SEQUENCE LISTING (55 sequences)

SEQ ID NO: 1 - DNA, 2117 bp, Mus musculus
ctagggtaaaaccgtgagactcggtctggaaatctggcctgagaggacagcctggcaatcctcagccggggtggggacgtctgccgaagatccttggactccagcaaccagtggtcgccaccgtccatccaccctaaggcccagtttgcacggcggagaacagctgtgcagccacgctggacactcaccccgcccgagttgagcccgcccccgggactacaggaccaataagtgatgaatatacccgcgcgtcacggagcaccggccaatcgcggacggccacgaccctagaaaggctgggcgcggcaggaggccacggggcggtggcggcgctggcgtagacgtttcctggctatggtggtggtggcagcggcgccgagcgcggccacggcggcccccaaagtgctactcttatctggccagcccgcctccggcggccgggcgctgccgctcatggtacccggtccgcgggcagcagggtcggaggcgagcgggacaccgcaggctcgcaagcggcagcggctcacgcacctgagcccggaggagaaagcgctgcggaggaaactgaaaaacagagtagcagcgcagactgctcgagatagaaagaaagcccggatgagcgagctggagcagcaagtggtggatttggaagaagagaaccacaaactccagctagaaaatcagcttttacgggagaaaactcacggccttgtggttgagaaccaggagttaagaacacgcttgggaatggacacgctggatcctgacgaggttccagaggtggaggccaaggggagtggagtaaggctggtggccgggtctgctgagtccgcagcaggtgcaggcccagttgtcacctccccagaacatcttcccatggactctgacactgttgcctcttcagattctgagtctgatatccttttgggcattctggacaagttggaccctgtcatgtttttcaaatgtccttccccagagtctgctagtctggaggaactcccagaggtctacccagaaggacctagttccttaccagcctccctttctctgtcagtggggacctcatcagccaagctggaagccattaatgaactcattcgttttgaccatgtatacaccaagcctctagttttagagatcccctctgagacagagagtcaaactaacgtggtagtgaaaattgaggaagcacctctaagctcttcagaagaggatcaccctgaattcattgtctcagtgaagaaagagcctttggaagatgacttcatcccagagctgggcatctcaaacctgctttcatccagccattgtctgagaccaccttcttgcctgctggacgctcacagtgactgtggatatgagggctccccttctcccttcagtgacatgtcttctccacttggtacagaccactcctgggaggatacttttgccaatgaacttttcccccagctgattagtgtctaaagagccacataacactgggcccctttccctgaccatcacattgcctagaggatagcataggcctgtctctttcgttaaaagccaaagtagaggctgtctggccttagaagaattcctctaaagtatttcaaatctcatagatgacttccaagtattgtcgtttgacactcagctgtctaaggtattcaaaggtattccagtactacagcttttgagattctagtttatcttaaaggtggtagtatactctaaatcgcagggagggtcatttgacagttttttcccagcctggcttcaaactatgtagccgaggctaggcagaaacttctgaccctcttgaccccacctcccaagtgctgggcttcaccaggtgtgcacctccacacctgcccccccgacatgtcaggtggacatgggattcatgaatggcccttagcatttctttctccactctctgcttcccaggtttcgtaacctgagggggcttgttttcccttatgtgcattttaaatgaagatcaagaatctttgtaaaatgatgaaaatttactatgtaaatgcttgatggatcttcttgctagtgtagcttctagaaggtgctttctccatttatttaaaactacccttgcaaaaaaaaaaaaaaaaaaa

SEQ ID NO: 2 - protein, 371 aa, Mus musculus
MVVVAAAPSAATAAPKVLLLSGQPASGGRALPLMVPGPRAAGSEASGTPQARKRQRLTHLSPEEKALRRKLKNRVAAQTARDRKKARMSELEQQVVDLEEENHKLQLENQLLREKTHGLVVENQELRTRLGMDTLDPDEVPEVEAKGSGVRLVAGSAESAAGAGPVVTSPEHLPMDSDTVASSDSESDILLGILDKLDPVMFFKCPSPESASLEELPEVYPEGPSSLPASLSLSVGTSSAKLEAINELIRFDHVYTKPLVLEIPSETESQTNVVVKIEEAPLSSSEEDHPEFIVSVKKEPLEDDFIPELGISNLLSSSHCLRPPSCLLDAHSDCGYEGSPSPFSDMSSPLGTDHSWEDTFANELFPQLISV

SEQ ID NO: 3 - DNA, 1787 bp, Homo sapiens
ctcgagctatggtggtggtggcagccgcgccgaacccggccgacgggacccctaaagttctgcttctgtcggggcagcccgcctccgccgccggagccccggccggccaggccctgccgctcatggtgccagcccagagaggggccagcccggaggcagcgagcggggggctgccccaggcgcgcaagcgacagcgcctcacgcacctgagccccgaggagaaggcgctgaggaggaaactgaaaaacagagtagcagctcagactgccagagatcgaaagaaggctcgaatgagtgagctggaacagcaagtggtagatttagaagaagagaaccaaaaacttttgctagaaaatcagcttttacgagagaaaactcatggccttgtagttgagaaccaggagttaagacagcgcttggggatggatgccctggttgctgaagaggaggcggaagccaaggggaatgaagtgaggccagtggccgggtctgctgagtccgcagcactcagactacgtgcacctctgcagcaggtgcaggcccagttgtcacccctccagaacatctccccatggattctggcggtattgactcttcagattcagagtctgatatcctgttgggcattctggacaacttggacccagtcatgttcttcaaatgcccttccccagagcctgccagcctggaggagctcccagaggtctacccagaaggacccagttccttaccagcctccctttctctgtcagtggggacgtcatcagccaagctggaagccattaatgaactaattcgttttgaccacatatataccaagcccctagtcttagagataccctctgagacagagagccaagctaatgtggtagtgaaaatcgaggaagcacctctcagcccctcagagaatgatcaccctgaattcattgtctcagtgaaggaagaacctgtagaagatgacctcgttccggagctgggtatctcaaatctgctttcatccagccactgcccaaagccatcttcctgcctactggatgcttacagtgactgtggatacgggggttccctttccccattcagtgacatgtcctctctgcttggtgtaaaccattcttgggaggacacttttgccaatgaactctttccccagctgattagtgtctaaggaatgatccaatactgttgcccttttccttgactattacactgcctggaggatagcagagaagcctgtctgtacttcattcaaaaagccaaaatagagagtatacagtcctagagaattcctctatttgttcagatctcatagatgacccccaggtattgtcttttgacatccagcagtccaaggtattgagacatattactggaagtaagaaatattactataattgagaactacagcttttaagattgtacttttatcttaaaagggtggtagttttccctaaaatacttattatgtaagggtcattagacaaatgtcttgaagtagacatggaatttatgaatggttctttatcatttctcttccccctttttggcatcctggcttgcctccagttttaggtcctttagtttgcttctgtaagcaacgggaacacctgctgagggggctctttccctcatgtatacttcaagtaagatcaagaatcttttgtgaaattatagaaatttactatgtaaatgcttgatggaattttttcctgctagtgtagcttctgaaaggtgctttctccatttatttaaaactacccatgcaattaaaaggccttcgtggcctcgag

SEQ ID NO: 4 - protein, 261 aa, Homo sapiens
MVVVAAAPNPADGTPKVLLLSGQPASAAGAPAGQALPLMVPAQRGASPEAASGGLPQARKRQRLTHLSPEEKALRRKLKNRVAAQTARDRKKARMSELEQQVVDLEEENQKLLLENQLLREKTHGLVVENQELRQRLGMDALVAEEEAEAKGNEVRPVAGSAESAALRLRAPLQQVQAQLSPLQNISPWILAVLTLQIQSLISCWAFWTTWTQSCSSNALPQSLPAWRSSQRSTQKDPVPYQPPFLCQWGRHQPSWKPLMN

SEQ ID NO: 5 - DNA, 26 bp, Artificial Sequence
  Synthetic oligonucleotide
cagcactcagactacgtgcacctctg

SEQ ID NO: 6 - DNA, 15 bp, Artificial Sequence
  Synthetic oligonucleotide
tggatgacgtgtaca

SEQ ID NO: 7 - DNA, 28 bp, Artificial Sequence
  Synthetic oligonucleotide
tcgagacaggtgctgacgtggcgattcc

SEQ ID NO: 8 - DNA, 19 bp, Artificial Sequence
  Synthetic oligonucleotide
ccaatnnnnnnnnnccacg

SEQ ID NO: 9 - DNA, 21 bp, Artificial Sequence
  Synthetic oligonucleotide
gggattcatgaatggccctta

SEQ ID NO: 10 - DNA, 2371 bp, Homo sapiens
agctggctgagaggggactgggcgccggcggggaaggaggagcgctaggtcggtgtacgaccgagattagggtgcgtgccagctccgggaggccgcggtgaggggccgggcccaagctgccgacccgagccgatcgtcagggtcgccagcgcctcagctctgtggaggagcagcagtagtcggagggtgcaggatattagaaatggctactccccagtcaattttcatctttgcaatctgcattttaatgataacagaattaattctggcctcaaaaagctactatgatatcttaggtgtgccaaaatcggcatcagagcgccaaatcaagaaggcctttcacaagttggccatgaagtaccaccctgacaaaaataagagcccggatgctgaagcaaaattcagagagattgcagaagcatatgaaacactctcagatgctaatagacgaaaagagtatgatacacttggacacagtgcttttactagtggtaaaggacaaagaggtagtggaagttcttttgagcagtcatttaacttcaattttgatgacttatttaaagactttggcttttttggtcaaaaccaaaacactggatccaagaagcgttttgaaaatcatttccagacacgccaggatggtggttccagtagacaaaggcatcatttccaagaattttcttttggaggtggattatttgatgacatgtttgaagatatggagaaaatgttttcttttagtggttttgactctaccaatcagcatacagtacagactgaaaatagatttcatggatctagcaagcactgcaggactgtcactcaacgaagaggaaatatggttactacatacactgactgttcaggacagtagttcttattctattctcactaaatccaactggttgactcttcctcattatctttgatgctaaacaattttctgtgaactattttgacaagtgcatgatttcactttaaacaatttgatatagctattaaatatatttaagggttttttttttttgacaaattcaacattcaacgagtagacaaaatgctaattatttccctgattaggaaagtttctttaaaaaacacgtaattttgcctagtgctttttctctacctgcccttgggctcactaatatcaccagtattattaccaagaaaatattgagtttacctgattaaactttaaaagttaattgtagatttaaattgtgtgaacctaatgatttttgcagtgaaacctttactaattcaaagttgcatgttctatgacatctgtgacttgcgttgcagagtgtacatgaaactgtataattgagtcattcagtaaaggagaacagtatcttggttaattgctactgaaaggttgagaaaggaatggtttgatatttaccacagcgctgtgcctttctacagtagaactggggtaaaggaaatggttttattgcccatagtcatttaggctggaaaaaagttgaaaacttaacgaaatattgccaagagattgttatgtgtttggttccagcctaaaaatgattttgtagtgttgaaatcatagctacttacatagctttttcatatttctttcttagttgttggcactcttaggtcttagtatggatttatgtgtttgtgtgtgtgtagtttatcctctctctcatctttatctagagattgactgatacctcattctgtttgtaaaaccagccagtaatttctgtgcaaccttactatgtgcaatatttttaaatcctgagaaatgtgtgcttttgttttcggatagacttatttctttagttctgcacttttccacattatactccatatgagtattaatcctatggatacatattaaaacaagtgtctcatacaacattgtatgtgagagaaatataaatatttacaacctgatattcgttgttgttttattgttaaaagtttattatgcaactctggaggtatagagggcatataagctatgggacatatgctgatcacaggctatattcatgaagttacttttgaccaacctgaaaactgataggattttgtttgtcatttggtaatttctactgcattcttaccatccttctctcacaaattttgatagcttgaagatctttttaattataattttgttgtatttgtttcctaggagcaagtgttcctgctgccagttctttcctctttaggcgtggttgagaaaaagcagaaactttacataaagctgtatttcttaatcatctttaatttgaaacttaagaaaatgaatttattctgttatatttatgtaacttatttcctggaagttatatctactagttttgtttgataataataaaattagctataccttgaa

SEQ ID NO: 11 - protein, 223 aa, Homo sapiens
MATPQSIFIFAICILMITELILASKSYYDILGVPKSASERQIKKAFHKLAMKYHPDKNKSPDAEAKFREIAEAYETLSDANRRKEYDTLGHSAFTSGKGQRGSGSSFEQSFNFNFDDLFKDFGFFGQNQNTGSKKRFENHFQTRQDGGSSRQRHHFQEFSFGGGLFDDMFEDMEKMFSFSGFDSTNQHTVQTENRFHGSSKHCRTVTQRRGNMVTTYTDCSGQ

SEQ ID NO: 12 - DNA, 1542 bp, Homo sapiens
ctcctcttcactcgcgagccctcggacatggtggcccccggctccgtgaccagccggctgggctcggtattccccttcctgctagtcctggtggatctgcagtacgaaggtgctgaatgtggagtaaatgcagatgttgagaaacatcttgaattgggcaagaaattacttgcagctggacagctagctgatgctttatctcagtttcatgctgccgtagatggtgaccctgataactatattgcttattatcggagggctactgtctttttagctatgggcaaatcaaaagctgcacttcctgatttaactaaagtgattcaattgaagatggacttcactgcagcaagattacagagaggtcacttattactcaaacaaggaaaacttgatgaagcagaagatgattttaaaaaagtgctcaaatctaatccaagtgaaaatgaagaaaaggaagcacagtctcaacttataaaatctgatgaaatgcagcgtttgcgttcacaagcacttaacgcttttggaagtggagattatactgctgctatagccttccttgataagattttagaggtttgtgtttgggatgcagaactacgggaacttcgagctgaatgttttataaaagaaggagaacctaggaaagctataagtgacttaaaagctgcgtcaaagttgaagaatgataatactgaagcgttttataaaataagcacactgtactaccaactaggagaccacgaactgtccctcagtgaagttcgggaatgtcttaaacttgaccaggatcataaaaggtgttttgcacactataaacaagtaaagaaacttaataagctgattgagtcagctgaagagctcatcagagatggcagatacacagatgctaccagcaaatatgaatctgtcatgaaaacagagccaagcattgctgaatatacagttcgttcaaaggagaggatttgccactgcttttctaaggacgagaagcctgttgaagctattagggtttgttctgaagttttacagatggaacctgacaatgtgaatgccctgaaagatcgagcagaggcctatttgatagaggaaatgtatgatgaagctattcaggattatgaaactgctcaggaacacaatgaaaatgatcagcagattcgagaaggtctagagaaagcacaaagattattgaaacagtcgcagaaacgagattattataaaatcttgggagtaaaaagaaatgccaaaaagcaagaaattattaaagcataccgaaaattagcactgcagtggcacccagataacttccagaatgaagaagaaaagaaaaaagctgagaaaaagttcattgatatagcagctgctaaagaagtcctctctgatccagaaatgagaaagaagtttgacgacggagaagatcctttggatgcagagagccagcaaggaggcggcggcaaccctttccacagaagctggaactcatggcaagggttcaatcccttcagctcaggcggaccatttagatttaaattccacttcaattaa

SEQ ID NO: 13 - protein, 504 aa, Homo sapiens
MVAPGSVTSRLGSVFPFLLVLVDLQYEGAECGVNADVEKHLELGKKLLAAGQLADALSQFHAAVDGDPDNYIAYYRRATVFLAMGKSKAALPDLTKVIQLKMDFTAARLQRGHLLLKQGKLDEAEDDFKKVLKSNPSENEEKEAQSQLIKSDEMQRLRSQALNAFGSGDYTAAIAFLDKILEVCVWDAELRELRAECFIKEGEPRKAISDLKAASKLKNDNTEAFYKISTLYYQLGDHELSLSEVRECLKLDQDHKRCFAHYKQVKKLNKLIESAEELIRDGRYTDATSKYESVMKTEPSIAEYTVRSKERICHCFSKDEKPVEAIRVCSEVLQMEPDNVNALKDRAEAYLIEEMYDEAIQDYETAQEHNENDQQIREGLEKAQRLLKQSQKRDYYKILGVKRNAKKQEIIKAYRKLALQWHPDNFQNEEEKKKAEKKFIDIAAAKEVLSDPEMRKKFDDGEDPLDAESQQGGGGNPFHRSWNSWQGFNPFSSGGPFRFKFHFN

SEQ ID NO: 14 - DNA, 6072 bp, Homo sapiens
ggtggtcggcggggaggcccccgcgctttaaaataatgcccgcggcgcccgcgcgaccatgcaatggcgagcgctcgtcctggggctggtgctcctccggcttggcctccatggagtattgtggctcgtcttcgggctggggcccagcatgggcttctaccagcgctttccgctcagcttcggcttccagcgtctgaggagccccgacggccccgcgtcgcccacctcggggcccgtgggccggcctgggggggtatccgggccgtcgtggctgcagccgccggggaccggggcagcgcagagcccgcgcaaggctccgcggcgtcctgggccggggatgtgcggcccagccaactggggctacgtgctgggcggccggggccgcggcccggacgagtacgagaagcgctacagcggcgccttccctccgcagctgcgtgcccagatgcgcgacctggcacggggcatgttcgtctttggctacgacaactacatggctcacgccttcccccaggacgagctcaaccccatccactgccgcggccgtgggcccgaccgcggggacccttcaaatctgaacatcaatgatgtactagggaactactcattgactcttgttgatgcattggatacacttgcaataatgggaaattcatccgagttccagaaagcagtcaagttagtgatcaacacagtttcatttgacaaagattccaccgtccaagtctttgaggccacgataagggtcctgggaagcctcctttctgctcacagaataataactgactccaagcagccctttggtgacatgacaattaaggactatgataatgagttgttatacatggcccatgacctggcggtgcggctcctccctgcttttgaaaacaccaagacagggattccatatcctcgggtgaatctaaagacaggagttcctcctgacaccaataatgagacatgcacagcgggagccggttccctcctggtggaatttgggattctgagtcgactcctgggggactccacatttgagtgggtggccagacgagcagtgaaagccctttggaacctccggagcaatgatacaggattactaggcaatgtcgtgaacattcagacgggccactgggttggaaagcagagtggcctgggtgccgggctggactccttctatgaatacctcttgaaatcttacattctctttggagaaaaagaagacctagaaatgtttaatgctgcatatcagagtattcagaactacttaagaagagggcgggaagcctgcaatgaaggagaaggagaccctccactctatgtcaacgtgaacatgttcagtgggcagctgatgaacacctggattgactctctgcaggcctttttccctggactgcaggtgctgataggagatgtggaagatgccatctgccttcatgccttctactatgccatatggaaacgatatggtgccctccctgagagatataactggcagctgcaggcccctgacgttctcttctacccactgagaccagagttagtggaatccacatatctcctctaccaggcaaccaagaatcccttctacctccatgtaggaatggatattctgcagagtctggaaaagtacacaaaagtcaagtgtgggtacgccacgctgcatcacgtcattgacaagtccacagaagaccggatggagagcttctttctcagtgagacctgtaaatatttgtatctgctgtttgatgaagacaatccagtacacaagtctggaaccagatacatgttcacaacagagggacacattgtatctgtggatgagcatcttcgggaattgccatggaaggaattcttctctgaagagggagggcaggaccaagggggaaagtctgtgcacaggccgaaacctcatgagttaaaagtcatcaactccagctccaactgcaatcgtgtacctgatgagaggaggtactccctgcccttaaagagcatctacatgcgacagattgaccagatggttggtttgatttgatctgctctctgtgaggcctcatcttgaaccagaccttaacgaccaaacccagaccatgccaaagtccagtctgaaatgaaaggggacagaagtcttgctgtccatggtggtgtaggaatttctgtgcaacacctcaccacgtctggttaatccttgcacacttcagtgtttctctcctgttcaataaaatgccctgttaaggatataatttgaagtgagaagatacatggaaattgccctcttatgacatgttgatgttataagcacaatagatggggcatctttggattgatgttcacagctttatacttcagaacctaagtctcttcactttgctggcacctgctatactggagtattgctatgtctttaaaaaatttttttttattatattttatttttttgagacagggtcttgatatttttttgggacagggttacctgggctcaagtgatccttctgcctcagcctcccgagtagctgggattacaggtgagcaccactgtacctggctagctacttctttgttagaggattgagaatgaaatttctgcaaaagggcccatggttcatttggtatccctatttaattgcattgaaaatgtcatcctttctgttgttagataattggggtcttcccctgatatccaaccgtgattttggatcacatgggagaaaaagtcatccagtttttcatgtttgcctcaagtaatctttacagtgttacaaattatttgcttaagaagaatggtcttaaccagaattcttaacagatagtctcttaggttattatgttatggtctaagaggttaactgacatcttttggatggtattttgcattttgaatatgaacttacctgaggaactcccatagttccagaatcaggtgccttttagggagagaacaatacctaagattgtctgagcttccatctttctcatatttcctaagcaaggattctcacttatgaccatatttgggttagagttctgttttgtttctgttttctgtgtctagtgccaattagctaaatcagggagaaagaaatgatcacatgacttttagcatccttgagccatttctctgtgtaatacaggctttagattagtgccttatattggttttggtttggggcactggatgtcgcagctactgctatggtttcaggaggcctgtttagccacatggtgagaccgtggtgaaagggggatggaaattgcttggccagtctttgcctttcatcctgtaaaagtaagcatgtagaaggaggaagttgtgctaaaatgcctttgtttttttgttattattttcttagccagaacatctctctttgaactcacactgatacacacctgctactcttacacagtgcagcagggctgactcttagtctggcttccatgaagcgtcatgggtggaaacgcattctagtaaaaaaggtaggaaatccctaaaacttccagcctcacatagcacggttctcacctgtcactgttttcccacctctaaggatttcatgtacatcttttcaaagctagaaataagcactgtctaagtttatgttgcatttttagtcaaaagggagaaatcttattccttcttgaaaattttaagtgttatggttttatatagttcagttctttgagatttttgaaaagagtattttcagtaataaacgtgccatctctatctcttaaacatttattacaacaattgttttaaaatagaaaaaataaaatgcttctattttaccttttttcatttcagaagcattattctgtttattaacagtgtcccatctactgaatagaaaactttgagaataatatatatatatattttaaatgttttcactgactcattgaaaatgttaattacacacacatgcatgcatgcacacacgagcatacttgtacctttgtctctgggcaaacaggtgggactgttagtgacccatttgggaaaatagagcatctcagagaaggaggtgagttcttcctgcctgtgatttctcttggcgctcccctcctctcccgctctggcttctgtggcggcagtggtgggtaagcactccagtgttctcttaatgaggcactttgcctgtcactcgagcaagcctgggtgttccttcctcctcatgctcctggaatagggaatagggatctcatgcttgcaaactacacaatgctgcaggtgcttcccaggggccacaggctgtcaggaaacgtgttttatgttaagtcacaaacccacttgacttctgggtactggaattaataccagtgggtgagactgagggtgagtgagttagtacatattaatcctggttgttgagcttccagactaccccgtccaaagtttgatgctatgtagtcagtggtttgtggggctggatgccagaaggttctttgagccagtttcaaaggttacttgtttttttttttttttttttaagtcagaatgttaacagctgtgatatatcctgcagggcttttgcagtttcttctgttctgtgttctgaaatcctgggtagagaatggctgaggaggagattaccagagaagttgctttgctcagtgctttgccccaggattgcctcaaatctgagtggacttcatcctttgcggcggctctgagcctggcccatcttcctattcccacgtgtagctagtgtctagtgtcagctttgctcaatgtggtggaaacattttgcagaactgttgtagaaagctgccttatagttggcttgacaaagcataattctctcataacaaactttcaaatcattacagtagcttagctactttagttgatgtgaccgaggaatcccttctagaatcataggtggcaagggagggtttgctagctctccatttgcactggccattgtgaaaaaccagcttctgtattcaaatctttccttcatttttttaaattttttttttggcagcgcttgtgctggaacttactcattgtaactgaatcctcagggcttttcttgttttagatcatggactgtgcacgtgacacttaaataattttctatgtatttaaagaaaaatgcaccaggatggtgtctgtgcacgtgactattagaggagcgtctgtagaagtacctggtttggtcagtgcagttgtgcaatctgagggccttgtttcctcctcccctttccccttctccccaccaaaggaaaatatccctcttaatgatttcgtagttcagtttactgaatgattaccacctgtaattcctctttggattgtgtagactcaacatgagacattcctttctgctttctggagggcaccaggggcctttctctttgataaattttttttgtctgttgacaaaaacaaaaatcttttttcaaatgtagtgctggtgaaaaggtagggctgagtgattaccttagccacagggtggctgagcaggaactttagaagaaaatcctgagctttcctgtccattcccagcatccagctcctattctagtgcctcttccctgcagggcagggaccccttgggaaatcgaggaggtgggacgggctgggccctgtgtcccaggtttcacagggctcagggttatgctcccgcttgaatctggacgtgaatctggtaaaaatatcaagtacctgtggaactccctgattctataccctcttccttctttctgcaaggcagaggaataatatttttaaaggttattttgttttagttttaaatagcaaaacacaagctgcatttttatttattttgcataagaaaggtaaatctttttacaaaaaaaagtatagagttggaaactctgggaaaacttacggaaatacacaaatgcttctctgtaatgtgcaatatgctttgcaactgtagatgatattttatgtttaatctgtaaataagaaatgtatttaaattaaaagggatctttttgtaaaaggaccaaatgttcttttataaatgtaataaggaatatcttgctctttaaaatttattaggatttttatgagtaatttttattaaaagatttctttttttg

SEQ ID NO: 15 - protein, 657 aa, Homo sapiens
MQWRALVLGLVLLRLGLHGVLWLVFGLGPSMGFYQRFPLSFGFQRLRSPDGPASPTSGPVGRPGGVSGPSWLQPPGTGAAQSPRKAPRRPGPGMCGPANWGYVLGGRGRGPDEYEKRYSGAFPPQLRAQMRDLARGMFVFGYDNYMAHAFPQDELNPIHCRGRGPDRGDPSNLNINDVLGNYSLTLVDALDTLAIMGNSSEFQKAVKLVINTVSFDKDSTVQVFEATIRVLGSLLSAHRIITDSKQPFGDMTIKDYDNELLYMAHDLAVRLLPAFENTKTGIPYPRVNLKTGVPPDTNNETCTAGAGSLLVEFGILSRLLGDSTFEWVARRAVKALWNLRSNDTGLLGNVVNIQTGHWVGKQSGLGAGLDSFYEYLLKSYILFGEKEDLEMFNAAYQSIQNYLRRGREACNEGEGDPPLYVNVNMFSGQLMNTWIDSLQAFFPGLQVLIGDVEDAICLHAFYYAIWKRYGALPERYNWQLQAPDVLFYPLRPELVESTYLLYQATKNPFYLHVGMDILQSLEKYTKVKCGYATLHHVIDKSTEDRMESFFLSETCKYLYLLFDEDNPVHKSGTRYMFTTEGHIVSVDEHLRELPWKEFFSEEGGQDQGGKSVHRPKPHELKVINSSSNCNRVPDERRYSLPLKSIYMRQIDQMVGLI

SEQ ID NO: 16 - DNA, 1681 bp, Homo sapiens
gtctgtattcctctagtgatgatgtgatcgaattaactccatcaaatttcaaccgagaagttattcagagtgatagtttgtggcttgtagaattctatgctccatggtgtggtcactgtcaaagattaacaccagaatggaagaaagcagcaactgcattaaaagatgttgtcaaagttggtgcagttgatgcagataagcatcattccctaggaggtcagtatggtgttcagggatttcctaccattaagatttttggatccaacaaaaacagaccagaagattaccaaggtggcagaactggtgaagccattgtagatgctgcgctgagtgctctgcgccagctcgtgaaggatcgcctcgggggacgaagcggaggatacagttctggaaaacaaggcagaagtgatagttcaagtaagaaggatgtgattgagctgacagacgacagctttgataagaatgttctggacagtgaagatgtttggatggttgagttctatgctccttggtgtggacactgcaaaaacctagagccagagtgggctgccgcagcttcagaagtaaaagagcagacgaaaggaagagtgaaactggcagctgtggatgctacagtcaatcaggttctggcctcccgatacgggattagaggatttcctacaatcaagatatttcagaaaggcgagtctcctgtggattatgacggtgggcggacaagatccgacatcgtgtcccgggcccttgatttgttttctgataacgccccacctcctgagctgcttgagattatcaacgaggacattgccaagaggacgtgtgaggagcaccagctctgtgttgtggctgtgctgccccatatccttgatactggagctgcaggcagaaattcttatctggaagttcttctgaagttggcagacaaatacaaaaagaaaatgtgggggtggctgtggacagaagctggagcccagtctgaacttgagaccgcgttggggattggagggtttgggtaccccgccatggccgccatcaatgcacgcaagatgaaatttgctctgctaaaaggctccttcagtgagcaaggcatcaacgagtttctcagggagctctcttttgggcgtggctccacggcacctgtaggaggcggggctttccctaccatcgttgagagagagccttgggacggcagggatggcgagcttcccgtggaggatgacattgacctcagtgatgtggagcttgatgacttagggaaagatgagttgtgagagccacaacagaggcttcagaccattttcttttcttgggagccagtggatttttccagcagtgaagggacattctctacactcagatgactctaccagtggccttttaaccaagaagtagtacttgattggtcatttgaaaacactgcaacagtgaacttttgcatctcaagaaaacattgaaaaattctatgaattgttgtagccggtgaattgagtcgtattctgtcacataatattttgaagaaaacttggctgtcgaaacatttttctctctgactgctgcttgaatgttcttggaggctgtttcttatgtatgggttttttttaatgtgatcccttcatttgaatattaatggctttttccattaaagaataaaatattttggacaaaaaaaaaaaaaaaaaaaaaa

SEQ ID NO: 17 - protein, 440 aa, Homo sapiens
MALLVLGLVSCTFFLAVNGLYSSSDDVIELTPSNFNREVIQSDSLWLVEFYAPWCGHCQRLTPEWKKAATALKDVVKVGAVDADKHHSLGGQYGVQGFPTIKIFGSNKNRPEDYQGGRTGEAIVDAALSALRQLVKDRLGGRSGGYSSGKQGRSDSSSKKDVIELTDDSFDKNVLDSEDVWMVEFYAPWCGHCKNLEPEWAAAASEVKEQTKGKVKLAAVDATVNQVLASRYGIRGFPTIKIFQKGESPVDYDGGRTRSDIVSRALDLFSDNAPPPELLEIINEDIAKRTCEEHQLCVVAVLPHILDTGAAGRNSYLEVLLKLADKYKKKMWGWLWTEAGAQSELETALGIGGFGYPAMAAINARKMKFALLKGSFSEQGINEFLRELSFGRGSTAPVGGGAFPTIVEREPWDGRDGELPVEDDIDLSDVELDDLGKDEL

SEQ ID NO: 18 - DNA, 1265 bp, Homo sapiens
cccaaagtagatcgaggcggcgggctgcacattcccgttgttgcgttgcgtttccttcctctttcactccgcgctcacggcggcggccaaagcggcggcgacggcggcgcgagaacgacccggcggccagttctcttcctcctgcgcacctgccctgctcggtcagtcagtcggcggccggcgcccggcttgtgctcagacctcgcgcttgcggcgcccaggcccagcggccgtagctagcgtctggcctgagaacctcggcgctccggcggcgcgggcaccacgagcggagcctcgcagcggctccagaggaggcaggcgagtgagcgagtccgaggggtggccggggcaggtggtggcgccgcgaagatggtcgccaagcaaaggatccgtatggccaacgagaagcacagcaagaacatcacccagcgcggcaacgtcgccaagacctcgagaaatgcccccgaagagaaggcgtctgtaggaccctggttattggctctcttcatttttgttgtctgtggttctgcaattttccagattattcaaagtatcaggatgggcatgtgaagtgactgaccttaagatgtttccattctcctgtgaattttaacttgaactcattcctgatgtttgataccctggttgaaaacaattcagtaaagcatcctgcctcagaatgactttcctatcatgcttcatgtgtcattccaaggtttcttcatgagtcattccaagttttctagtccataccacagtgccttgcaaaaaacaccacatgaataaagcaataaaatttgattgttaagatacagtagtggaccctacttattcagtcaattaagagtaagtttttttatgtggttattaaaacagtatgaacaattagtctaactctgcatagacagggtctagattttgttaacccaaatgtataactgcagttagcttaaattacaatttgaagtcttgtggtttttatatagctaggcactttattactcttttgaactgaaagcacactcccttataggttcatgtaactgtcctgtaataaggtgcttattaaatgggaacaactacacagcctagttttgccacaacctttagcatctaaaaagttttaaaaagcttctaaatgtctaatattaaagggagatgcttatagccacaacatctattttaccaatattgtttccattacactaccttgggattttggcatgagtgagtatagktaacccaggatgccattaaaaaaaaaa

SEQ ID NO: 19 - protein, 66 aa, Homo sapiens
MVAKQRIRMANEKHSKNITQRGNVAKTSRNAPEEKASVGPWLLALFIFVVCGSAIFQIIQSIRMGM

SEQ ID NO: 20 - DNA, 1174 bp, Homo sapiens
ggcctcacagggccgggtgggctggcgagccgacgcggcggcggaggaggctgtgaggagtgtgtggaacaggacccgggacagaggaaccatggctccgcagaacctgagcaccttttgcctgttgctgctatacctcatcggggcggtgattgccggacgagatttctataagatcttgggggtgcctcgaagtgcctctataaaggatattaaaaaggcctataggaaactagccctgcagcttcatcccgaccggaaccctgatgatccacaagcccaggagaaattccaggatctgggtgctgcttatgaggttctgtcagatagtgagaaacggaaacagtacgatacttatggtgaagaaggattaaaagatggtcatcagagctcccatggagacattttttcacacttctttggggattttggtttcatgtttggaggaacccctcgtcagcaagacagaaatattccaagaggaagtgatattattgtagatctagaagtcactttggaagaagtatatgcaggaaattttgtggaagtagttagaaacaaacctgtggcaaggcaggctcctggcaaacggaagtgcaattgtcggcaagagatgcggaccacccagctgggccctgggcgcttccaaatgacccaggaggtggtctgcgacgaatgccctaatgtcaaactagtgaatgaagaacgaacgctggaagtagaaatagagcctggggtgagagacggcatggagtacccctttattggagaaggtgagcctcacgtggatggggagcctggagatttacggttccgaatcaaagttgtcaagcacccaatatttgaaaggagaggagatgatttgtacacaaatgtgacaatctcattagttgagtcactggttggctttgagatggatattactcacttggatggtcacaaggtacatatttcccgggataagatcaccaggccaggagcgaagctatggaagaaaggggaagggctccccaactttgacaacaacaatatcaagggctctttgataatcacttttgatgtggattttccaaaagaacagttaacagaggaagcgagagaaggtatcaaacagctactgaaacaagggtcagtgcagaaggtatacaatggactgcaaggatattgagagtga

SEQ ID NO: 21 - protein, 358 aa, Homo sapiens
MAPQNLSTFCLLLLYLIGAVIAGRDFYKILGVPRSASIKDIKKAYRKLALQLHPDRNPDDPQAQEKFQDLGAAYEVLSDSEKRKQYDTYGEEGLKDGHQSSHGDIFSHFFGDFGFMFGGTPRQQDRNIPRGSDIIVDLEVTLEEVYAGNFVEVVRNKPVARQAPGKRKCNCRQEMRTTQLGPGRFQMTQEVVCDECPNVKLVNEERTLEVEIEPGVRDGMEYPFIGEGEPHVDGEPGDLRFRIKVVKHPIFERRGDDLYTNVTISLVESLVGFEMDITHLDGHKVHISRDKITRPGAKLWKKGEGLPNFDNNNIKGSLIITFDVDFPKEQLTEEAREGIKQLLKQGSVQKVYNGLQGY

SEQ ID NO: 22 - DNA, 2554 bp, Homo sapiens
aggtcgacgccggccaagacagcacagacagattgacctattggggtgtttcgcgagtgtgagagggaagcgccgcggcctgtatttctagacctgcccttcgcctggttcgtggcgccttgtgaccccgggcccctgccgcctgcaagtcggaaattgcgctgtgctcctgtgctacggcctgtggctggactgcctgctgctgcccaactggctggcaagatgaagctctccctggtggccgcgatgctgctgctgctcagcgcggcgcgggccgaggaggaggacaagaaggaggacgtgggcacggtggtcggcatcgacttggggaccacctactcctgcgtcggcgtgttcaagaacggccgcgtggagatcatcgccaacgatcagggcaaccgcatcacgccgtcctatgtcgccttcactcctgaaggggaacgtctgattggcgatgccgccaagaaccagctcacctccaaccccgagaacacggtctttgacgccaagcggctcatcggccgcacgtggaatgacccgtctgtgcagcaggacatcaagttcttgccgttcaaggtggttgaaaagaaaactaaaccatacattcaagttgatattggaggtgggcaaacaaagacatttgctcctgaagaaatttctgccatggttctcactaaaatgaaagaaaccgctgaggcttatttgggaaagaaggttacccatgcagttgttactgtaccagcctattttaatgatgcccaacgccaagcaaccaaagacgctggaactattgctggcctaaatgttatgaggatcatcaacgagcctacggcagctgctattgcttatggcctggataagagggagggggagaagaacatcctggtgtttgacctgggtggcggaaccttcgatgtgtctcttctcaccattgacaatggtgtcttcgaagttgtggccactaatggagatactcatctgggtggagaagactttgaccagcgtgtcatggaacacttcatcaaactgtacaaaaagaagacgggcaaagatgtcaggaaggacaatagagctgtgcagaaactccggcgcgaggtagaaaaggccaaggccctgtcttctcagcatcaagcaagaattgaaattgagtccttctatgaaggagaagacttttctgagaccctgactcgggccaaatttgaagagctcaacatggatctgttccggtctactatgaagcccgtccagaaagtgttggaagattctgatttgaagaagtctgatattgatgaaattgttcttgttggtggctcgactcgaattccaaagattcagcaactggttaaagagttcttcaatggcaaggaaccatcccgtggcataaacccagatgaagctgtagcgtatggtgctgctgtccaggctggtgtgctctctggtgatcaagatacaggtgacctggtactgcttcatgtatgtccccttacacttggtattgaaactgtaggaggtgtcatgaccaaactgattccaagtaatacagtggtgcctaccaagaactctcagatcttttctacagcttctgataatcaaccaactgttacaatcaaggtctatgaaggtgaaagacccctgacaaaagacaatcatcttctgggtacatttgatctgactggaattcctcctgctcctcgtggggtcccacagattgaagtcacctttgagatagatgtgaatggtattcttcgagtgacagctgaagacaagggtacagggaacaaaaataagatcacaatcaccaatgaccagaatcgcctgacacctgaagaaatcgaaaggatggttaatgatgctgagaagtttgctgaggaagacaaaaagctcaaggagcgcattgatactagaaatgagttggaaagctatgcctattctctaaagaatcagattggagataaagaaaagctgggaggtaaactttcctctgaagataaggagaccatggaaaaagctgtagaagaaaagattgaatggctggaaagccaccaagatgctgacattgaagacttcaaagctaagaagaaggaactggaagaaattgttcaaccaattatcagcaaactctatggaagtgcaggccctcccccaactggtgaagaggatacagcagaaaaagatgagttgtagacactgatctgctagtgctgtaatattgtaaatactggactcaggaacttttgttaggaaaaaattgaaagaacttaagtctcgaatgtaattggaatcttcacctcagagtggagttgaactgctatagcctaagcggctgtttactgcttttcattagcagttgctcacatgtctttgggtggggggggagaagaagaattggccatcttaaaaagcgggtaaaaaacctgggttagggtgtgtgttcaccttcaaaatgttctatttaacaactgggtcatgtgcatctggtgtaggaagttttttctaccataagtgacaccaataaatgtttgttatttacactggtcaaaaaaaaaaaaaaaaa

SEQ ID NO: 23 - protein, 653 aa, Homo sapiens
MKLSLVAAMLLLLSAARAEEEDKKEDVGTVVGIDLGTTYSCVGVFKNGRVEIIANDQGNRITPSYVAFTPEGERLIGDAAKNQLTSNPENTVFDAKRLIGRTWNDPSVQQDIKFLPFKVVEKKTKPYIQVDIGGGQTKTFAPEEISAMVLTKMKETAEAYLGKKVTHAVVTVPAYFNDAQRQATKDAGTIAGLNVMRIINEPTAAAIAYGLDKREGEKNILVFDLGGGTFDVSLLTIDNGVFEVVATNGDTHLGGEDFDQRVMEHFIKLYKKKTGKDVRKDNRAVQKLRREVEKAKALSSQHQARIEIESFYEGEDFSETLTRAKFEELNMDLFRSTMKPVQKVLEDSDLKKSDIDEIVLVGGSTRIPKIQQLVKEFFNGKEPSRGINPDEAVAYGAAVQAGVLSGDQDTGDLVLLHVCPLTLGIETVGGVMTKLIPSNTVVPTKNSQIFSTASDNQPTVTIKVYEGERPLTKDNHLLGTFDLTGIPPAPRGVPQIEVTFEIDVNGILRVTAEDKGTGNKNKITITNDQNRLTPEEIERMVNDAEKFAEEDKKLKERIDTRNELESYAYSLKNQIGDKEKLGGKLSSEDKETMEKAVEEKIEWLESHQDADIEDFKAKKKELEEIVQPIISKLYGSAGPPPTGEEDTAEKDEL

SEQ ID NO: 24 - DNA, 2474 bp, Homo sapiens
  Synthetic oligonucleotide
aagatattaatcacggagttccagggaaaaggaacttgtgaaatgggggagccggctggggttgccggcaccatggagtcaccttttagcccgggactctttcacaggctggatgaagattgggattctgctctctttgctgaacttggttatttcacagacactgatgagctgcaattggaagcagcaaatgagacgtatgaaaacaattttgataatcttgattttgatttggatttgttaccttgggagtcagacatttgggacatcaacaaccaaatctgtacagttaaagatattaaggcagaaccccagccactttctccagcctcctcaagttattcagtctcatctcctcggtcagtggactcttattcttcaactcagcatgttcctgaggagttggatttgtcttctagttctcagatgtctcccctttccttatatggtgaaaactctaatagtctctcttcaccggagccactgaaggaagataagcctgtcactggttctaggaacaagactgaaaatggactgactccaaagaaaaaaattcaggtgaattcaaaaccttcaattcagcccaagcctttattgcttccagcagcacccaagactcaaacaaactccagtgttccagcaaaaaccatcattattcagacagtaccaacgcttatgccattggcaaagcagcaaccaattatcagtttacaacctgcacccactaaaggccagacggttttgctgtctcagcctactgtggtacaacttcaagcacctggagttctgccctctgctcagccagtccttgctgttgctgggggagtcacacagctccctaatcacgtggtgaatgtggtaccagccccttcagcgaatagcccagtgaatggaaaactttccgtgactaaacctgtcctacaaagtaccatgagaaatgtcggttcagatattgctgtgctaaggagacagcaacgtatgataaaaaatcgagaatccgcttgtcagtctcgcaagaagaagaaagaatatatgctagggttagaggcgagattaaaggctgccctctcagaaaacgagcaactgaagaaagaaaatggaacactgaagcggcagctggatgaagttgtgtcagagaaccagaggcttaaagtccctagtccaaagcgaagagttgtctgtgtgatgatagtattggcatttataatactgaactatggacctatgagcatgttggaacaggattccaggagaatgaaccctagtgtgggacctgcaaatcaaaggaggcaccttctaggattttctgctaaagaggcacaggacacatcagatggtattatccagaaaaacagctacagatatgatcattctgtttcaaatgacaaagccctgatggtgctaactgaagaaccattgctttacattcccccacctccttgtcagcccctaattaatacaacagagtctctcaggttaaatcatgaacttcgaggatgggttcatagacatgaagtagaaaggaccaagtctagaagaatgacaaataatcaacagaaaacccgtattcttcagggtgttgtggaacagggctcaaattctcagctgatggctgttcaatacacagaaaccactagtagtatcagcaggaactcagggagtgagctacaagtgtattatgcttcacccagaagttatcaagacttttttgaagccatccgcagaaggggagacacattttatgttgtgtcatttcgaagggatcacctgctgttaccagctaccacccataacaagaccacaagaccaaaaatgtcaattgtgttaccagcaataaacataaatgagaatgtgatcaatgggcaggactacgaagtgatgatgcagattgactgtcaggtgatggacaccaggatcctccatatcaaaagttcgtcggttcctccttacctccgagatcagcagaggaatcaaaccaacaccttctttggctcccctcccgcagccacagaggcaacccacgttgtcagcaccatccctgagtcattacaatagcacccgcagctatgtggaaaactgagcgtgggacccccagactgaagagcaggtgagcaaaatgctgcttttccttggtggcaggcagagaactgttcgtactagaattcaaggagaaaagaagaagaaataaaagaagctgctccatttttcatcatctacccatctatttggaaagcactggaattcagatgcaagagaacaatgtttcttcagtggcaaatgtagccctgcatcctccagtgttacctggtgtagatttttttttctgtacctttctaaacctctcttccctctgtgatggttttgtgtttaaacagtcatcttcttttaaataatatccacctctcctttttgccatttcacttattgattcataaagtgaattttatttaaagctaaaaaaaaaaaaaaaaaaa

SEQ ID NO: 25 - protein, 670 aa, Homo sapiens
MGEPAGVAGTMESPFSPGLFHRLDEDWDSALFAELGYFTDTDELQLEAANETYENNFDNLDFDLDLLPWESDIWDINNQICTVKDIKAEPQPLSPASSSYSVSSPRSVDSYSSTQHVPEELDLSSSSQMSPLSLYGENSNSLSSPEPLKEDKPVTGSRNKTENGLTPKKKIQVNSKPSIQPKPLLLPAAPKTQTNSSVPAKTIIIQTVPTLMPLAKQQPIISLQPAPTKGQTVLLSQPTVVQLQAPGVLPSAQPVLAVAGGVTQLPNHVVNVVPAPSANSPVNGKLSVTKPVLQSTMRNVGSDIAVLRRQQRMIKNRESACQSRKKKKEYMLGLEARLKAALSENEQLKKENGTLKRQLDEVVSENQRLKVPSPKRRVVCVMIVLAFIILNYGPMSMLEQDSRRMNPSVGPANQRRHLLGFSAKEAQDTSDGIIQKNSYRYDHSVSNDKALMVLTEEPLLYIPPPPCQPLINTTESLRLNHELRGWVHRHEVERTKSRRMTNNQQKTRILQGVVEQGSNSQLMAVQYTETTSSISRNSGSELQVYYASPRSYQDFFEAIRRRGDTFYVVSFRRDHLLLPATTHNKTTRPKMSIVLPAININENVINGQDYEVMMQIDCQVMDTRILHIKSSSVPPYLRDQQRNQTNTFFGSPPAATEATHVVSTIPESLQ

SEQ ID NO: 26 - DNA, 1103 bp, Homo sapiens
cttcggtcctgctgtagtgccttctgcgccaggcccggttcaatcagcggccacaactgtctagggctcagacaccaccagccaatgagggagggcacgtggagccgcgtctgggctcgcggctcctgaccaatggggaagtggcatgtgggagggcgccggggttccccccgccaatggggagctacggcgcgcggccgggacttggaggcggtgcggcgcggcgggtgcggttcagtcggtcggcggcggcagcggaggaggaggaggaggaggaggatgaggaggatgaggaggatgtgggccacgcaggggctggcggtgcgcgtggctctgagcgtgctgccgggcagccgggcgctgcggccgggcgactgcgaagtttgtatttcttatctgggaagattttaccaggacctcaaagacagagatgtcacattctcaccagccactattgaaaacgaacttataaagttctgccgggaagcaagaggcaaagagaatcggttgtgctactatatcggggccacagatgatgcagccaccaaaatcatcaatgaggtatcaaagcctctggcccaccacatccctgtggagaagatctgtgagaagcttaagaagaaggacagccagatatgtgagcttaagtatgacaagcagatcgacctgagcacagtggacctgaagaagctccgagttaaagagctgaagaagattctggatgactggggggagacatgcaaaggctgtgcagaaaagtctgactacatccggaagataaatgaactgatgcctaaatatgcccccaaggcagccagtgcaccgaccgatttgtagtctgctcaatctctgttgcacctgagggggaaaaaacagttcaactgcttactcccaaaacagcctttttgtaatttattttttaagtgggctcctgacaatactgtatcagatgtgaagcctggagctttcctgatgatgctggccctacagtacccccatgaggggattcccttccttctgttgctggtgtactctaggacttcaaagtgtgtctgggatttttttattaaagaaaaaaaatttctagctgtcaaaaaaaaaaa

SEQ ID NO: 27 - protein, 234 aa, Homo sapiens
MGKWHVGGRRGSPRQWGATARGRDLEAVRRGGCGSVGRRRQRRRRRRRRMRRMRRMWATQGLAVRVALSVLPGSRALRPGDCEVCISYLGRFYQDLKDRDVTFSPATIENELIKFCREARGKENRLCYYIGATDDAATKIINEVSKPLAHHIPVEKICEKLKKKDSQICELKYDKQIDLSTVDLKKLRVKELKKILDDWGETCKGCAEKSDYIRKINELMPKYAPKAASAPTDL

SEQ ID NO: 28 - DNA, 2371 bp, Homo sapiens; identical to SEQ ID NO: 10

SEQ ID NO: 29 - protein, 223 aa, Homo sapiens; identical to SEQ ID NO: 11

SEQ ID NO: 30 - DNA, 1125 bp, Homo sapiens
ttctgccctcgagcccaccgggaacgaaagagaagctctatctcgcctccaggagcccagctatgaactccttctccacaagcgccttcggtccagttgccttctccctggggctgctcctggtgttgcctgctgccttccctgccccagtacccccaggagaagattccaaagatgtagccgccccacacagacagccactcacctcttcagaacgaattgacaaacaaattcggtacatcctcgacggcatctcagccctgagaaaggagacatgtaacaagagtaacatgtgtgaaagcagcaaagaggcactggcagaaaacaacctgaaccttccaaagatggctgaaaaagatggatgcttccaatctggattcaatgaggagacttgcctggtgaaaatcatcactggtcttttggagtttgaggtatacctagagtacctccagaacagatttgagagtagtgaggaacaagccagagctgtgcagatgagtacaaaagtcctgatccagttcctgcagaaaaaggcaaagaatctagatgcaataaccacccctgacccaaccacaaatgccagcctgctgacgaagctgcaggcacagaaccagtggctgcaggacatgacaactcatctcattctgcgcagctttaaggagttcctgcagtccagcctgagggctcttcggcaaatgtagcatgggcacctcagattgttgttgttaatgggcattccttcttctggtcagaaacctgtccactgggcacagaacttatgttgttctctatggagaactaaaagtatgagcgttaggacactattttaattatttttaatttattaatatttaaatatgtgaagctgagttaatttatgtaagtcatatttatatttttaagaagtaccacttgaaacattttatgtattagttttgaaataataatggaaagtggctatgcagtttgaatatcctttgtttcagagccagatcatttcttggaaagtgtaggcttacctcaaataaatggctaacttatacatatttttaaagaaatatttatattgtatttatataatgtataaatggtttttataccaataaatggcattttaaaaaattc

SEQ ID NO: 31 - protein, 212 aa, Homo sapiens
MNSFSTSAFGPVAFSLGLLLVLPAAFPAPVPPGEDSKDVAAPHRQPLTSSERIDKQIRYILDGISALRKETCNKSNMCESSKEALAENNLNLPKMAEKDGCFQSGFNEETCLVKIITGLLEFEVYLEYLQNRFESSEEQARAVQMSTKVLIQFLQKKAKNLDAITTPDPTTNASLLTKLQAQNQWLQDMTTHLILRSFKEFLQSSLRALRQM

SEQ ID NO: 32 - DNA, 19 bp, Artificial Sequence
  Synthetic oligonucleotide
guuggacccugucauguuu

SEQ ID NO: 33 - DNA, 19 bp, Artificial Sequence
  Synthetic oligonucleotide
aaacaugacaggguccaac

SEQ ID NO: 34 - DNA, 19 bp, Artificial Sequence
  Synthetic oligonucleotide
gccauuaaugaacucauuc

SEQ ID NO: 35 - DNA, 19 bp, Artificial Sequence
  Synthetic oligonucleotide
gaaugaguucauuaauggc

SEQ ID NO: 36 - DNA, 21 bp, Artificial Sequence
  Synthetic oligonucleotide
gaagagaaccacaaacuccuu

SEQ ID NO: 37 - DNA, 21 bp, Artificial Sequence
  Synthetic oligonucleotide
ggaguuugugguucucuucuu

SEQ ID NO: 38 - DNA, 21 bp, Artificial Sequence
  Synthetic oligonucleotide
gaggaucacccugaauucauu

SEQ ID NO: 39 - DNA, 21 bp, Artificial Sequence
  Synthetic oligonucleotide
ugaauucagggugauccucuu

SEQ ID NO: 40 - DNA, 20 bp, Artificial Sequence
  Synthetic oligonucleotide
acacgcttgggaatggacac

SEQ ID NO: 41 - DNA, 20 bp, Artificial Sequence
  Synthetic oligonucleotide
ccatgggaagatgttctggg

SEQ ID NO: 42 - DNA, 20 bp, Artificial Sequence
  Synthetic oligonucleotide
tggagttccccagattgaag

SEQ ID NO: 43 - DNA, 20 bp, Artificial Sequence
  Synthetic oligonucleotide
cctgacccacctttttctca

SEQ ID NO: 44 - DNA, 21 bp, Artificial Sequence
  Synthetic oligonucleotide
cuuggacccagucauguucuu

SEQ ID NO: 45 - DNA, 21 bp, Artificial Sequence
  Synthetic oligonucleotide
gaacaugacuggguccaaguu

SEQ ID NO: 46 - DNA, 21 bp, Artificial Sequence
  Synthetic oligonucleotide
aucugcuuucauccagccauu

SEQ ID NO: 47 - DNA, 21 bp, Artificial Sequence
  Synthetic oligonucleotide
uggcuggaugaaagcagauuu

SEQ ID NO: 48 - DNA, 21 bp, Artificial Sequence
  Synthetic oligonucleotide
gccccuagucuuagagauauu

SEQ ID NO: 49 - DNA, 21 bp, Artificial Sequence
  Synthetic oligonucleotide
uaucucuaagacuaggggcuu

SEQ ID NO: 50 - DNA, 21 bp, Artificial Sequence
  Synthetic oligonucleotide
gaaccuguagaagaugaccuu

SEQ ID NO: 51 - DNA, 21 bp, Artificial Sequence
  Synthetic oligonucleotide
ggucaucuucuacagguucuu

SEQ ID NO: 52 - DNA, 1817 bp, Homo sapiens
gcggcgctggcgtagacgtttcctggctatggtggtggtggcagcggcgccgagcgcggccacggcggcccccaaagtgctactcttatctggccagcccgcctccggcggccgggcgctgccgctcatggtacccggtccgcgggcagcagggtcggaggcgagcgggacaccgcaggctcgcaagcggcagcggctcacgcacctgagcccggaggagaaagcgctgcggaggaaactgaaaaacagagtagcagcgcagactgctcgagatagaaagaaagcccggatgagcgagctggagcagcaagtggtggatttggaagaagagaaccacaaactccagctagaaaatcagcttttacgggagaaaactcacggccttgtggttgagaaccaggagttaagaacacgcttgggaatggacacgctggatcctgacgaggttccagaggtggaggccaaggggagtggagtaaggctggtggccgggtctgctgagtccgcagcactcagactatgtgcacctctgcagcaggtgcaggcccagttgtcacctccccagaacatcttcccatggactctgacactgttgcctcttcagattctgagtctgatatccttttgggcattctggacaagttggaccctgtcatgtttttcaaatgtccttccccagagtctgctagtctggaggaactcccagaggtctacccagaaggacctagttccttaccagcctccctttctctgtcagtggggacctcatcagccaagctggaagccattaatgaactcattcgttttgaccatgtatacaccaagcctctagttttagagatcccctctgagacagagagtcaaactaacgtggtagtgaaaattgaggaagcacctctaagctcttcagaagaggatcaccctgaattcattgtctcagtgaagaaagagcctttggaagatgacttcatcccagagctgggcatctcaaacctgctttcatccagccattgtctgagaccaccttcttgcctgctggacgctcacagtgactgtggatatgagggctccccttctcccttcagtgacatgtcttctccacttggtacagaccactcctgggaggatacttttgccaatgaacttttcccccagctgattagtgtctaaagagccacataacactgggcccctttccctgaccatcacattgcctagaggatagcataggcctgtctctttcgttaaaagccaaagtagaggctgtctggccttagaagaattcctctaaagtatttcaaatctcatagatgacttccaagtattgtcgtttgacactcagctgtctaaggtattcaaaggtattccagtactacagcttttgagattctagtttatcttaaaggtggtagtatactctaaatcgcagggagggtcatttgacagttttttcccagcctggcttcaaactatgtagccgaggctaggcagaaacttctgaccctcttgaccccacctcccaagtgctgggcttcaccaggtgtgcacctccacacctgcccccccgacatgtcaggtggacatgggattcatgaatggcccttagcatttctttctccactctctgcttcccaggtttcgtaacctgagggggcttgttttcccttatgtgcattttaaatgaagatcaagaatctttgtaaaatgatgaaaatttactatgtaaatgcttgatggatcttcttgctagtgtagcttctagaaggtgctttctccatttatttaaaactacccttgcaaaaaaaaaaaaaaaaaaa

SEQ ID NO: 53 - protein, 267 aa, Mus musculus
MVVVAAAPSAATAAPKVLLLSGQPASGGRALPLMVPGPRAAGSEASGTPQARKRQRLTHLSPEEKALRRKLKNRVAAQTARDRKKARMSELEQQVVDLEEENHKLQLENQLLREKTHGLVVENQELRTRLGMDTLDPDEVPEVEAKGSGVRLVAGSAESAALRLCAPLQQVQAQLSPPQNIFPWTLTLLPLQILSLISFWAFWTSWTLSCFSNVLPQSLLVWRNSQRSTQKDLVPYQPPFLCQWGPHQPSWKPLMNSFVLTMYTPSL

SEQ ID NO: 54 - DNA, 1761 bp, Homo sapiens
ctcgagctatggtggtggtggcagccgcgccgaacccggccgacgggacccctaaagttctgcttctgtcggggcagcccgcctccgccgccggagccccggccggccaggccctgccgctcatggtgccagcccagagaggggccagcccggaggcagcgagcggggggctgccccaggcgcgcaagcgacagcgcctcacgcacctgagccccgaggagaaggcgctgaggaggaaactgaaaaacagagtagcagctcagactgccagagatcgaaagaaggctcgaatgagtgagctggaacagcaagtggtagatttagaagaagagaaccaaaaacttttgctagaaaatcagcttttacgagagaaaactcatggccttgtagttgagaaccaggagttaagacagcgcttggggatggatgccctggttgctgaagaggaggcggaagccaaggggaatgaagtgaggccagtggccgggtctgctgagtccgcagcaggtgcaggcccagttgtcacccctccagaacatctccccatggattctggcggtattgactcttcagattcagagtctgatatcctgttgggcattctggacaacttggacccagtcatgttcttcaaatgcccttccccagagcctgccagcctggaggagctcccagaggtctacccagaaggacccagttccttaccagcctccctttctctgtcagtggggacgtcatcagccaagctggaagccattaatgaactaattcgttttgaccacatatataccaagcccctagtcttagagataccctctgagacagagagccaagctaatgtggtagtgaaaatcgaggaagcacctctcagcccctcagagaatgatcaccctgaattcattgtctcagtgaaggaagaacctgtagaagatgacctcgttccggagctgggtatctcaaatctgctttcatccagccactgcccaaagccatcttcctgcctactggatgcttacagtgactgtggatacgggggttccctttccccattcagtgacatgtcctctctgcttggtgtaaaccattcttgggaggacacttttgccaatgaactctttccccagctgattagtgtctaaggaatgatccaatactgttgcccttttccttgactattacactgcctggaggatagcagagaagcctgtctgtacttcattcaaaaagccaaaatagagagtatacagtcctagagaattcctctatttgttcagatctcatagatgacccccaggtattgtcttttgacatccagcagtccaaggtattgagacatattactggaagtaagaaatattactataattgagaactacagcttttaagattgtacttttatcttaaaagggtggtagttttccctaaaatacttattatgtaagggtcattagacaaatgtcttgaagtagacatggaatttatgaatggttctttatcatttctcttccccctttttggcatcctggcttgcctccagttttaggtcctttagtttgcttctgtaagcaacgggaacacctgctgagggggctctttccctcatgtatacttcaagtaagatcaagaatcttttgtgaaattatagaaatttactatgtaaatgcttgatggaattttttcctgctagtgtagcttctgaaaggtgctttctccatttatttaaaactacccatgcaattaaaaggccttcgtggcctcgag

SEQ ID NO: 55 - protein, 376 aa, Homo sapiens
MVVVAAAPNPADGTPKVLLLSGQPASAAGAPAGQALPLMVPAQRGASPEAASGGLPQARKRQRLTHLSPEEKALRRKLKNRVAAQTARDRKKARMSELEQQVVDLEEENQKLLLENQLLREKTHGLVVENQELRQRLGMDALVAEEEAEAKGNEVRPVAGSAESAAGAGPVVTPPEHLPMDSGGIDSSDSESDILLGILDNLDPVMFFKCPSPEPASLEELPEVYPEGPSSLPASLSLSVGTSSAKLEAINELIRFDHIYTKPLVLEIPSETESQANVVVKIEEAPLSPSENDHPEFIVSVKEEPVEDDLVPELGISNLLSSSHCPKPSSCLLDAYSDCGYGGSLSPFSDMSSLLGVNHSWEDTFANELFPQLISV

(19) United States
(12) Patent Application Publication
(10) Pub. No.: US 2006/0063187 A1
(43) Pub. Date: Mar. 23, 2006

(54) Modulation of XBP-1 activity for treatment of metabolic disorders

(76) Inventors: Gokhan S. Hotamisligil, Wellesley, MA (US); Laurie H. Glimcher, West Newton, MA (US); Umut Ozcan, Brookline, MA (US)

Correspondence Address: CHOATE, HALL & STEWART/HARVARD UNIVERSITY, TWO INTERNATIONAL PLACE, BOSTON, MA, 02110, US

(21) Appl. No.: 11/227,543

(22) Filed: Sep. 15, 2005

Related U.S. Application Data
(60) Provisional application No. 60/610,286, filed on Sep. 15, 2004.
(60) Provisional application No. 60/610,093, filed on Sep. 15, 2004.

(51) Int. Cl. C40B 40/08; C40B 40/10

(52) U.S. Cl. 435/6; 435/7.1

(57) ABSTRACT

The invention provides methods and compositions for modulating the expression, processing, post-translational modification, stability and/or activity of XBP-1 protein, or a protein in a signal transduction pathway involving XBP-1 to treat metabolic disorders, e.g., type II diabetes. The present invention also pertains to methods for identifying compounds that modulate the expression, processing, post-translational modification, and/or activity of XBP-1 protein or a molecule in a signal transduction pathway involving XBP-1.

### RELATED APPLICATIONS

The present application claims priority under 35 U.S.C. § 119(e) to U.S. provisional patent application, U.S. Ser. No. 60/610,286, filed Sep. 15, 2004. This application is related to U.S. Ser. No. 10/655,620, filed Sep. 2, 2003, entitled “Methods and Compositions for Modulating XBP-1 Activity.” This application is also related to U.S. provisional patent application, U.S. Ser. No. 60/610,093, filed Sep. 15, 2004, entitled “Reducing ER Stress in the Treatment of Obesity and Diabetes,” and U.S. patent application, U.S. Ser. No. XX/XXX,XXX, filed Sep. 15, 2005, entitled “Reducing ER Stress in the Treatment of Obesity and Diabetes.” The entire contents of each of these applications is incorporated herein by reference.

### GOVERNMENT SUPPORT

Work described herein was supported, at least in part, under NIH Grant No. 32412 awarded by the National Institutes of Health. The United States government may have certain rights in the invention.

### BACKGROUND OF THE INVENTION

Diabetes affects more than 5% of the US population (Zimmet and Shaw. 2001 Nature 414:782; incorporated herein by reference). Type 2 diabetes is the most common form of diabetes. It is a metabolic disease characterized by defective insulin secretion and insulin resistance. (Saltiel and Kahn. 2001. Nature 414:799; incorporated herein by reference). Obesity is a major risk factor for the development of type 2 diabetes. Obesity is the result of an imbalance between caloric intake and energy expenditure and is highly correlated with insulin resistance and diabetes in experimental animals and humans. Many of the pathological consequences of obesity are thought to involve insulin resistance. These consequences include hypertension, hyperlipidemia, and type 2 diabetes. This cluster of pathologies, known as metabolic syndrome, has become one of the most serious threats to human health. The dramatic increase in the incidence of obesity in most parts of the world has contributed to the emergence of this disease cluster, particularly insulin resistance and type 2 diabetes. Unfortunately, understanding the molecular mechanisms underlying these individual disorders and their links with each other has been extremely challenging. In the past decade, a model has emerged wherein stress and inflammatory signaling abnormalities and their integration with metabolic regulation have assumed a central position in the mechanisms underlying many of these disorders (G. S. Hotamisligil, in Diabetes Mellitus D. LeRoith, S. I. Taylor, J. M. OLefsky, Eds. Lippincott Williams & Wilkins, Philadelphia, 2003 pp. 953-962; G. S. Hotamisligil. 2003. Int J Obes Relat Metab Disord 27 Suppl 3, S53-5, each of which is incorporated herein by reference. Previous studies have identified JNK (WO 02/085396; Hirosumi et al. 2002. Nature 420:333; each of which is incorporated herein by reference), IKK-β (U.S. Pat. No. 6,630,312; incorporated herein by reference), TNF-α (U.S. Pat. No. 5,730,975; incorporated herein by reference) and PERK (Harding et al. 2001. Molecular Cell. 7:1153; incorporated herein by reference) as being potentially important in the development of diabetes, however, neither the cause of the inflammatory response associated with obesity nor the events that result in the deterioration of insulin action and the development of type 2 diabetes are completely understood.

The further identification of molecular mechanisms involved in the development of metabolic disorders such as type 2 diabetes would lead to identification of new drug targets and would provide methods of ameliorating the disease and, therefore, would be of great benefit.

### SUMMARY OF THE INVENTION

The present invention demonstrates a role for the transcription factor XBP-1 in metabolic disorders, including type 2 diabetes. Although previous studies have identified JNK and PERK as being potentially important in the development of diabetes, XBP-1 is involved in a separate arm of the unfolded protein response than PERK, and JNK is involved in signal transduction pathways that do not involve XBP-1. Consequently, prior to the instant invention, there was no teaching or suggestion in the art that XBP-1 played a key role in metabolic disorders such as type 2 diabetes.

Accordingly, in one aspect, the invention pertains to a method of identifying a compound useful in treating at least one symptom of a metabolic disorder comprising, providing an indicator composition comprising mammalian XBP-1, contacting the indicator composition with each member of a library of test compounds, selecting from the library of test compounds a compound of interest that increases the expression, activity, and/or stability of spliced XBP-1 to thereby identify a compound useful in treating at least one symptom of a metabolic disorder.

In one embodiment, the activity of XBP-1 is measured by measuring the phosphorylation of PERK or eIF2α. In another embodiment, the indicator composition comprises an indicator gene whose expression is regulated by XBP-1 and the activity of XBP-1 is determined by measuring the expression or activity of the indicator gene. In one embodiment, the indicator gene is a chaperone gene. In another embodiment, the indicator gene comprises the regulatory region of XBP-1 operably linked to a nucleotide sequence encoding a measurable polypeptide and expression or activity of the polypeptide is measured. In one embodiment, the chaperone gene is selected from the group consisting of: ERdj4, p58^{ipk}, EDEM, PDI-P5, RAMP4, HEDJ, BiP, ATF6α, XBP-1, Armet, and DNAJB9. In one embodiment, the measurable polypeptide is a reporter polypeptide. In one embodiment, the metabolic disorder is obesity. In another embodiment, the metabolic disorder is insulin resistance. In yet another embodiment, the metabolic disorder is type 2 diabetes.

Another aspect of the invention features a method of increasing insulin sensitivity in a cell comprising contacting a cell with an agent that increases the expression or activity of spliced XBP-1 in the cell such that insulin sensitivity is increased.

Yet another aspect of the invention features a method of upmodulating glucose metabolism in a mammalian cell comprising contacting a cell with an agent that increases the expression, processing, post-translational modification, and/or activity of spliced XBP-1 in the cell such that glucose metabolism is decreased.

In one embodiment, the agent is selected from the group consisting of: nucleic acid molecules encoding a biologically active portion of XBP-1, biologically active portions of XBP-1, and expression vectors encoding XBP-1 that allow for increased expression of XBP-1 activity in a cell, and chemical compounds that act to specifically increase the activity of XBP-1.

One aspect of the invention features a method for treating at least one symptom of a metabolic disorder in a subject comprising upmodulating the expression, processing, post-translational modification, and/or activity of spliced XBP-1 to thereby treat at least one symptom of a metabolic disorder. In one embodiment, the metabolic disorder is obesity. In another embodiment, the metabolic disorder is insulin resistance. In yet another embodiment, the metabolic disorder is type 2 diabetes. In one embodiment, the agent is selected from the group consisting of: nucleic acid molecules encoding a biologically active portion of XBP-1, biologically active portions of XBP-1, and expression vectors encoding XBP-1 that allow for increased expression of XBP-1 activity in a cell, and chemical compounds that act to specifically increase the activity of XBP-1.

Another aspect of the invention features a method for diagnosing a subject at risk for developing a metabolic disorder comprising measuring the level expression of spliced XBP-1, wherein a decrease in the level of expression of spliced form of XBP-1 relative to a control indicates that the subject is at risk of developing a metabolic disorder.

Yet another aspect of the invention features a method for diagnosing a subject at risk for developing a metabolic disorder comprising measuring the level expression of a gene whose expression is upregulated by spliced XBP-1, wherein a decrease in the level of expression of the gene relative to a control indicates that the subject is at risk of developing a metabolic disorder.

In one embodiment, the metabolic disorder is obesity. In another embodiment, the metabolic disorder is insulin resistance. In yet another embodiment, the metabolic disorder is type 2 diabetes. In another embodiment, the gene is selected from the group consisting of: ERdj4, p58^{ipk}, EDEM, PDI-P5, RAMP4, HEDJ, BiP, ATF6α, XBP-1, Armet, and DNAJB9.

### BRIEF DESCRIPTION OF THE FIGURES

FIG. 1 depicts that Endoplasmic Reticulum (ER) stress is increased in obesity. Dietary (high fat diet-induced) and genetic (ob/ob) models of mouse obesity were used to examine markers of ER stress in liver tissue compared with age and sex matched lean controls. (A) ER stress markers including eIF2α phosphorylation (p-eIF2α), PERK phosphorylation (p-PERK), and JNK activity were examined in the liver samples of the male mice (C57BL/6) that were kept either on standard diet (RD) or high fat diet (HFD) for 16 weeks. (B) Examination of the same ER stress markers in the livers of male ob/ob and WT lean mice at the age of 12-14 weeks. (C) Northern blot analysis of GRP78 mRNA in the livers of mice with dietary-induced obesity and lean controls. (D) Northern blot analysis of GRP78 mRNA in the livers of ob/ob and WT lean mice. Ethidium bromide staining is shown as a control for loading and integrity of RNA.

FIG. 2 depicts that the induction of ER stress impairs insulin action through JNK mediated phosphorylation of IRS-1. (A) ER stress was induced in Fao liver cells by a 3-hour treatment with 5 μg/ml tunicamycin (Tun). Cells were subsequently stimulated with insulin (Ins). IRS-1 tyrosine and serine (Ser307) phosphorylation, Akt phosphorylation (Ser473), insulin receptor (IR) tyrosine phosphorylation, and their total protein levels were examined using either immunoprecipitation (IP) followed by immunoblotting (IB) or direct immunoblotting. (B) Quantitation of IRS-1 (tyrosine and Ser307), Akt (Ser473), and IR (tyrosine) phosphorylation under the experimental conditions described in (A) with normalization to protein levels for each molecule. (C) Inhibition of ER stress-induced (300 nM thapsigargin for 4 hours) Ser307 phosphorylation of IRS-1 by JNK-1 inhibitor, SP600125 (JNKi, 25 μM). (D) Quantitation of IRS-1 Ser307 phosphorylation under conditions described in (C). (E) Reversal of ER stress-induced inhibition of insulin-stimulated tyrosine phosphorylation (pY) of IRS-1 by a JNK inhibitor. (F) Quantitation of insulin-induced IRS-1 tyrosine phosphorylation levels described in (E). (G) JNK activity, Ser307 phosphorylation of IRS-1, and total IRS-1 levels at indicated times following tunicamycin treatment (Tun, 10 μg/ml for I hour) in IRE-1α^{+/+} and IRE-1α^{-/-} fibroblasts. (H) Insulin-stimulated IRS-1 tyrosine phosphorylation and total IRS-1 levels following tunicamycin treatment (Tun, 10 μg/ml for 1 hour) in IRE-1α^{+/+} and IRE-1α^{-/-} fibroblasts. Quantitation of insulin-induced IRS-1 tyrosine phosphorylation levels in IRE-1α^{+/+} and IRE-1α^{-/-} cells is displayed in the bottom of the panel. All graphs show mean ±SEM from at least 2 independent experiments and statistical significance from the controls is indicated by * with p<0.005.

FIG. 3 depicts that alteration of the ER stress response by manipulation of XBP-1 levels leads to alterations in insulin receptor signaling. ER stress responses in XBP-1s overexpressing cells, XBP-1^{-/-} cells, and their controls. (A) Induction of XBP-1s expression upon removal of doxycycline in mouse embryonic fibroblasts (MEF). (B) Southern blot analysis of XBP-1^{-/-} MEF cells and their WT controls for the wild type (9.4 kb) and targeted (6.5 kb) alleles. (C) PERK phosphorylation (p-PERK) and JNK activity in the XBP-1s overexpressing cells and their control cells (−Dox and +Dox, respectively) upon tunicamycin treatment (Tun, 2 μg/ml). (D) PERK phosphorylation and JNK activity upon low dose tunicamycin treatment (Tun, 0.5 μg/ml) in XBP-1^{-/-}-MEF cells and their WT controls. (E) IRS-1 Ser307 phosphorylation upon tunicamycin treatment (Tun, 2 μg/ml) in the XBP-1s overexpressingcells and the control cells (−Dox and +Dox, respectively), detected using immunoprecipitation (IP) of IRS-1 followed by immunoblotting (IB) with an IRS-1 phosphoserine 307-specific antibody. The graph next to the blots shows the quantitation of IRS-1 Ser307 phosphorylation under conditions described in panel E. (F) Insulin-stimulated tyrosine phosphorylation of IRS-1 in the XBP-1s overexpressing cells and controls cells with or without tunicamycin treatment (Tun, 2 μg/ml). The ratio of IRS-1 tyrosine phosphorylation to total IRS-1 level was summarized from independent experiments and was presented in the graph. (G) IRS-1 Ser307 phosphorylation upon tunicamycin treatment (Tun, 0.5 μg/ml) in XBP-1^{-/-} cells and WT controls was detected as described in panel C. The graph next to the blots shows the quantitation of IRS-1 Ser307 phosphorylation under conditions described in panel G. (H) Insulin-stimulated tyrosine phosphorylation of IRS-1 in XBP-1^{-/-} and WT control cells with or without tunicamycin treatment (Tun, 0.5 μg/ml). The ratio of IRS-1 tyrosine phosphorylation to total IRS-1 level was summarized from independent experiments and presented in the graph. All graphs show mean±SEM from at least 2 independent experiments and statistically significance from the controls is indicated by * with p<0.005.

FIG. 4 depicts the glucose homeostasis in XBP-1^{±} mice on high fat diet. The XBP-1^{±} (open diamond) and XBP-1^{+/+} (filled square) mice were placed on high fat diet (HFD) immediately after weaning. Total body weight (A), fasting blood insulin (B), C-peptide (C), and glucose (D) levels were measured in the XBP-1^{±} and XBP-1^{+/+} mice during the course of HFD. Glucose tolerance tests were performed after 7 (E) and 16 (F) weeks on HFD in XBP-1^{±} and XBP-1^{+/+} mice. Insulin tolerance tests were performed after 8 (G) and 17 (H) weeks on HFD in XBP-1^{±} and XBP-1^{+/+} mice. n=11 XBP-1^{±} mice; n=8 XBP-1^{+/+} mice. Data are shown as mean±SEM. Statistical significance in two-tailed student t test at p≦0.05 is indicated by *, p≦0.005 by ** and p≦0.0005 by ***. XBP-1^{±} and XBP-1^{+/+} groups are also compared by ANOVA (panels A-H).

FIG. 5 depicts ER stress and insulin receptor signaling in XBP-1^{±} mice. PERK phosphorylation (p-PERK) (A), JNK activity (p-c-Jun) (B), and IRS-1 Ser307 (IRS-1pSer307) (C) were examined in the livers of XBP-1^{±} and XBP-1^{+/+} mice after 16 weeks on high fat diet. After infusion of insulin (1U/kg) through the portal vein, insulin receptor (IR) tyrosine phosphorylation (pY) (D), IRS-1 tyrosine phosphorylation (E), IRS-2 tyrosine phosphorylation (F), and Akt Ser473 phosphorylation (G) were examined in livers of XBP-1^{±} and XBP-1^{+/+} mice after 16 weeks on high fat diet.

FIG. 6 depicts the regulation of GRP78 expression by glucose in vitro and hyperglycemia in vivo. (A) Fao cells were treated with various doses of glucose (0, 5, 10, 25, and 75 mM) for 24 hours. The mRNA level of GRP78 was examined by Northern blot using the total RNAs isolated from these cells. Ethidium bromide staining is shown as a control for loading and integrity of RNA. (B) Streptozotocin (STZ, 200 mg/kg) was injected intaperitoneally into male mice. Three days after injection, blood glucose levels were measured to confirm STZ-induced hyperglycemia. Livers were collected 10 days after injection and GRP78 expression was examined by Northern blot analysis using the liver total RNA.

FIG. 7 depicts ER stress indicators in adipose tissues of obese mice. Dietary (high fat diet-induced) and genetic (ob/ob) models of mouse obesity were used to examine markers of ER stress in adipose tissue compared with age and sex matched lean controls. (A) PERK phosphorylation (p-PERK) and JNK activity were examined in the adipose samples of the male mice (C57BL/6) that were kept either on standard diet (RD) or high fat diet (HFD) for 16 weeks. (B) PERK phosphorylation and JNK activity in the adipose tissues of male ob/ob and WT lean mice at the ages of 12-14 weeks. (C) The mRNA levels of GRP78 were examined by Northern blot analysis in the adipose tissues of WT lean and ob/ob animals. Ethidium bromide staining is shown as a control for loading and integrity of RNA.

FIG. 8 depicts inhibition of insulin receptor signaling by thapsigargin-induced ER stress and the role of Ca⁺² levels in IRS-1 serine phosphorylation. (A) ER stress was induced in Fao cells by 1 hour treatment with 300 nM thapsigargin (Thap), and cells were subsequently stimulated with insulin (Ins). IRS-1 tyrosine phosphorylation (pY) and serine phosphorylation (pSer307), insulin receptor (IR) tyrosine phosphorylation, and total protein levels were examined using either immunoprecipitation (UP) followed by immunoblotting (IB) or direct immunobloting. (B) Fao cells were treated with sulindac sulfide (SS: 0, 7.5, 30, and 60 μM) for 45 minutes with or without an additional hour of exposure to 300 nM thapsigargin (Thap). IRS-1 serine phosphorylation and total IRS-1 protein levels were examined as described above.

FIG. 9 depicts insulin-induced insulin receptor autophosphorylation in XBP-1 overexpressing and XBP-1-deficient cells. (A) XBP-1 overexpressing cells and their control MEF cells (−Dox and +Dox, respectively) were treated with 2 μg/ml tunicamycin (Tun) for various period (0, 0.5, 1, 2, 3, and 4 hours). Insulin-induced insulin receptor (IR) tyrosine phosphorylation (pY) and total IR levels were examined in those cells using immunoprecipitation (IP) with IR antibody followed by immunoblotting (IB) with antibodies against IR or phospho tyrosine (pY). (B) XBP-1^{-/-} MEF cells and their WT controls were treated with 0.5 μg/ml tunicamycin for various period (0, 0.5, 1, 2, 3, and 4 hours). Insulin-induced insulin receptor (IR) tyrosine phosphorylation (pY) and total IR levels were examined as in panel A.

FIG. 10 depicts insulin sensitivity in XBP-1^{±}-and XBP-1^{+/+} mice. In XBP-1^{±} and XBP-1^{+/+} mice placed on regular diet, blood insulin (A) and c-peptide (B) levels were measured, and glucose tolerance test (C) and insulin tolerance test (D) were performed at 16 weeks of age. On chow diet, there was also no difference in blood glucose levels, C-peptide levels, and insulin sensitivity measured by glucose and insulin tolerance tests in mice followed up to 18 weeks of age.

FIG. 11 depicts the characterization of pancreatic islets in XBP-1^{±} and XBP-1^{+/+} mice. Islet morphology, size and immuno-histochemical staining for insulin and glucagon in pancreatic sections obtained from XBP-1^{±} and XBP^{+/+} mice on either regular diet (A-D) or HFD (E-H). Glucose-stimulated insulin secretion in XBP-1^{±} and XBP-1^{+/+} mice on high fat diet. Glucose-stimulated insulin secretion was examined in XBP-1^{±} and WT mice placed on high fat diet for 16 weeks (I). Glucose was administered introperitoneally to mice in each genotype and blood samples are collected at the indicated times for insulin measurements.

FIG. 12 depicts intact insulin receptor signaling in liver and adipose tissues of XBP-1^{±} and XBP-1^{+/+} mice on regular diet. After infusion of insulin (1U/kg) through portal vein, insulin receptor (IR) tyrosine phosphorylation (pY), IRS-1 tyrosine phosphorylation, IRS-2 tyrosine phosphorylation, Akt Ser473 phosphorylation, and their total protein levels were examined in livers (A) and adipose tissues (B) of XBP-1^{±} and XBP^{+/+} mice on regular diet.

FIG. 13 depicts reduced insulin receptor signaling in adipose tissues of XBP-1^{±} and XBP-1^{+/+} mice on high fat diet. (A) After infusion of insulin (1U/kg) through portal vein, insulin receptor (IR) tyrosine phosphorylation (pY), IRS-1 tyrosine phosphorylation, IRS-2 tyrosine phosphorylation, Akt Ser473 phosphorylation, and their total protein levels were examined in adipose tissues of XBP-1^{±} and XBP^{+/+} mice on high fat diet for 16 weeks. (B) JNK kinase assay was performed in adipose tissues of XBP-1^{±} and XBP^{+/+} mice on high fat diet for 16 weeks.

FIG. 14 shows the anti-diabetic effects of XBP-1. The active, spliced form of XBP-1 (XBP-1s) protein is transgenically expressed in the livers of mice. These XBP-1s transgenic (XBP1-Tg) animals along with their wild type (WT) non-transgenic controls were placed on a high fat diet for 16 weeks which results in increased blood glucose levels and decreased systemic insulin action (insulin resistance). At 16 weeks, blood glucose levels were determined (A). Blood glucose levels in the transgenic, XBP-1s producing animals were significantly lower (*) than wild type controls. Insulin action was further evaluated by performing glucose tolerance tests (B) and insulin tolerance tests (C). In both of these tests, transgenic XBP-1s producing animals performed superior to wild type controls. The glucose disposal curves in transgenic animals demonstrated better glucose homeostasis and insulin sensitivity in both tests. Asterix indicates statistically siginificant differences.

### DETAILED DESCRIPTION OF CERTAIN PREFERRED EMBODIMENTS OF THE INVENTION

The instant invention is based, at least in part, on the finding that XBP-1 plays a role in modulating metabolic disorders, such as type 2 diabetes. These findings provide for assays to identify agents that modulate the expression and/or activity of XBP-1 (and other molecules in the pathways in which XBP-1 is involved) which are useful in modulating the symptoms of metabolic disorders and provide for the use of such agents to treat metabolic disorders.

Certain terms are first defined so that the invention may be more readily understood.

I. Definitions

As used herein, the term “XBP-1” refers to a X-box binding human protein that is a DNA binding protein and has an amino acid sequence as described in, for example, Liou, H-C. et. al. (1990) Science 247:1581-1584 and Yoshimura, T. et al. (1990) EMBO J. 9:2537-2542, each of which is incorporated herein by reference, and other mammalian homologs thereof, such as described in Kishimoto T. et al., (1996) Biochem. Biophys. Res. Commun. 223:746-751 (rat homologue), incorporated herein by reference. Exemplary proteins intended to be encompassed by the term “XBP-1” include those having amino acid sequences disclosed in GenBank with accession numbers A36299 [gi:105867]; AF443192 [gi: 18139942] (SEQ ID NO.:2; spliced murine XBP-1); P17861 [gi:139787]; CAA39149 [gi:287645]; AF027963 [gi: 13752783] (SEQ ID NO.:53; murine unspliced XBP-1); BAB82982.1 [gi: 18148382] (SEQ ID NO.:55; spliced human XBP-1); BAB82981 [gi:18148380] (SEQ ID NO.:4; human unspliced XBP-1); and BAA82600 [gi:5596360] or e.g., encoded by nucleic acid molecules such as those disclosed in GenBank with accession numbers AF027963 [gi: 13752783]; NM_{—}013842 [gi:13775155] (SEQ ID NO.:1; spliced murine XBP-1); or M31627 [gi:184485] (SEQ ID NO.:52; unspliced murine XBP-1); AB076384 [gi:18148381] (SEQ ID NO.:54; spliced human XBP-1); or AB076383 [gi: 18148379] (SEQ ID NO.:3; human unspliced XBP-1). XBP-1 is also referred to in the art as TREB5 or HTF (Yoshimura et al. 1990. EMBO Journal. 9:2537; Matsuzaki et al. 1995. J. Biochem. 117:303; each of which is incorporated herein by reference).

XBP-1 is a basic region leucine zipper (b-zip) transcription factor isolated independently by its ability to bind to a cyclic AMP response element (CRE)-like sequence in the mouse class II MHC Aα gene or the CRE-like site in the HTLV-1 21 base pair enhancer, and subsequently shown to regulate transcription of both the DRα and HTLV-1 Itr gene.

Like other members of the b-zip family, XBP-1 has a basic region that mediates DNA-binding and an adjacent leucine zipper structure that mediates protein dimerization. Deletional and mutational analysis identified transactivation domains in the C-terminus of XBP-1 in regions rich in acidic residues, glutamine, serine/threonine and proline/glutamine. XBP-1 is present at high levels in plasma cells in joint synovium in patients with rheumatoid arthritis. In human multiple myeloma cells, XBP-1 is selectively induced by IL-6 treatment and implicated in the proliferation of malignant plasma cells.

As described above, there are two forms of XBP-1 protein, unspliced and spliced, which differ markedly in their sequence and activity. Unless the form is referred to explicitly herein, the term “XBP-1” as used herein includes both the spliced and unspliced forms. Spliced XBP-1 protein directly controls the activation of the UPR, control plasma differentiation and control the production of the myeloma cell survival cytokine IL-6, while unspliced XBP-1 functions in these pathways only due to its ability to negatively regulate spliced XBP-1.

As used herein, the term “spliced XBP-1” refers to the spliced, processed form of the mammalian XBP-1 mRNA or the corresponding protein. Human and murine XBP-1 mRNA contain an open reading frame (ORF1) encoding bZIP proteins of 261 and 267 amino acids, respectively. Both mRNA's also contain another ORF, ORF2, partially overlapping but not in frame with ORF1. ORF2 encodes 222 amino acids in both human and murine cells. Human and murine ORF1 and ORF2 in the XBP-1 mRNA share 75% and 89% identity respectively. In response to ER stress, XBP-1 mRNA is processed by the ER transmembrane endoribonuclease and kinase IRE-1 which excises an intron from XBP-1 mRNA. In murine and human cells, a 26 nucleotide intron is excised. The boundaries of the excised introns are encompassed in an RNA structure that includes two loops of seven residues held in place by short stems. The RNA sequences 5′ to 3′ to the boundaries of the excised introns form extensive base-pair interactions. Splicing out of 26 nucleotides in murine and human cells results in a frame shift at amino acid 165 (the numbering of XBP-1 amino acids herein is based on GenBank accession number NM_{—}013842[gi:13775155)(SEQ ID NO.:1—nucleic acid; SEQ ID NO.:2—amino acid; spliced murine XBP-1) and one of skill in the art can determine corresponding amino acid numbers for XBP-1 from other organisms, e.g., by performing a simple alignment). This causes removal of the C-terminal 97 amino acids from the first open reading frame (ORF1) and addition of the 212 amino from ORF2 to the N-terminal 164 amino acids of ORF1 containing the b-ZIP domain. In mammalian cells, this splicing event results in the conversion of a 267 amino acid unspliced XBP-1 protein to a 371 amino acid spliced XBP-1 protein. The spliced XBP-1 then translocates into the nucleus where it binds to its target sequences to induce their transcription.

As used herein, the term “unspliced XBP-1” refers to the unprocessed XBP-1 mRNA or the corresponding protein. As set forth above, unspliced murineXBP-1 is 267 amino acids in length and spliced murine XBP-1 is 371 amino acids in length. The sequence of unspliced XBP-1 is known in the art and can be found, e.g., Liou, H-C. et. al. (1990) Science 247:1581-1584 and Yoshimura, T. et al. (1990) EMBO J. 9:2537-2542, or at GenBank accession numbers: AF443192 [gi: 18139942] (SEQ ID NO.:2; amino acid spliced murine XBP-1); AF027963 [gi: 13752783] (SEQ ID NO.:53; amino acid murine unspliced XBP-1); NM_{—}013842 [gi:13775155] (SEQ ID NO.:1; nucleic acid spliced murine XBP-1); or M31627 [gi: 184485] (SEQ ID NO.:52; nucleic acid unspliced murine XBP-1.

As used herein, the term “ratio of spliced to unspliced XBP-1” refers to the amount of spliced XBP-1 present in a cell or a cell-free system, relative to the amount or of unspliced XBP-1 present in the cell or cell-free system. “The ratio of unspliced to spliced XBP-1” refers to the amount of unspliced XBP-1 compared to the amount of unspliced XBP-1. “Increasing the ratio of spliced XBP-1 to unspliced XBP-1” encompasses increasing the amount of spliced XBP-1 or decreasing the amount of unspliced XBP-1 by, for example, promoting the degradation of unspliced XBP-1. Increasing the ratio of unspliced XBP-1 to spliced XBP-1 can be accomplished, e.g., by decreasing the amount of spliced XBP-1 or by increasing the amount of unspliced XBP-1. Levels of spliced and unspliced XBP-1 an be determined as described herein, e.g., by comparing amounts of each of the proteins which can be distinguished on the basis of their molecular weights or on the basis of their ability to be recognized by an antibody. In another embodiment described in more detail below, PCR can be performed employing primers with span the splice junction to identify unspliced XBP-1 and spliced XBP-1 and the ratio of these levels can be readily calculated.

As used herein, the term “IRE-1” refers to an ER transmembrane endoribonuclease and kinase called “iron responsive element binding protein-1,” which oligomerizes and is activated by autophosphorylation upon sensing the presence of unfolded proteins, see, e.g., Shamu et al., (1996) EMBO J. 15: 3028-3039, incorporated herein by reference. In Saccharomyces cerevisiae, the UPR is controlled by IREp. In the mammalian genome, there are two homologs of IRE-1, IRE1α and IRE1β. IRE1α is expressed in all cells and tissue whereas IRE1β is primarily expressed in intestinal tissue. The endoribonucleases of either IRE1α and IRE1β are sufficient to activate the UPR. Accordingly, as used herein, the term “IRE-1” includes, e.g., IRE1α, IRE1β and IREp. In a preferred embodiment, RE-1 refers to IRE1α.

IRE-1 is a large protein having a transmembrane segment anchoring the protein to the ER membrane. A segment of the IRE-1 protein has homology to protein kinases and the C-terminal has some homology to RNAses. Over-expression of the IRE-1 gene leads to constitutive activation of the UPR. Phosphorylation of the IRE-1 protein occurs at specific serine or threonine residues in the protein.

IRE-1 senses the overabundance of unfolded proteins in the lumen of the ER. The oligomerization of this kinase leads to the activation of a C-terminal endoribonuclease by trans-autophosphorylation of its cytoplasmic domains. IRE-1 uses its endoribonuclease activity to excise an intron from XBP-1 mRNA. Cleavage and removal of a small intron is followed by re-ligation of the 5′ and 3′ fragments to produce a processed mRNA that is translated more efficiently and encodes a more stable protein (Calfon et al. (2002) Nature 415(3): 92-95; incorporated herein by reference). The nucleotide specificity of the cleavage reaction for splicing XBP-1 is well documented and closely resembles that for IRE-p mediated cleavage of HAC1 mRNA (Yoshida et al. (2001) Cell 107:881-891; incorporated herein by reference). In particular, RE-1 mediated cleavage of murine XBP-1 cDNA occurs at nucleotides 506 and 532 and results in the excision of a 26 base pair fragment (e.g., CAGCACTCAGACTACGTGCACCTCTG (SEQ ID NO:5) for mouse XBP-1). IRE-1 mediated cleavage of XBP-1 derived from other species, including humans, occurs at nucleotides corresponding to nucleotides 506 and 532 of murine XBP-1 cDNA, for example, between nucleotides 5012 and 502 and 526 and 527 of human XBP-1.

As used herein, the term “activating transcription factors 6” include ATF6α and ATF6β. ATF6 is a member of the basic-leucine zipper family of transcription factors. It contains a transmembrane domain and is located in membranes of the endoplasmic reticulum. ATF6 is constitutively expressed in an inactive form in the membrane of the ER. Activation in response to ER stress results in proteolytic cleavage of its N-terminal cytoplasmic domain by the S2P serine protease to produce a potent transcriptional activator of chaperone genes (Yoshida et al. 1998 J. Biol. Chem. 273: 33741-33749; Li et al. 2000 Biochem J 350 Pt 1: 131-138; Ye et al. 2000 Mol Cell 6: 1355-1364; Yoshida et al. 2001 Cell 107: 881-891; Shen et al. 2002 Dev Cell 3: 99-111; each of which is incorporated herein by reference). The recently described ATF6β is closely related structurally to ATF6α and posited to be involved in the UPR (Haze et al. 2001 Biochem J 355: 19-28; Yoshida et al. 2001b Mol Cell Biol 21: 1239-1248; each of which is incorporated herein by reference). The third pathway acts at the level of posttranscriptional control of protein synthesis. An ER transmembrane component, PEK/PERK, related to PKR (interferon-induced double-stranded RNA-activated protein kinase) is a serine/threonine protein kinase that acts in the cytoplasm to phosphorylate eukaryotic initiation factor-2α (eIF2α). Phosphorylation of eIF2α results in translation attenuation in response to ER stress(Shi et al. 1998 Mol. Cell. Biol. 18: 7499-7509; Harding et al. 1999 Nature 397: 271-274; each of which is incorporated herein by reference).

As used herein, the various forms of the term “modulate” include stimulation (e.g., increasing or upregulating a particular response or activity) and inhibition (e.g., decreasing or downregulating a particular response or activity).

As used herein, the term “a modulator of XBP-1” includes a modulator of XBP-1 expression, processing, post-translational modification, stability, and/or activity. The term includes agents, for example a compound or compounds which modulates transcription of an XBP-1 gene, processing of an XBP-1 mRNA (e.g., splicing), translation of XBP-1 mRNA, post-translational modification of an XBP-1 protein (e.g., glycosylation, ubiquitination) or activity of an XBP-1 protein. In one embodiment, a modulator modulates one or more of the above. In preferred embodiments, the activity of XBP-1 is modulated. A “modulator of XBP-1 activity” includes compounds that directly or indirectly modulate XBP-1 activity. For example, an indirect modulator of XBP-1 activity can modulate a non-XBP-1 molecule which is in a signal transduction pathway that includes XBP-1. Examples of modulators that directly modulate XBP-1 expression, processing, post-translational modification, and/or activity include nucleic acid molecules encoding a biologically active portion of XBP-1, biologically active portions of XBP-1, antisense or siRNA nucleic acid molecules that bind to XBP-1 mRNA or genomic DNA, intracellular antibodies that bind to XBP-1 intracellularly and modulate (i.e., inhibit) XBP-1 activity, XBP-1 peptides that inhibit the interaction of XBP-1 with a target molecule (e.g., IRE-1) and expression vectors encoding XBP-1 that allow for increased expression of XBP-1 activity in a cell, dominant negative forms of XBP-1, as well as chemical compounds that act to specifically modulate the activity of XBP-1.

As used interchangeably herein, the terms “XBP-1 activity,” “biological activity of XBP-1” or “functional activity XBP-1,” include activities exerted by XBP-1 protein on an XBP-1 responsive cell or tissue, e.g., a hepatocyte, a B cell, or on an XBP-1 nucleic acid molecule or protein target molecule, as determined in vivo, or in vitro, according to standard techniques. XBP-1 activity can be a direct activity, such as an association with an XBP-1-target molecule e.g., binding of spliced XBP-1 to a regulatory region of a gene responsive to XBP-1 (for example, a gene such as ERdj4, p58^{ipk}, EDEM, PDI-P5, RAMP4, HEDJ, BiP, ATF6α, XBP-1, Armet and/or DNAJB9) or the inhibition of spliced XBP-1 by unspliced XBP-1. Alternatively, an XBP-1 activity is an indirect activity, such as a downstream biological event mediated by interaction of the XBP-1 protein with an XBP-1 target molecule, e.g., IRE-1. The biological activities of XBP-1 are described herein and include: e.g., modulation of the UPR, modulation of cellular differentiation, modulation of IL-6 production, modulation of immunoglobulin production, modulation of the proteasome pathway, modulation of protein folding and transport, modulation of terminal B cell differentiation, modulation of apoptosis, modulation of insulin resistance, modulation of insulin resceptor signaling, and modulation of a metabolic disorder. These findings provide for the use of XBP-1 (and other molecules in the pathways in which XBP-1 is involved) for as drug targets and as targets for modulation of these biological activities in cells and for therapeutic intervention in diseases such as malignancies, acquired immunodeficiencies, autoimmune disorders, and metabolic disorders. The invention yet further provides immunomodulatory compositions, such as vaccines, comprising agents which modulate XBP-1 activity.

“Activity of unspliced XBP-1” includes the ability to modulate the activity of spliced XBP-1. In one embodiment, unspliced XBP-1 competes for binding to target DNA sequences with spliced XBP-1. In another embodiment, unspliced XBP-1 disrupts the formation of homodimers or heterodimers (e.g., with cfos or ATF6α) by XBP-1.

As used interchangeably herein, “IRE-1 activity,” “biological activity of IRE-1” or “functional activity IRE-1,” includes an activity exerted by IRE-1 on an IRE-1 responsive target or substrate, as determined in vivo, or in vitro, according to standard techniques (Tirasophon et al. 2000. Genes Dev. 2000 14: 2725-2736; incorporated herein by reference), IRE-1 activity can be a direct activity, such as a phosphorylation of a substrate (e.g., autokinase activity) or endoribonuclease activity on a substrate e.g., XBP-1 mRNA. In another embodiment, an IRE-1 activity is an indirect activity, such as a downstream event brought about by interaction of the IRE-1 protein with a IRE-1 target or substrate. As IRE-1 is in a signal transduction pathway involving XBP-1, modulation of IRE-1 modulates a molecule in a signal transduction pathway involving XBP-1. Modulators which modulate an XBP-1 biological activity indirectly modulate expression and/or activity of a molecule in a signal transduction pathway involving XBP-1, e.g., IRE-1, eIF2α, or ATF6α.

As used herein, a “substrate” or “target molecule” or “binding partner” is a molecule with which a protein binds or interacts in nature, such that protein's function (e.g., modulation of activation of the UPR, plasma cell differentiation, IL-6 production, immunoglobulin production, apoptosis, or glucose metabolism in the case of XBP-1) is achieved. For example, a target molecule can be a protein or a nucleic acid molecule. Exemplary target molecules of the invention include proteins in the same signaling pathway as the XBP-1 protein, e.g., proteins which can function upstream (including both stimulators and inhibitors of activity) or downstream of the XBP-1 protein in a pathway involving regulation of, for example, modulation of the UPR, modulation of cellular differentiation, modulation of IL-6 production, modulation of immunoglobulin production, modulation of the proteasome pathway, modulation of protein folding and transport, modulation of terminal B cell differentiation, and modulation of apoptosis. Exemplary XBP-1 target molecules include IRE-1, ATF6α, XBP-1 itself (as the molecule forms homodimers) cfos (which can form heterodimers with XBP-1) as well as the regulatory regions of genes regulated by XBP-1. Exemplary IRE-1 target molecules include XBP-1 and IRE-1 itself (as the molecule can form homodimers).

As used herein, the term “signal transduction pathway” includes the means by which a cell converts an extracellular influence or signal (e.g., a signal transduced by a receptor on the surface of a cell, such as a cytokine receptor or an antigen receptor) into a cellular response (e.g., modulation of gene transcription). Exemplary signal transduction pathways include the JAK1/STAT-1 pathway (Leonard, W. 2001. Int. J. Hematol. 73:271; incorporated herein by reference) and the TGF-β pathway (Attisano and Wrana. 2002. Science. 296:1646; incorporated herein by reference). A “signal transduction pathway involving XBP-1” is one in which XBP-1 is a signaling molecule which relays signals.

The subject methods can employ various target molecules. For example, an one embodiment, the subject methods employ XBP-1. In another embodiment, the subject methods employ at least one other molecule in an XBP-1 signaling pathway, e.g., a molecule either upstream or downstream of XBP-1. For example, in one embodiment, the subject methods employ IRE-1. In another embodiment, the subject methods employ ATF6α.

As used herein, the term “contacting” (i.e., contacting a cell e.g. a cell, with a compound) includes incubating the compound and the cell together in vitro (e.g., adding the compound to cells in culture) as well as administering the compound to a subject such that the compound and cells of the subject are contacted in vivo. The term “contacting” does not include exposure of cells to an XBP-1 modulator that may occur naturally in a subject (i.e., exposure that may occur as a result of a natural physiological process).

As used herein, the term “test compound” refers to a compound that has not previously been identified as, or recognized to be, a modulator of the activity being tested. The term “library of test compounds” refers to a panel comprising a multiplicity of test compounds.

As used herein, the term “indicator composition” refers to a composition that includes a protein of interest (e.g., XBP-1 or a molecule in a signal transduction pathway involving XBP-1), for example, a cell that naturally expresses the protein, a cell that has been engineered to express the protein by introducing an expression vector encoding the protein into the cell, or a cell free composition that contains the protein (e.g., purified naturally-occurring protein or recombinantly-engineered protein).

As used herein, the term “cell” includes prokaryotic and eukaryotic cells. In one embodiment, a cell of the invention is a bacterial cell. In another embodiment, a cell of the invention is a fungal cell, such as a yeast cell. In another embodiment, a cell of the invention is a vertebrate cell, e.g., an avian or mammalian cell. In a preferred embodiment, a cell of the invention is a murine or human cell.

Numerous cell types can be used in the instant assays. For example, liver cells or fibroblasts can be used.

As used herein, the term “engineered” (as in an engineered cell) refers to a cell into which a nucleic acid molecule e.g., encoding an XBP-1 protein (e.g., a spliced and/or unspliced form of XBP-1) has been introduced.

As used herein, the term “cell free composition” refers to an isolated composition, which does not contain intact cells. Examples of cell free compositions include cell extracts and compositions containing isolated proteins.

As used herein, the term “reporter gene” refers to any gene that expresses a detectable gene product, e.g., RNA or protein. As used herein the term “reporter protein” refers to a protein encoded by a reporter gene. Preferred reporter genes are those that are readily detectable. The reporter gene can also be included in a construct in the form of a fusion gene with a gene that includes desired transcriptional regulatory sequences or exhibits other desirable properties. Examples of reporter genes include, but are not limited to CAT (chloramphenicol acetyl transferase) (Alton and Vapnek (1979), Nature 282: 864-869; incorporated herein by reference) luciferase, and other enzyme detection systems, such as beta-galactosidase; firefly luciferase (deWet et al. (1987), Mol. Cell. Biol. 7:725-737; incorporated herein by reference); bacterial luciferase (Engebrecht and Silverman (1984), PNAS 1: 4154-4158; Baldwin et al. (1984), Biochemistry 23: 3663-3667; each of which is incorporated herein by-reference); alkaline phosphatase (Toh et al. (1989) Eur. J. Biochem. 182: 231-238, Hall et al. (1983) J. Mol. Appl. Gen. 2: 101; each of which is incorporated herein by reference), human placental secreted alkaline phosphatase (Cullen and Malim (1992) Methods in Enzymol. 216:362-368; incorporated herein by reference) and green fluorescent protein (U.S. Pat. No. 5,491,084; WO 96/23898; each of which is incorporated herein by reference).

As used herein, the term “XBP-1-responsive element” refers to a DNA sequence that is directly or indirectly regulated by the activity of the XBP-1 (whereby activity of XBP-1 can be monitored, for example, via transcription of a reporter gene).

As used herein, the term “cells deficient in XBP-1” includes cells of a subject that are naturally deficient in XBP-1, as wells as cells of a non-human XBP-1 deficient animal, e.g., a mouse, that have been altered such that they are deficient in XBP-1. The term “cells deficient in XBP-1” is also intended to include cells isolated from a non-human XBP-1 deficient animal or a subject that are cultured in vitro.

As used herein, the term “non-human XBP-1 deficient animal” refers to a non-human animal, preferably a mammal, more preferably a mouse, in which an endogenous gene has been altered by homologous recombination between the endogenous gene and an exogenous DNA molecule introduced into a cell of the animal, e.g., an embryonic cell of the animal, prior to development of the animal, such that the endogenous XBP-1 gene is altered, thereby leading to either no production of XBP-1 or production of a mutant form of XBP-1 having deficient XBP-1 activity. Preferably, the activity of XBP-1 is entirely blocked, although partial inhibition of XBP-1 activity in the animal is also encompassed. The term “non-human XBP-1 deficient animal” is also intended to encompass chimeric animals (e.g., mice) produced using a blastocyst complementation system, such as the RAG-2 blastocyst complementation system, in which a particular organ or organs (e.g., the lymphoid organs) arise from embryonic stem (ES) cells with homozygous mutations of the XBP-1 gene.

As used herein, the term “metabolic disorder” includes disorders that result from a metabolic imbalance. Preferably, such disorders include obesity, insulin resistance or disorders that result, at least in part, from these conditions. Exemplary disorders include: type 2 diabetes, hypertension, cardiovascular disease, dysyslipidemia, hyperglycemia, hyperinsulinemia, polycystic ovarian disease,Cushing's syndrome, acromegaly, pheochromocytoma, glucagonoma, primary aldosteronism, abnormalities of blood clotting, or somatostatinoma, and symptoms associated therewith.

In one embodiment, small molecules can be used as test compounds. The term “small molecule” is a term of the art and includes molecules that are less than about 7500, less than about 5000, less than about 1000 molecular weight or less than about 500 molecular weight. In one embodiment, small molecules do not exclusively comprise peptide bonds. In another embodiment, small molecules are not oligomeric. Exemplary small molecule compounds which can be screened for activity include, but are not limited to, peptidomimetics, small organic molecules (e.g., Cane et al. 1998. Science 282:63; incorporated herein by reference), and natural product extract libraries. In another embodiment, the compounds are small, organic non-peptidic compounds. In a further embodiment, a small molecule is not biosynthetic. For example, a small molecule is preferably not itself the product of transcription or translation.

Various aspects of the present invention are described in further detail in the following subsections.

II. Screening Assays

In one embodiment, the invention provides methods (also referred to herein as “screening assays”) for identifying agents for treating (e.g., modulating at least one symptom of) a metabolic disorder, i.e., candidate or test compounds or agents (e.g., enzymes, peptides, peptidomimetics, small molecules, ribozymes, or antisense or siRNA molecules) which bind, e.g., to XBP-1 or a molecule in a signaling pathway involving XBP-1 (e.g., IRE-1, or ATF6α proteins); have a stimulatory or inhibitory effect on the expression, processing (e.g., splicing), post-translational modification (e.g., glycosylation, ubiquitination, phosphorylation, or stability), or activity of XBP-1 or a molecule in a signal transduction pathway involving XBP-1. For example, XBP-1, IRE-1, and ATF6α function in a signal transduction pathway involving XBP-1. Therefore, any of these molecules can be used in the subject screening assays. Although the specific embodiments described below in this section and in other sections may list XBP-1, IRE-I, and/or ATF6α as examples, other molecules in a signal transduction pathway involving XBP-1 can also be used in the subject screening assays.

In one embodiment, the ability of a compound to directly modulate the expression, processing (e.g., splicing), post-translational modification (e.g., glycosylation, ubiquitination, or phosphorylation), stability or activity of XBP-1 is measured in a screening assay of the invention.

The indicator composition can be a cell that expresses the XBP-1 protein or a molecule in a signal transduction pathway involving XBP-1, for example, a cell that naturally expresses or, more preferably, a cell that has been engineered to express the protein by introducing into the cell an expression vector encoding the protein. Preferably, the cell is a mammalian cell, e.g., a human cell. In one embodiment, the cell is a B cell. In another embodiment, the cell is a hepatocyte. Alternatively, the indicator composition can be a cell-free composition that includes the protein (e.g., a cell extract or a composition that includes e.g., either purified natural or recombinant protein). In another embodiment, the cell is a secretory cell. In another embodiment, the cell is under ER stress. In yet another embodiment, the cell expresses ATF6α.

Compounds identified as upmodulating the expression, activity, and/or stability of spliced XBP-1 (or downmodulating the expression, activity, and/or stability of unspliced XBP-1) using the assays described herein are useful for treating metabolic disorders. Exemplary condition(s) that can benefit from modulation of a signal transduction pathway involving XBP-1 include metabolic disorders such as obesity, insulin resistance, type 2 diabetes, hypertension, cardiovascular disease, dysyslipidemia, hyperglycemia, hyperinsulinemia, polycystic ovarian disease, Cushing's syndrome, acromegaly, pheochromocytoma, glucagonoma, primary aldosteronism, or somatostatinoma, and symptoms associated therewith.

The subject screening assays can be performed in the presence or absence of other agents. In one embodiment, the subject assays are performed in the presence of an agent that affects the unfolded protein response, e.g., tunicamycin, which evokes the UPR by inhibiting N-glycosylation, or thapsigargin. In another embodiment, the subject assays are performed in the presence of an agent that inhibits degradation of proteins by the ubiquitin-proteasome pathway (e.g., peptide aldehydes, such as MG132). In another embodiment, the screening assays can be performed in the presence or absence of a molecule that enhances cell activation.

In another aspect, the invention pertains to a combination of two or more of the assays described herein. For example, a modulating agent can be identified using a cell-based or a cell-free assay, and the ability of the agent to modulate the activity of XBP-1 or a molecule in a signal transduction pathway involving XBP-1 can be confirmed in vivo, e.g., in an animal model for diabetes and/or obesity.

Moreover, a modulator of XBP-1 or a molecule in a signaling pathway involving XBP-1 identified as described herein (e.g., an enzyme, an antisense nucleic acid molecule, or a specific antibody, or a small molecule) can be used in an animal model to determine the efficacy, toxicity, or side effects of treatment with such a modulator. Alternatively, a modulator identified as described herein can be used in an animal model to determine the mechanism of action of such a modulator.

In another embodiment, it will be understood that similar screening assays can be used to identify compounds that indirectly modulate the activity and/or expression of XBP-1 e.g., by performing screening assays such as those described above using molecules with which XBP-1 interacts, e.g., molecules that act either upstream or downstream of XBP-1 (e.g., IRE-1, or ATF6α) in a signal transduction pathway.

The cell based and cell free assays of the invention are described in more detail below.

A. Cell Based Assays

The indicator compositions of the invention can be a cell that expresses an XBP-1 protein (or non-XBP-1 protein in the XBP-1 signaling pathway such as IRE-1 or ATF6α), for example, a cell that naturally expresses endogenous XBP-1, IRE-1 or ATF6α or, more preferably, a cell that has been engineered to express an exogenous XBP-1, IRE-1, or ATF6α protein by introducing into the cell an expression vector encoding the protein. Alternatively, the indicator composition can be a cell-free composition that includes XBP-1 or a non-XBP-1 protein such as IRE-1 or ATF6α (e.g., a cell extract from an XBP-1, IRE-1, or ATF6α-expressing cell or a composition that includes purified XBP-1, IRE-1, or ATF6α protein, either natural or recombinant protein).

Compounds that modulate expression and/or activity of XBP-1, or a non-XBP-1 protein that acts upstream or downstream of XBP-1 can be identified using various “read-outs.”

For example, an indicator cell can be transfected with an XBP-1 expression vector, incubated in the presence and in the absence of a test compound, and the effect of the compound on the expression of the molecule or on a biological response regulated by XBP-1 can be determined. In one embodiment, unspliced XBP-1 (e.g., capable of being spliced so that the cell will make both forms, or incapable of being spliced so the cell will make only the unspliced form) can be expressed in a cell. In another embodiment, spliced XBP-1 can be expressed in a cell. The biological activities of XBP-1 include activities determined in vivo, or in vitro, according to standard techniques. An XBP-1 activity can be a direct activity, such as an association with an XBP-I-target molecule (e.g., a nucleic acid molecule to which XBP-1 binds such as the transcriptional regulatory region of a chaperone gene) or a protein such as the IRE-1 or ATF6oc protein. Alternatively, an XBP-1 activity is an indirect activity, such as a cellular signaling activity or alteration in gene expression occurring downstream of the interaction of the XBP-1 protein with an XBP-1 target molecule or a biological effect occurring as a result of the signaling cascade triggered by that interaction. For example, biological activities of XBP-1 described herein include: modulation of the UPR, modulation of cellular differentiation, modulation of IL-6 production, modulation of immunoglobulin production, modulation of the proteasome pathway, modulation of protein folding and transport, modulation of terminal B cell differentiation, modulation of apoptosis, modulation of insulin resistance, modulation of insulin resceptor signaling, and modulation of a metabolic disorder.

To determine whether a test compound modulates XBP-1 protein expression, in vitro transcriptional assays can be performed. In one example of such an assay, the full length XBP-1 gene or promoter and enhancer of XBP-1 operably linked to a reporter gene such as chloramphenicol acetyltransferase (CAT) or luciferase and introduced into host cells. The expression or activity of XBP-1 or the reporter gene can be measured using techniques known in the art. The ability of a test compound to regulate the expression or activity of a molecule in a signal transduction pathway involving XBP-1 can be similarly tested.

As used interchangeably herein, the terms “operably linked” and “operatively linked” are intended to mean that the nucleotide sequence is linked to a regulatory sequence in a manner which allows expression of the nucleotide sequence in a host cell (or by a cell extract).

In another embodiment, modulation of expression of a protein whose expression is regulated by XBP-1 is measured. Regulatory sequences are art-recognized and can be selected to direct expression of the desired protein in an appropriate host cell. The term regulatory sequence is intended to include promoters, enhancers, polyadenylation signals and other expression control elements. Such regulatory sequences are known to those skilled in the art and are described in Goeddel, Gene Expression Technology: Methods in Enzymology 185, Academic Press, San Diego, Calif. (1990), incorporated herein by reference. It should be understood that the design of the expression vector may depend on such factors as the choice of the host cell to be transfected and/or the type and/or amount of protein desired to be expressed.

Exemplary target molecules of XBP-1 include: XBP-1-responsive elements, for example, upstream regulatory regions from genes such as α-1 antitrypsin, α-fetoprotein, HLA DRα, as well as the 21 base pair repeat enhancer of the HTLV-1 LTR. An example of an XBP-1-responsive reporter construct is the HLA DRα-CAT construct described in Ono et al. (1991) Proc. Natl. Acad. Sci. USA 88:4309-4312, incorporated herein by reference. Other examples can include regulatory regions of the chaperone genes such as members of the family of Glucose Regulated Proteins (GRPs) such as GRP78 (BiP) and GRP94 (endoplasmin), as well as other chaperones such as calreticulin, protein disulfide isomerase, and ERp72. XBP-1 targets are taught, e.g. in Clauss et al. Nucleic Acids Research 1996. 24:1855, incorporated herein by reference, also include CRE and TRE sequences

Exemplary constructs can include an XBP-1 target sequence TGGATGACGTGTACA (SEQ ID NO: 6) fused to the minimal promoter of the mouse RANTES gene (Clauss et al. Nucleic Acids Research 1996. 24:1855; incorporated herein by reference) or the ATF6/XBP-1 target TCGAGACAGGTGCTGACGTGGCGATTCC (SEQ ID NO: 7) and comprising −53/+45 of the cfos promoter (J. Biol. Chem. 275:27013; incorporated herein by reference) fused to a reporter gene. In one embodiment, multiple copies of the XBP-1 target sequence can be included.

A variety of reporter genes are known in the art and are suitable for use in the screening assays of the invention. Examples of suitable reporter genes include those which encode chloramphenicol acetyltransferase, beta-galactosidase, alkaline phosphatase or luciferase. Standard methods for measuring the activity of these gene products are known in the art.

A variety of cell types are suitable for use as an indicator cell in the screening assay. Preferably a cell line is used which expresses low levels of endogenous XBP-1, IRE-1, and/or ATF6α, and is then engineered to express recombinant XBP-1, IRE-1, and/or ATF6α. Cells for use in the subject assays include both eukaryotic and prokaryotic cells. For example, in one embodiment, a cell is a bacterial cell. In another embodiment, a cell is a fungal cell, such as a yeast cell. In another embodiment, a cell is a vertebrate cell, e.g., an avian cell or a mammalian cell (e.g., a murine cell, or a human cell).

In one embodiment, the level of expression of the reporter gene in the indicator cell in the presence of the test compound is higher than the level of expression of the reporter gene in the indicator cell in the absence of the test compound and the test compound is identified as a compound that stimulates the expression of the molecule. In another embodiment, the level of expression of the reporter gene in the indicator cell in the presence of the test compound is lower than the level of expression of the reporter gene in the indicator cell in the absence of the test compound and the test compound is identified as a compound that inhibits the expression of the molecule.

In one embodiment, the invention provides methods for identifying compounds that modulate cellular responses in which XBP-1 is involved. For example, in one embodiment, modulation of the UPR or ER stress can be determined and used as an indicator of modulation of XBP-1 activity. Transcription of genes encoding molecular chaperones and folding enzymes in the endoplasmic reticulum (ER) is induced by accumulation of unfolded proteins in the ER. This intracellular signaling, known as the unfolded protein response (UPR), is mediated by the cis-acting ER stress response element (ERSE) in mammals. In addition to ER chaperones, the mammalian transcription factor CHOP (also called GADD153) is induced by ER stress. XBP-1 (also called TREB5) is also induced by ER stress and the induction of CHOP and XBP-1 is mediated by ERSE. The ERSE consensus sequence is CCAAT-N(9)-CCACG (SEQ ID NO.:8). As the general transcription factor NF-Y (also known as CBF) binds to CCAAT, CCACG is considered to provide specificity in the mammalian UPR. The basic leucine zipper protein ATF6 isolated as a CCACG -binding protein is synthesized as a transmembrane protein in the ER, and ER stress-induced proteolysis produces a soluble form of ATF6 that translocates into the nucleus. In another embodiment, the expression of molecular chaperones such as GRP78 or BIP can be measured.

Modulation of XBP-1 activity can also be measured by, for example, measuring the changes in the endogenous levels of mRNA and the transcription or production of proteins such as ERdj4, p58^{ipk}, EDEM, PDI-P5, RAMP4, HEDJ, BiP, ATF6α, XBP-1, Armet and DNAJB9 or folding catalysts using routine ELISA, Northern and Western blotting techniques. In addition, the attenuation of translation associated with the UPR can be measured, e.g., by measuring protein production (Ruegsegger et al. 2001. Cell 107:103; incorporated herein by reference). Preferred proteins for detection are expressed on the cell surface or are secreted. In another embodiment, the phosphorylation of eukaryotic initiation factor 2 can be measured. In another embodiment, the accumulation of aggregated, misfolded, or damaged proteins in a cell can be monitored (Welch, W. J. 1992 Physiol. Rev. 72:1063; Gething and Sambrook. 1992. Nature. 355:33; Kuznetsov et al. 1997. J. Biol. Chem. 272:3057; each of which is incorporated herein by reference).

In one embodiment, modulation of XBP-1 activity can be measured by determining the phosphorylation status of PERK or eIF2α, e.g., using an antibody, as was done in the instant examples. In another embodiment, the JNK-dependent serine phosphorylation of IRS-1 (insulin receptor substrate-l) can be measured to monitor modulation of XBP-1 activity. Increased phosphorylation of these molecules is observed under under conditions of ER stress.

In another embodiment, modulation of XBP-1 activity can be detected by measuring a decrease in insulin receptor-mediated signaling, e.g., a modulation in insulin stimulated IRS-1 or IRS-2 tyrosine phosphorylation. Decreased phosphorylation of these molecules is observed under conditions of ER stress.

As described in the instant Examples, induction of ER stress leads to modulation of XBP-i activity, e.g., an increase in spliced XBP-1. Cells overexpressing the spliced form of XBP-1 downmodulate serine phosphorylation of IRS-1 and increase tyrosine phosphorylation of IRS-1, when ER stress is induced.

In another embodiment, the ability of a compound to modulate the proteasome pathway of a cell can be determined using any of a number of art-recognized techniques. For example, in one embodiment, the half life of normally short-lived regulatory proteins (e.g., NF-kB, cyclins, oncogenic products or tumor suppressors) can be measured to measure the degradation capacity of the proteasome. In another embodiment, the presentation of antigen in the context of MHC molecules on the surface of cells can be measured (e.g., in an in vitro assay of T cell activation) as proteasome degradation of antigen is important in antigen processing and presentation. In another embodiment, threonine protease activity associated with the proteasome can be measured. Agents that modulate the proteasome pathway will affect the normal degradation of these proteins. In another embodiment, the modulation of the proteasome pathway can be measured indirectly by measuring the ratio of spliced to unspliced XBP-1 or the ratio of unspliced to spliced XBP-1. Inhibition of the proteasome pathway, e.g., by the inhibitor MG-132, leads to an increase in the level of unspliced XBP-1 as compared to spliced XBP-1. The levels of these different forms of XBP-1 can be measured using various techniques described herein (e.g., Western blotting or PCR) or known in the art and a ratio determined.

In one embodiment, the ability of a compound to modulate protein folding or transport can be determined. The expression of a protein on the surface of a cell or the secretion of a secreted protein can be measured as indicators of protein folding and transport. Protein expression on a cell can be measured, e.g., using FACS analysis, surface iodination, immunoprecipitation from membrane preparations. Protein secretion can be measured, for example, by measuring the level of protein in a supernatant from cultured cells. The production of any secreted protein can be measured in this manner. The protein to be measured can be endogenous or exogenous to the cell. In preferred embodiment, the protein is selected from the group consisting of: α-fetoprotein, α1-antitrypsin, albumin, luciferase, and immunoglobulins. The production of proteins can be measured using standard techniques in the art.

In another embodiment, the ability of a compound to modulate apoptosis, e.g., modulate apoptosis by disrupting the UPR, can be determined. In one embodiment, the ability of a compound to modulate apoptosis in a secretory cell or a cell under ER stress is determined. Apoptosis can be measured in the presence or the absence of Fas-mediated signals. In one embodiment, cytochrome C release from mitochondria during cell apoptosis can be detected, e.g., plasma cell apoptosis (as described in, for example, Bossy-Wetzel E. et al. (2000) Methods in Enzymol. 322:235-42, incorporated herein by reference). Other exemplary assays include: cytofluorometric quantitation of nuclear apoptosis induced in a cell-free system (as described in, for example, Lorenzo et al. (2000) Methods in Enzymol. 322:198-201; incorporated herein by reference); apoptotic nuclease assays (as described in, for example, Hughes F. M. (2000) Methods in Enzymol. 322:47-62; incorporated herein by reference); analysis of apoptotic cells, e.g., apoptotic plasma cells, by flow and laser scanning cytometry (as described in, for example, Darzynkiewicz Z. et al. (2000) Methods in Enzymol. 322:18-39; incorporated herein by reference); detection of apoptosis by annexin V labeling (as described in, for example, Bossy-Wetzel E. et al. (2000) Methods in Enzymol. 322:15-18; incorporated herein by reference); transient transfection assays for cell death genes (as described in, for example, Miura M. et al. (2000) Methods in Enzymol. 322:480-92; incorporated herein by reference); and assays that detect DNA cleavage in apoptotic cells, e.g., apoptotic plasma cells (as described in, for example, Kauffman S. H. et al. (2000) Methods in Enzymol. 322:3-15; incorporated herein by reference). Apoptosis can also be measured by propidium iodide staining or by TUNEL assay. In another embodiment, the transcription of genes associated with a cell signaling pathway involved in apoptosis (e.g., JNK) can be detected using standard methods.

In another embodiment, mitochondrial inner membrane permeabilization can be measured in intact cells by loading the cytosol or the mitochondrial matrix with a die that does not normally cross the inner membrane, e.g., calcein (Bernardi et al. 1999. Eur. J. Biochem. 264:687; Lemasters et al. 1998. Biochem. Biophys. Acta 1366:177; each of which is incorporated herein by reference). In another embodiment, mitochondrial inner membrane permeabilization can be assessed, e.g., by determining a change in the mitochondrial inner membrane potential (ΔΨm). For example, cells can be incubated with lipophilic cationic fluorochromes such as DiOC6 (Gross et al. 1999. Genes Dev. 13:1988; incorporated herein by reference) (3,3′dihexyloxacarbocyanine iodide) or JC-1(5,5′,6,6′-tetrachloro-1,1′,3,3′-tetraethylbenzimidazolylcarbocyanine iodide). These dyes accumulate in the mitochondrial matrix, driven by the Ψm. Dissipation results in a reduction of the fluorescence intensity (e.g., for DiOC6 (Gross et al. 1999. Genes Dev. 13:1988; incorporated herein by reference) or a shift in the emission spectrum of the dye. These changes can be measured by cytofluorometry or microscopy.

In yet another embodiment, the ability of a compound to modulate translocation of spliced XBP-1 to the nucleus can be determined. Translocation of spliced XBP-1 to the nucleus can be measured, e.g., by nuclear translocation assays in which the emission of two or more fluorescently-labeled species is detected simultaneously. For example, the cell nucleus can be labeled with a known fluorophore specific for DNA, such as Hoechst 33342. The spliced XBP-1 protein can be labeled by a variety of methods, including expression as a fusion with GFP or contacting the sample with a fluorescently-labeled antibody specific spliced XBP-1. The amount spliced XBP-1 that translocates to the nucleus can be determined by determining the amount of a first fluorescently-labeled species, i.e., the nucleus, that is distributed in a correlated or anti-correlated manner with respect to a second fluorescently-labeled species, i.e., spliced XBP-1, as described in U.S. Pat. No. 6,400,487, the contents of which are hereby incorporated by reference.

The ability of the test compound to modulate XBP-1 (or a molecule in a signal transduction pathway involving to XBP-1) binding to a substrate or target molecule (e.g., IRE-1 or ATF6α in the case of XBP-1) can also be determined. Determining the ability of the test compound to modulate XBP-1 (or e.g., IRE-1, or ATF6α) binding to a target molecule (e.g., a binding partner such as a substrate) can be accomplished, for example, by coupling the target molecule with a radioisotope or enzymatic label such that binding of the target molecule to XBP-1 or a molecule in a signal transduction pathway involving XBP-1 can be determined by detecting the labeled XBP-1 (or e.g., IRE-1 or ATF6α) target molecule in a complex. Alternatively, XBP-1(or e.g., IRE-1 or ATF6α) could be coupled with a radioisotope or enzymatic label to monitor the ability of a test compound to modulate XBP-1 (or e.g., IRE-1 or ATF6α) binding to a target molecule in a complex. Determining the ability of the test compound to bind to XBP-1(or e.g., IRE-1 or ATF6α) can be accomplished, for example, by coupling the compound with a radioisotope or enzymatic label such that binding of the compound to XBP-1(or e.g., IRE-1 or ATF6α) can be determined by detecting the labeled compound in a complex. For example, targets can be labeled with ¹²⁵I, ³⁵S, ¹⁴C, or ³H, either directly or indirectly, and the radioisotope detected by direct counting of radioemmission or by scintillation counting. Alternatively, compounds can be labeled, e.g., with, for example, horseradish peroxidase, alkaline phosphatase, or luciferase, and the enzymatic label detected by determination of conversion of an appropriate substrate to product.

In another embodiment, the ability of XBP-1 or a molecule in a signal transduction pathway involving XBP-1 to be acted on by an enzyme or to act on a substrate can be measured. For example, in one embodiment, the effect of a compound on the phosphorylation of IRE-1, the ability of IRE-1 to process XBP-1, etc., can be measured using techniques that are known in the art.

It is also within the scope of this invention to determine the ability of a compound to interact with XBP-1 or a molecule in a signal transduction pathway involving XBP-1 without the labeling of any of the interactants. For example, a microphysiometer can be used to detect the interaction of a compound with XBP-1, IRE-1, or ATF6α without the labeling of either the compound or the XBP-1, IRE-1, or ATF6α (McConnell. et al. (1992) Science 257:1906-1912; incorporated herein by reference). As used herein, a “microphysiometer” (e.g., Cytosensor) is an analytical instrument that measures the rate at which a cell acidifies its environment using a light-addressable potentiometric sensor (LAPS). Changes in this acidification rate can be used as an indicator of the interaction between a compound and XBP-1, IRE-1, or ATF6α.

In another embodiment, a different (i.e., non-XBP-1) molecule acting in a pathway involving XBP-1 that acts upstream (e.g., IRE-1) or downstream (e.g., ATF6α or cochaperone proteins that activate ER resident HspTO proteins, such as p58^{IPK}) of XBP-1 can be included in an indicator composition for use in a screening assay. Compounds identified in a screening assay employing such a molecule would also be useful in modulating XBP-1 activity, albeit indirectly. IRE-1 is one exemplary IRE-1 substrate (e.g., the autophosphorylation of IRE-1). In another embodiment, the endoribonuclease activity of IRE-1 can be measured, e.g., by detecting the splicing of XBP-1 using techniques that are known in the art. The activity of IRE-1 can also be measured by measuring the modulation of biological activity associated with XBP-1.

The cells used in the instant assays can be eukaryotic or prokaryotic in origin. For example, in one embodiment, the cell is a bacterial cell. In another embodiment, the cell is a fungal cell, e.g., a yeast cell. In another embodiment, the cell is a vertebrate cell, e.g., an avian or a mammalian cell. In a preferred embodiment, the cell is a human cell.

The cells of the invention can express endogenous XBP-1 or another protein in a signaling pathway involving XBP-1 or can be engineered to do so. For example, a cell that has been engineered to express the XBP-1 protein and/or a non XBP-1 protein which acts upstream or downstream of XBP-1 can be produced by introducing into the cell an expression vector encoding the protein.

In one embodiment, to specifically assess the role of agents that modulate the expression and/or activity of unspliced or spliced XBP-1 protein, retroviral gene transduction of cells deficient in XBP-1 with spliced XBP-1 or a form of XBP-1 which cannot be spliced can be performed. For example, a construct in which mutations at in the loop structure of XBP-1 (e.g., positions −1 and +3 in the loop structure of XBP-1) can be generated. Expression of this construct in cells results in production of the unspliced form of XBP-1 only. Using such constructs, the ability of a compound to modulate a particular form of XBP-1 can be detected. In one embodiment, a compound modulates one form of XBP-1, e.g., spliced XBP-1, without modulating the other form, e.g., unspliced XBP-1.

Recombinant expression vectors that can be used for expression of XBP-1 or a molecule in a signal transduction pathway involving XBP-1 (e.g., a protein which acts upstream or downstream of XBP-1) or a molecule in a signal transduction pathway involving XBP-1 in the indicator cell are known in the art. For example, the XBP-1, IRE-1, or ATF6α cDNA is first introduced into a recombinant expression vector using standard molecular biology techniques. A cDNA can be obtained, for example, by amplification using the polymerase chain reaction (PCR) or by screening an appropriate cDNA library. The nucleotide sequences of cDNAs for XBP-1 or a molecule in a signal transduction pathway involving XBP-1 (e.g., human, murine and yeast) are known in the art and can be used for the design of PCR primers that allow for amplification of a cDNA by standard PCR methods or for the design of a hybridization probe that can be used to screen a cDNA library using standard hybridization methods. The nucleotide and predicted amino acid sequences of a mammalian XBP-1 cDNA are disclosed in Liou et. al. (1990) Science 247:1581-1584, Yoshimura, T. et al. (1990) EMBO J. 9:2537-2542, and Kishimoto T. et al., (1996) Biochem. Biophys. Res. Commun. 223:746-751; each of which is incorporated herein by reference. The nucleotide sequences of human, mouse, C. elegans and yeast IRE-1 are disclosed, for example in Calfon et al. (2002) Nature 415:92-96; incorporated herein by reference.

Following isolation or amplification of a cDNA molecule encoding XBP-1 or a non-XBP-1 molecule in a signal transduction pathway involving XBP-1 the DNA fragment is introduced into an expression vector. As used herein, the term “vector” refers to a nucleic acid molecule capable of transporting another nucleic acid to which it has been linked. One type of vector is a “plasmid,” which refers to a circular double stranded DNA loop into which additional DNA segments can be inserted. Another type of vector is a viral vector, wherein additional DNA segments can be ligated into the viral genome. Certain vectors are capable of autonomous replication in a host cell into which they are introduced (e.g., bacterial vectors having a bacterial origin of replication and episomal mammalian vectors). Other vectors (e.g., non-episomal mammalian vectors) are integrated into the genome of a host cell upon introduction into the host cell, and thereby are replicated along with the host genome. Moreover, certain vectors are capable of directing the expression of genes to which they are operatively linked. Such vectors are referred to herein as “recombinant expression vectors” or simply “expression vectors.” In general, expression vectors of utility in recombinant DNA techniques are often in the form of plasmids. In the present specification, “plasmid” and “vector” may be used interchangeably as the plasmid is the most commonly used form of vector. However, the invention is intended to include such other forms of expression vectors, such as viral vectors (e.g., replication defective retroviruses, adenoviruses and adeno-associated viruses), which serve equivalent functions.

The recombinant expression vectors of the invention comprise a nucleic acid molecule in a form suitable for expression of the nucleic acid molecule in a host cell, which means that the recombinant expression vectors include one or more regulatory sequences, selected on the basis of the host cells to be used for expression and the level of expression desired, which is operatively linked to the nucleic acid sequence to be expressed. Within a recombinant expression vector, “operably linked” is intended to mean that the nucleotide sequence of interest is linked to the regulatory sequence(s) in a manner which allows for expression of the nucleotide sequence (e.g., in an in vitro transcription/translation system or in a host cell when the vector is introduced into the host cell). The term “regulatory sequence” is intended to includes promoters, enhancers and other expression control elements (e.g., polyadenylation signals). Such regulatory sequences are described, for example, in Goeddel; Gene Expression Technology: Methods in Enymology 185, Academic Press, San Diego, Calif. (1990), incorporated herein by reference. Regulatory sequences include those which direct constitutive expression of a nucleotide sequence in many types of host cell, those which direct expression of the nucleotide sequence only in certain host cells (e.g., tissue-specific regulatory sequences) or those which direct expression of the nucleotide sequence only under certain conditions (e.g., inducible regulatory sequences).

When used in mammalian cells, the expression vector's control functions are often provided by viral regulatory elements. For example, commonly used promoters are derived from polyoma virus, adenovirus, cytomegalovirus and Simian Virus 40. Non-limiting examples of mammalian expression vectors include pCDM8 (Seed, B., (1987) Nature 329:840; incorporated herein by reference) and pMT2PC (Kaufman et al. (1987), EMBO J. 6:187-195; incorporated herein by reference). A variety of mammalian expression vectors carrying different regulatory sequences are commercially available. For constitutive expression of the nucleic acid in a mammalian host cell, a preferred regulatory element is the cytomegalovirus promoter/enhancer. Moreover, inducible regulatory systems for use in mammalian cells are known in the art, for example systems in which gene expression is regulated by heavy metal ions (see, e.g., Mayo et al. (1982) Cell 29:99-108; Brinster et al. (1982) Nature 296:39-42; Searle et al. (1985) Mol. Cell. Biol. 5:1480-1489; each of which is incorporated herein by reference), heat shock (see e.g., Nouer et al. (1991) in Heat Shock Response, e.d. Nouer, L., CRC, Boca Raton, Fla., pp 167-220; incorporated herein by reference), hormones (see e.g., Lee et al. (1981) Nature 294:228-232; Hynes et al. (1981) Proc. Natl. Acad. Sci. USA 78:2038-2042; Klock et al. (1987) Nature 329:734-736; Israel & Kaufman (1989) Nucl. Acids Res. 17:2589-2604; PCT Publication No. WO 93/23431; each of which is incorporated herein by reference), FK506-related molecules (see e.g., PCT Publication No. WO 94/18317; incorporated herein by reference) or tetracyclines (Gossen, M. and Bujard, H. (1992) Proc. Natl. Acad. Sci. USA 89:5547-5551; Gossen, M. et al. (1995) Science 268:1766-1769; PCT Publication No. WO 94/29442; PCT Publication No. WO 96/01313; each of which is incorporated herein by reference). Still further, many tissue-specific regulatory sequences are known in the art, including the albumin promoter (liver-specific; Pinkert et al. (1987) Genes Dev. 1:268-277; incorporated herein by reference), lymphoid-specific promoters (Calame and Eaton (1988) Adv. Immunol. 43:235-275; incorporated herein by reference), in particular promoters of T cell receptors (Winoto and Baltimore (1989) EMBO J. 8:729-733; incorporated herein by reference) and immunoglobulins (Banerji et al. (1983) Cell 33:729-740; Queen and Baltimore (1983) Cell 33:741-748; incorporated herein by reference), neuron-specific promoters (e.g., the neurofilament promoter; Byrne and Ruddle (1989) Proc. Natl. Acad. Sci. USA 86:5473-5477; incorporated herein by reference), pancreas-specific promoters (Edlund et al. (1985) Science 230:912-916; incorporated herein by reference) and mammary gland-specific promoters (e.g., milk whey promoter; U.S. Pat. No. 4,873,316 and European Application Publication No. 264,166; each of which is incorporated herein by reference). Developmentally-regulated promoters are also encompassed, for example the murine hox promoters (Kessel and Gruss (1990) Science 249:374-379; incorporated herein by reference) and the α-fetoprotein promoter (Campes and Tilghman (1989) Genes Dev. 3:537-546; incorporated herein by reference).

Vector DNA can be introduced into mammalian cells via conventional transfection techniques. As used herein, the various forms of the term “transfection” are intended to refer to a variety of art-recognized techniques for introducing foreign nucleic acid (e.g., DNA) into mammalian host cells, including calcium phosphate co-precipitation, DEAE-dextran-mediated transfection, lipofection, or electroporation. Suitable methods for transfecting host cells can be found in Sambrook et al. (Molecular Cloning: A Laboratory Manual, 2nd Edition, Cold Spring Harbor Laboratory press (1989)), and other laboratory manuals.

For stable transfection of mammalian cells, it is known that, depending upon the expression vector and transfection technique used, only a small fraction of cells may integrate the foreign DNA into their genome. In order to identify and select these integrants, a gene that encodes a selectable marker (e.g., resistance to antibiotics) is generally introduced into the host cells along with the gene of interest. Preferred selectable markers include those which confer resistance to drugs, such as G418, hygromycin and methotrexate. Nucleic acid encoding a selectable marker can be introduced into a host cell on a separate vector from that encoding XBP-1 or, more preferably, on the same vector. Cells stably transfected with the introduced nucleic acid can be identified by drug selection (e.g., cells that have incorporated the selectable marker gene will survive, while the other cells die).

In one embodiment, within the expression vector coding sequences are operatively linked to regulatory sequences that allow for constitutive expression of the molecule in the indicator cell (e.g., viral regulatory sequences, such as a cytomegalovirus promoter/enhancer, can be used). Use of a recombinant expression vector that allows for constitutive expression of XBP-1 or a molecule in a signal transduction pathway involving XBP-1 in the indicator cell is preferred for identification of compounds that enhance or inhibit the activity of the molecule. In an alternative embodiment, within the expression vector the coding sequences are operatively linked to regulatory sequences of the endogenous gene for XBP-1 or a molecule in a signal transduction pathway involving XBP-1 (i.e., the promoter regulatory region derived from the endogenous gene). Use of a recombinant expression vector in which expression is controlled by the endogenous regulatory sequences is preferred for identification of compounds that enhance or inhibit the transcriptional expression of the molecule.

B. Assays Measuring Spliced Versus Unspliced XBP-1

In another embodiment, the invention provides for screening assays to identify compounds which alter the ratio of spliced XBP-1 to unspliced XBP-1 or the ratio of unspliced XBP-1 to spliced XBP-1. Only the spliced form of XBP-1 mRNA activates gene transcription. Unspliced XBP-1 mRNA inhibits the activity of spliced XBP-1 mRNA. As explained above, human and murine XBP-1 mRNA contain an open reading frame (ORF1) encoding bZIP proteins of 261 and 267 amino acids, respectively. Both mRNA's also contain another ORF, ORF2, partially overlapping but not in frame with ORF1. ORF2 encodes 222 amino acids in both human and murine cells. Human and murine ORF1 and ORF2 in the XBP-1 mRNA share 75% and 89% identity respectively. In response to ER stress, XBP-1 mRNA is processed by the ER transmembrane endoribonuclease and kinase IRE-1 which excises an intron from XBP-1 mRNA. In murine and human cells, a 26 nucleotide intron is excised. Splicing out of 26 nucleotides in murine cells results in a frame shift at amino acid 165. This causes removal of the C-terminal 97 amino acids from the first open reading frame (ORFI) and addition of the 212 amino from ORF2 to the N-terminal 164 amino acids of ORF1 containing the b-ZIP domain. In mammalian cells, this splicing event results in the conversion of an approximately 267 amino acid unspliced XBP-1 protein to a 371 amino acid spliced XBP-1 protein. The spliced XBP-1 then translocates into the nucleus where it binds to its target sequences to induce their transcription.

Compounds that alter the ratio of unspliced to spliced XBP-1 or spliced to unspliced XBP-1 can be useful to modulate the biological activities of XBP-1, e.g., in modulation of the UPR, modulation of cellular differentiation, modulation of IL-6 production, modulation of immunoglobulin production, modulation of the proteasome pathway, modulation of protein folding and transport, modulation of terminal B cell differentiation, and modulation of apoptosis. The compounds can also be used to treat disorders that would benefit from modulation of XBP-1 expression and/or activity, e.g., autoimmune disorders, malignancies, and metabolic disorders.

The techniques for assessing the ratios of unspliced to spliced XBP-1 and spliced to unspliced XBP-1 are routine in the art. For example, the two forms can be distinguished based on their size, e.g., using northern blots or western blots. Because the spliced form of XBP-1 comprises an exon not found in the unspliced form, in another embodiment, antibodies that specifically recognize the spliced or unspliced form of XBP-1 can be developed using techniques well known in the art (Yoshida et al. 2001. Cell. 107:881; incorporated herein by reference). In addition, PCR can be used to distinguish spliced from unspliced XBP-1. For example, as described herein, primer sets can be used to amplify XBP-1 where the primers are derived from positions 410 and 580 of murine XBP-1, or corresponding positions in related XBP-1 molecules, in order to amplify the region that encompasses the splice junction. A fragment of 171 base pairs corresponds to unspliced XBP-1 mRNA. An additional band of 145 bp corresponds to the spliced form of XBP-1. The ratio of the different forms of XBP-1 can be determined using these or other art recognized methods.

C. Cell-Free Assays

In another embodiment, the indicator composition is a cell free composition. XBP-1 or a non-XBP-1 protein in a signal transduction pathway involving XBP-1 expressed by recombinant methods in a host cells or culture medium can be isolated from the host cells, or cell culture medium using standard methods for protein purification. For example, ion-exchange chromatography, gel filtration chromatography, ultrafiltration, electrophoresis, and immunoaffinity purification with antibodies can be used to produce a purified or semi-purified protein that can be used in a cell free composition. Alternatively, a lysate or an extract of cells expressing the protein of interest can be prepared for use as cell-free composition.

In one embodiment, compounds that specifically modulate XBP-1 activity or the activity of a molecule in a signal transduction pathway involving XBP-1 are identified based on their ability to modulate the interaction of XBP-1 (or e.g., IRE-1 or ATF6α) with a target molecule to which XBP-1(or e.g., IRE-1 or ATF6α) binds. The target molecule can be a DNA molecule, e.g., an XBP-1-responsive element, such as the regulatory region of a chaperone gene) or a protein molecule. Suitable assays are known in the art that allow for the detection of protein-protein interactions (e.g., immunoprecipitations, two-hybrid assays and the like) or that allow for the detection of interactions between a DNA binding protein with a target DNA sequence (e.g., electrophoretic mobility shift assays, DNAse 1 footprinting assays and the like). By performing such assays in the presence and absence of test compounds, these assays can be used to identify compounds that modulate (e.g., inhibit or enhance) the interaction of XBP-1 with a target molecule.

In one embodiment, the amount of binding of XBP-1 or a molecule in a signal transduction pathway involving XBP-1 to the target molecule in the presence of the test compound is greater than the amount of binding of XBP-1 (or e.g., IRE-1 or ATF6α) to the target molecule in the absence of the test compound, in which case the test compound is identified as a compound that enhances binding of XBP-1(or e.g., IRE-1 or ATF6α) to a target. In another embodiment, the amount of binding of the XBP-1 (or e.g., RB-1 or ATF6α) to the target molecule in the presence of the test compound is less than the amount of binding of the XBP-1(or e.g., IRE-1 or ATF6α) to the target molecule in the absence of the test compound, in which case the test compound is identified as a compound that inhibits binding of XBP-1 (or e.g., IRE-1 or ATF6α) to the target.

Binding of the test compound to XBP-1 or a molecule in a signal transduction pathway involving XBP-1 can be determined either directly or indirectly as described above. Determining the ability of XBP-1(or e.g., IRE-1 or ATF6α) protein to bind to a test compound can also be accomplished using a technology such as real-time Biomolecular Interaction Analysis (BIA) (Sjolander, S. and Urbaniczky, C. (1991) Anal. Chem. 63:2338-2345; Szabo et al. (1995) Curr. Opin. Struct. Biol. 5:699-705; each of which is incorporated herein by reference). As used herein, “BIA” is a technology for studying biospecific interactions in real time, without labeling any of the interactants (e.g., BIAcore). Changes in the optical phenomenon of surface plasmon resonance (SPR) can be used as an indication of real-time reactions between biological molecules.

In the methods of the invention for identifying test compounds that modulate an interaction between XBP-1(or e.g., IRE-1 or ATF6α) protein and a target molecule, the complete XBP-1(or e.g., IRE-1 or ATF6α) protein can be used in the method, or, alternatively, only portions of the protein can be used. For example, an isolated XBP-1 b-ZIP structure (or a larger subregion of XBP-1 that includes the b-ZIP structure) can be used. In another example, a form of XBP-1 comprising the splice junction can be used (e.g., a portion including from about nucleotide 506 to about nucleotide 532). The degree of interaction between the protein and the target molecule can be determined, for example, by labeling one of the proteins with a detectable substance (e.g., a radiolabel), isolating the non-labeled protein and quantitating the amount of detectable substance that has become associated with the non-labeled protein. The assay can be used to identify test compounds that either stimulate or inhibit the interaction between the XBP-1(or e.g., IRE-1 or ATF6α) protein and a target molecule. A test compound that stimulates the interaction between the protein and a target molecule is identified based upon its ability to increase the degree of interaction between, e.g., spliced XBP-1 and a target molecule as compared to the degree of interaction in the absence of the test compound and such a compound would be expected to increase the activity of spliced XBP-1 in the cell. A test compound that inhibits the interaction between the protein and a target molecule is identified based upon its ability to decrease the degree of interaction between the protein and a target molecule as compared to the degree of interaction in the absence of the compound and such a compound would be expected to decrease spliced XBP-1 activity.

In one embodiment of the above assay methods of the present invention, it may be desirable to immobilize either XBP-1(or a molecule in a signal transduction pathway involving XBP-1, e.g., IRE-1 or ATF6α) or a respective target molecule for example, to facilitate separation of complexed from uncomplexed forms of one or both of the proteins, or to accommodate automation of the assay. Binding of a test compound to a XBP-1 or a molecule in a signal transduction pathway involving XBP-1, or interaction of an XBP-1 protein (or a molecule in a signal transduction pathway involving XBP-1, e.g., IRE-1 or ATF6α) with a target molecule in the presence and absence of a test compound, can be accomplished in any vessel suitable for containing the reactants. Examples of such vessels include microtitre plates, test tubes, and micro-centrifuge tubes. In one embodiment, a fusion protein can be provided in which a domain that allows one or both of the proteins to be bound to a matrix is added to one or more of the molecules. For example, glutathione-S-transferase fusion proteins or glutathione-S-transferase/target fusion proteins can be adsorbed onto glutathione sepharose beads (Sigma Chemical, St. Louis, Mo.) or glutathione derivatized microtitre plates, which are then combined with the test compound or the test compound and either the non-adsorbed target protein or XBP-1 (or .g., IRE-1 or ATF6α) protein, and the mixture incubated under conditions conducive to complex formation (e.g., at physiological conditions for salt and pH). Following incubation, the beads or microtitre plate wells are washed to remove any unbound components, the matrix is immobilized in the case of beads, and complex formation is determined either directly or indirectly, for example, as described above. Alternatively, the complexes can be dissociated from the matrix, and the level of binding or activity determined using standard techniques.

Other techniques for immobilizing proteins on matrices can also be used in the screening assays of the invention. For example, either an XBP-1 protein or a molecule in a signal transduction pathway involving XBP-1, or a target molecule can be immobilized utilizing conjugation of biotin and streptavidin. Biotinylated protein or target molecules can be prepared from biotin-NHS (N-hydroxy-succinimide) using techniques known in the art (e.g., biotinylation kit, Pierce Chemicals, Rockford, Ill.), and immobilized in the wells of streptavidin-coated 96 well plates (Pierce Chemical). Alternatively, antibodies which are reactive with protein or target molecules but which do not interfere with binding of the protein to its target molecule can be derivatized to the wells of the plate, and unbound target or XBP-1 (or e.g., IRE-1 or ATF6α) protein is trapped in the wells by antibody conjugation. Methods for detecting such complexes, in addition to those described above for the GST-immobilized complexes, include immunodetection of complexes using antibodies reactive with XBP-1 or a molecule in a signal transduction pathway involving XBP-1 or target molecule, as well as enzyme-linked assays which rely on detecting an enzymatic activity associated with the XBP-1, IRE-1, or ATF6α protein or target molecule.

In yet another aspect of the invention, the XBP-1 protein(or .g., IRE-1 or ATF6α) or fragments thereof can be used as “bait proteins” e.g., in a two-hybrid assay or three-hybrid assay (see, e.g., U.S. Pat. No. 5,283,317; Zervos et al. (1993) Cell 72:223-232; Madura et al. (1993) J. Biol. Chem. 268:12046-12054; Bartel et al. (1 993) Biotechniques 14:920-924; Iwabuchi et al. (1993) Oncogene 8:1693-1696; Brent WO94/10300; each of which is incorporated herein by reference), to identify other proteins, which bind to or interact with XBP-1 (“binding proteins” or “bp”) and are involved in XBP-1 activity. Such XBP-1-binding proteins are also likely to be involved in the propagation of signals by the XBP-1 proteins or XBP-1 targets such as, for example, downstream elements of an XBP-1-mediated signaling pathway. Alternatively, such XBP-1-binding proteins can be XBP-1 inhibitors.

The two-hybrid system is based on the modular nature of most transcription factors, which consist of separable DNA-binding and activation domains. Briefly, the assay utilizes two different DNA constructs. In one construct, the gene that codes for an XBP-1 protein is fused to a gene encoding the DNA binding domain of a known transcription factor (e.g., GAL-4). In the other construct, a DNA sequence, from a library of DNA sequences, that encodes an unidentified protein (“prey” or “sample”) is fused to a gene that codes for the activation domain of the known transcription factor. If the “bait” and the “prey” proteins are able to interact, in vivo, forming an XBP-1 dependent complex, the DNA-binding and activation domains of the transcription factor are brought into close proximity. This proximity allows transcription of a reporter gene (e.g., LacZ) which is operably linked to a transcriptional regulatory site responsive to the transcription factor. Expression of the reporter gene can be detected and cell colonies containing the functional transcription factor can be isolated and used to obtain the cloned gene which encodes the protein which interacts with the XBP-1 protein or a molecule in a signal transduction pathway involving XBP-1.

D. Assays Using Knock-Down or Knock-Out Cells

In another embodiment, the invention provides methods for identifying compounds that modulate a biological effect of XBP-1 or a molecule in a signal transduction pathway involving XBP-1 using cells deficient in XBP-1(or e.g., IRE-1 or ATF6α). Cells deficient in XBP-1 or a molecule in a signal transduction pathway involving XBP-1 or in which XBP-1 or a molecule in a signal transduction pathway involving XBP-1 is knocked down can be used identify agents that modulate a biological response regulated by XBP-1 by means other than modulating XBP-1 itself (i.e., compounds that “rescue” the XBP-1 deficient phenotype). Alternatively, a “conditional knock-out” system, in which the gene is rendered non-functional in a conditional manner, can be used to create deficient cells for use in screening assays. For example, a tetracycline-regulated system for conditional disruption of a gene as described in WO 94/29442 and U.S. Pat. No. 5,650,298, each of which is incorporated herein by reference, can be used to create cells, or animals from which cells can be isolated, be rendered deficient in XBP-1 (or a molecule in a signal transduction pathway involving XBP-1 e.g., IRE-1 or ATF6α) in a controlled manner through modulation of the tetracycline concentration in contact with the cells.

In the screening method, cells deficient in XBP-1 or a molecule in a signal transduction pathway involving XBP-1 can be contacted with a test compound and a biological response regulated by XBP-1 or a molecule in a signal transduction pathway involving XBP-1 can be monitored. Modulation of the response in cells deficient in XBP-1 or a molecule in a signal transduction pathway involving XBP-1 (as compared to an appropriate control such as, for example, untreated cells or cells treated with a control agent) identifies a test compound as a modulator of the XBP-1(or e.g., IRE-1 or ATF6α) regulated response. In another embodiment, to specifically assess the role of agents that modulate unspliced or spliced XBP-1 protein, retroviral gene transduction of cells deficient in XBP-1, to express spliced XBP-1 or a form of XBP-1 which cannot be spliced can be performed. For example, a construct such as that described in the instant examples in which mutations at in the loop structure of XBP-1 (e.g., positions −1 and +3 in the loop structure of XBP-1) can be generated. Expression of this construct in cells results in production of the unspliced form of XBP-1 only. Using such constructs, the ability of a compound to modulate a particular form of XBP-1 can be detected. For example, in one embodiment, a compound modulates one form of XBP-1 without modulating the other form.

In one embodiment, the test compound is administered directly to a non-human knock out animal, preferably a mouse (e.g., a mouse in which the XBP gene or a gene in a signal transduction pathway involving XBP-1 is conditionally disrupted by means described above, or a chimeric mouse in which the lymphoid organs are deficient in XBP-1 or a molecule in a signal transduction pathway involving XBP-1 as described above), to identify a test compound that modulates the in vivo responses of cells deficient in XBP-1(or e.g., IRE-1 or ATF6α). In another embodiment, cells deficient in XBP-1(or e.g., IRE-1 or ATF6α) are isolated from the non-human XBP-1 or a molecule in a signal transduction pathway involving XBP-1 deficient animal, and contacted with the test compound ex vivo to identify a test compound that modulates a response regulated by XBP-1(or e.g., IRE-1 or ATF6α) in the cells

Cells deficient in XBP-1 or a molecule in a signal transduction pathway involving XBP-1 can be obtained from a non-human animals created to be deficient in XBP-1 or a molecule in a signal transduction pathway involving XBP-1 Preferred non-human animals include monkeys, dogs, cats, mice, rats, cows, horses, goats and sheep. In preferred embodiments, the deficient animal is a mouse. Mice deficient in XBP-1 or a molecule in a signal transduction pathway involving XBP-1 can be made using methods known in the art. Non-human animals deficient in a particular gene product typically are created by homologous recombination. Briefly, a vector is prepared which contains at least a portion of the gene into which a deletion, addition or substitution has been introduced to thereby alter, e.g., functionally disrupt, the endogenous XBP-1 (or e.g., IRE-1 or ATF6α gene). The gene preferably is a mouse gene. For example, a mouse XBP-1 gene can be isolated from a mouse genomic DNA library using the mouse XBP-1 cDNA as a probe. The mouse XBP-1 gene then can be used to construct a homologous recombination vector suitable for modulating an endogenous XBP-1 gene in the mouse genome. In a preferred embodiment, the vector is designed such that, upon homologous recombination, the endogenous gene is functionally disrupted (i.e., no longer encodes a functional protein; also referred to as a “knock out” vector).

Alternatively, the vector can be designed such that, upon homologous recombination, the endogenous gene is mutated or otherwise altered but still encodes functional protein (e.g., the upstream regulatory region can be altered to thereby alter the expression of the endogenous XBP-1 protein). In the homologous recombination vector, the altered portion of the gene is flanked at its 5′ and 3′ ends by additional nucleic acid of the gene to allow for homologous recombination to occur between the exogenous gene carried by the vector and an endogenous gene in an embryonic stem cell. The additional flanking nucleic acid is of sufficient length for successful homologous recombination with the endogenous gene. Typically, several kilobases of flanking DNA (both at the 5′ and 3′ ends) are included in the vector (see e.g., Thomas, K. R. and Capecchi, M. R. (1987) Cell 51:503 for a description of homologous recombination vectors; incorporated herein by reference). The vector is introduced into an embryonic stem cell line (e.g., by electroporation) and cells in which the introduced gene has homologously recombined with the endogenous gene are selected (see e.g., Li, E. et al. (1992) Cell 69:915; incorporated herein by reference). The selected cells are then injected into a blastocyst of an animal (e.g., a mouse) to form aggregation chimeras (see e.g., Bradley, A. in Teratocarcinomas and Embryonic Stem Cells: A Practical Approach, E. J. Robertson, ed. (IRL, Oxford, 1987) pp. 113-152; incorporated herein by reference). A chimeric embryo can then be implanted into a suitable pseudopregnant female foster animal and the embryo brought to term. Progeny harboring the homologously recombined DNA in their germ cells can be used to breed animals in which all cells of the animal contain the homologously recombined DNA by germline transmission of the transgene. Methods for constructing homologous recombination vectors and homologous recombinant animals are described further in Bradley, A. (1991) Current Opinion in Biotechnology 2:823-829 and in PCT International Publication Nos.: WO 90/11354 by Le Mouellec et al.; WO 91/01140 by Smithies et al.; WO 92/0968 by Zijistra et al.; and WO 93/04169 by Berns et al.; each of which is incorporated herein by reference.

In another embodiment, retroviral transduction of donor bone marrow cells from both wild type and null mice can be performed, e.g., with the XBP-1 unspliced, DN or spliced constructs to reconstitute irradiated RAG recipients. This will result in the production of mice whose lymphoid cells express only unspliced, or only spliced XBP-1 protein, or which express a dominant negative version of XBP-1. Cells from these mice can then be tested for compounds that modulate a biological response regulated by XBP-1.

In another embodiment, a molecule which mediates RNAi, e.g., double stranced RNA can be used to knock down expression of XBP-1 or a molecule in a signal transduction pathway involving XBP-1. For example, an XBP-1-specific RNAi vector has been constructed by inserting two complementary oligonucleotides 5′-GGGATTCATGAATGGCCCTTA-3′ (SEQ ID NO.:9) into the pBS/U6 vector as described (Sui etal. 2002 Proc Natl Acad Sci US A 99: 5515-5520; incorporated herein by reference).

In one embodiment of the screening assay, compounds tested for their ability to modulate a biological response regulated by XBP-1 or a molecule in a signal transduction pathway involving XBP-1 are contacted with deficient cells by administering the test compound to a non-human deficient animal in vivo and evaluating the effect of the test compound on the response in the animal.

The test compound can be administered to a non-knock out animal as a pharmaceutical composition. Such compositions typically comprise the test compound and a pharmaceutically acceptable carrier. As used herein the term “pharmaceutically acceptable carrier” includes any and all solvents, dispersion media, coatings, antibacterial and antifungal compounds, isotonic and absorption delaying compounds, and the like, compatible with pharmaceutical administration. The use of such media and compounds for pharmaceutically active substances is well known in the art. Except insofar as any conventional media or compound is incompatible with the active compound, use thereof in the compositions is contemplated. Supplementary active compounds can also be incorporated into the compositions. Pharmaceutical compositions are described in more detail below.

In another embodiment, compounds that modulate a biological response regulated by XBP-1 or a signal transduction pathway involving XBP-1 are identified by contacting cells deficient in XBP-1 ex vivo with one or more test compounds, and determining the effect of the test compound on a read-out. In one embodiment, XBP-1 deficient cells contacted with a test compound ex vivo can be readministered to a subject.

For practicing the screening method ex vivo, cells deficient, e.g., in XBP-1, IRE-1, or ATF6α can be isolated from a non-human XBP-1, IRE-1, or ATF6α deficient animal or embryo by standard methods and incubated (i.e., cultured) in vitro with a test compound. Cells (e.g., B cells, hepatocytes, MEFs) can be isolated from e.g., XBP-1, IRE-1, or ATF6α deficient animals by standard techniques.

In another embodiment, cells deficient in more than one member of a signal transduction pathway involving XBP-1 can be used in the subject assays.

Following contact of the deficient cells with a test compound (either ex vivo or in vivo), the effect of the test compound on the biological response regulated by XBP-1 or a molecule in a signal transduction pathway involving XBP-1 can be determined by any one of a variety of suitable methods, such as those set forth herein, e.g., including light microscopic analysis of the cells, histochemical analysis of the cells, production of proteins, induction of certain genes, e.g., chaperone genes or IL-6.

E. Test Compounds

A variety of test compounds can be evaluated using the screening assays described herein. The term “test compound” includes any reagent or test agent which is employed in the assays of the invention and assayed for its ability to influence the expression and/or activity of XBP-1 or a molecule in a signal transduction pathway involving XBP-1. More than one compound, e.g., a plurality of compounds, can be tested at the same time for their ability to modulate the expression and/or activity of, e.g., XBP-1 in a screening assay. The term “screening assay” preferably refers to assays which test the ability of a plurality of compounds to influence the readout of choice rather than to tests which test the ability of one compound to influence a readout. Preferably, the subject assays identify compounds not previously known to have the effect that is being screened for. In one embodiment, high throughput screening can be used to assay for the activity of a compound.

In certain embodiments, the compounds to be tested can be derived from libraries (i.e., are members of a library of compounds). While the use of libraries of peptides is well established in the art, new techniques have been developed which have allowed the production of mixtures of other compounds, such as benzodiazepines (Bunin et al. (1992). J. Am. Chem. Soc. 114:10987; DeWitt et al. (1993). Proc. Natl. Acad. Sci. USA 90:6909; each of which is incorporated herein by reference) peptoids (Zuckermann. (1994). J. Med Chem. 37:2678; incorporated herein by reference) oligocarbamates (Cho et al. (1993). Science. 261:1303; incorporated herein by reference), and hydantoins (DeWitt et al. supra; incorporated herein by reference). An approach for the synthesis of molecular libraries of small organic molecules with a diversity of 104-105 as been described (Carell et al. (1994). Angew. Chem. Int. Ed. Engl. 33:2059; Carell et al. (1 994) Angew. Chem. Int. Ed. Engl. 33:2061; each of which is incorporated herein by reference).

The compounds of the present invention can be obtained using any of the numerous approaches in combinatorial library methods known in the art, including: biological libraries; spatially addressable parallel solid phase or solution phase libraries, synthetic library methods requiring deconvolution, the ‘one-bead one-compound’ library method, and synthetic library methods using affinity chromatography selection. The biological library approach is limited to peptide libraries, while the other four approaches are applicable to peptide, non-peptide oligomer or small molecule libraries of compounds (Lam (1997) Anticancer Drug Des. 12:145; incorporated herein by reference). Other exemplary methods for the synthesis of molecular libraries can be found in the art, for example in: Erb et al. (1994). Proc. Natl. Acad. Sci. USA 91:11422; Horwell et al. (1996) Immunopharmacology 33:68; and in Gallop et al. (1994); J. Med. Chem. 37:1233; each of which is incorporated herein by reference.

Libraries of compounds can be presented in solution (e.g., Houghten (1992) Biotechniques 13:412-421; incorporated herein by reference), or on beads (Lam (1991) Nature 354:82-84; incorporated herein by reference), chips (Fodor (1993) Nature 364:555-556; incorporated herein by reference), bacteria (Ladner U.S. Pat. No. 5,223,409; incorporated herein by reference), spores (Ladner USP '409; incorporated herein by reference), plasmids (Cull et al. (1992) Proc Natl Acad Sci USA 89:1865-1869; incorporated herein by reference) or on phage (Scott and Smith (1990) Science 249:386-390; incorporated herein by reference); (Devlin (1990) Science 249:404-406; incorporated herein by reference); (Cwirla et al. (1990) Proc. Natl. Acad. Sci. 87:6378-6382; incorporated herein by reference); (Felici (1991) J. Mol. Biol. 222:301-310; incorporated herein by reference). In still another embodiment, the combinatorial polypeptides are produced from a cDNA library.

Exemplary compounds which can be screened for activity include, but are not limited to, peptides, nucleic acids, carbohydrates, small organic molecules, and natural product extract libraries.

Candidate/test compounds include, for example, 1) peptides such as soluble peptides, including Ig-tailed fusion peptides and members of random peptide libraries (see, e.g., Lam, K. S. et al. (1991) Nature 354:82-84; Houghten, R. et al. (1991) Nature 354:84-86; each of which is incorporated herein by reference) and combinatorial chemistry-derived molecular libraries made of D- and/or L-configuration amino acids; 2) phosphopeptides (e.g., members of random and partially degenerate, directed phosphopeptide libraries, see, e.g., Songyang et al. (1993) Cell 72:767-778; incorporated herein by reference); 3) antibodies (e.g., polyclonal, monoclonal, humanized, anti-idiotypic, chimeric, and single chain antibodies as well as Fab, F(ab′)₂, Fab expression library fragments, and epitope-binding fragments of antibodies); 4) small organic and inorganic molecules (e.g., molecules obtained from combinatorial and natural product libraries); 5) enzymes (e.g., endoribonucleases, hydrolases, nucleases, proteases, synthatases, isomerases, polymerases, kinases, phosphatases, oxido-reductases and ATPases), and 6) mutant forms of XBP-1 (or e.g., IRE-1 or ATF6α molecules, e.g., dominant negative mutant forms of the molecules.

The test compounds of the present invention can be obtained using any of the numerous approaches in combinatorial library methods known in the art, including: biological libraries; spatially addressable parallel solid phase or solution phase libraries; synthetic library methods requiring deconvolution; the ‘one-bead one-compound’ library method; and synthetic library methods using affinity chromatography selection. The biological library approach is limited to peptide libraries, while the other four approaches are applicable to peptide, non-peptide oligomer or small molecule libraries of compounds (Lam, K. S. (1997) Anticancer Drug Des. 12:145; incorporated herein by reference).

Examples of methods for the synthesis of molecular libraries can be found in the art, for example in: DeWitt et al. (1993) Proc. Natl. Acad. Sci. U.S.A. 90:6909; Erb et al. (1994) Proc. Natl. Acad. Sci. USA 91:11422; Zuckermann et al. (1994) J. Med. Chem. 37:2678; Cho et al. (1993) Science 261:1303; Carrell et al. (1994) Angew. Chem. Int. Ed. Engl. 33:2059; Carell et al. (1994) Angew. Chem. Int. Ed. Engl. 33:2061; and Gallop et al. (1994) J. Med. Chem. 37:1233; each of which is incorporated herein by reference.

Libraries of compounds can be presented in solution (e.g., Houghten (1992) Biotechniques 13:412-421; incorporated herein by reference), or on beads (Lam (1991) Nature 354:82-84; incorporated herein by reference), chips (Fodor (1993) Nature 364:555-556; incorporated herein by reference), bacteria (Ladner U.S. Pat. No. 5,223,409; incorporated herein by reference), spores (Ladner USP '409; incorporated herein by reference), plasmids (Cull et al. (1992) Proc Natl Acad Sci USA 89:1865-1869; incorporated herein by reference) or phage (Scott and Smith (1990) Science 249:386-390; Devlin (1990) Science 249:404-406; Cwirla et al. (1990) Proc. Natl. Acad. Sci. 87:6378-6382; Felici (1991) J. Mol. Biol. 222:301-310; Ladner supra.; each of which is incorporated herein by reference).

Compounds identified in the subject screening assays can be used in methods of modulating one or more of the biological responses regulated by XBP-1. It will be understood that it may be desirable to formulate such compound(s) as pharmaceutical compositions (described supra) prior to contacting them with cells.

Once a test compound is identified that directly or indirectly modulates, e.g., XBP-1 expression or activity, by one of the variety of methods described hereinbefore, the selected test compound (or “compound of interest”) can then be further evaluated for its effect on cells, for example by contacting the compound of interest with cells either in vivo (e.g., by administering the compound of interest to a subject) or ex vivo (e.g., by isolating cells from the subject and contacting the isolated cells with the compound of interest or, alternatively, by contacting the compound of interest with a cell line) and determining the effect of the compound of interest on the cells, as compared to an appropriate control (such as untreated cells or cells treated with a control compound, or carrier, that does not modulate the biological response).

F. Computer Assisted Design of Modulators of XBP-1

Computer-based analysis of a protein with a known structure can also be used to identify molecules which will bind to the protein. Such methods rank molecules based on their shape complementary to a receptor site. For example, using a 3-D database, a program such as DOCK can be used to identify molecules which will bind to XBP-1 or a molecule in a signal transduction pathway involving XBP-1. See DesJarlias et al. (1988) J. Med. Chem. 31:722; Meng et al. (1992) J. Computer Chem. 13:505; Meng et al. (1993) Proteins 17:266; Shoichet et al. (1993) Science 259:1445; each of which is incorporated herein by reference. In addition, the electronic complementarity of a molecule to a targeted protein can also be analyzed to identify molecules which bind to the target. This can be determined using, for example, a molecular mechanics force field as described in Meng et al. (1992) J. Computer Chem. 13:505 and Meng et al. (1993) Proteins 17:266; each of which is incorporated herein by reference. Other programs which can be used include CLIX which uses a GRID force field in docking of putative ligands. See Lawrence et al. (1992) Proteins 12:31; Goodford et al. (1985) J. Med. Chem. 28:849; Boobbyer et al. (1989) J. Med. Chem. 32:1083; each of which is incorporated herein by reference.

The instant invention also pertains to compounds identified in the subject screening assays.

III. Pharmaceutical Compositions

A pharmaceutical composition comprising a compound of the invention, e.g., a stimulatory or inhibitory molecule of the invention or a compound identified in the subject screening assays, is formulated to be compatible with its intended route of administration. For example, solutions or suspensions used for parenteral, intradermal, or subcutaneous application can include the following components: a sterile diluent such as water for injection, saline solution, fixed oils, polyethylene glycols, glycerine, propylene glycol or other synthetic solvents; antibacterial compounds such as benzyl alcohol or methyl parabens; antioxidants such as ascorbic acid or sodium bisulfite; chelating compounds such as ethylenediaminetetraacetic acid; buffers such as acetates, citrates or phosphates and compounds for the adjustment of tonicity such as sodium chloride or dextrose. pH can be adjusted with acids or bases, such as hydrochloric acid or sodium hydroxide. The parenteral preparation can be enclosed in ampoules, disposable syringes or multiple dose vials made of glass or plastic.

Pharmaceutical compositions suitable for injectable use include sterile aqueous solutions (where water soluble) or dispersions and sterile powders for the extemporaneous preparation of sterile injectable solutions or dispersion. For intravenous administration, suitable carriers include physiological saline, bacteriostatic water, Cremophor EL™ (BASF, Parsippany, N.J.) or phosphate buffered saline (PBS). In all cases, the composition will preferably be sterile and should be fluid to the extent that easy syringability exists. It will preferably be stable under the conditions of manufacture and storage and must be preserved against the contaminating action of microorganisms such as bacteria and fungi. The carrier can be a solvent or dispersion medium containing, for example, water, ethanol, polyol (for example, glycerol, propylene glycol, and liquid polyetheylene glycol, and the like), and suitable mixtures thereof. The proper fluidity can be maintained, for example, by the use of a coating such as lecithin, by the maintenance of the required particle size in the case of dispersion and by the use of surfactants. Prevention of the action of microorganisms can be achieved by various antibacterial and antifungal compounds, for example, parabens, chlorobutanol, phenol, ascorbic acid, thimerosal, and the like. In many cases, it will be preferable to include isotonic compounds, for example, sugars, polyalcohols such as manitol, sorbitol, sodium chloride in the composition. Prolonged absorption of the injectable compositions can be brought about by including in the composition an compound which delays absorption, for example, aluminum monostearate and gelatin.

Sterile injectable solutions can be prepared by incorporating the active compound in the required amount in an appropriate solvent with one or a combination of ingredients enumerated above, as required, followed by filtered sterilization. Generally, dispersions are prepared by incorporating the active compound into a sterile vehicle which contains a basic dispersion medium and the required other ingredients from those enumerated above. In the case of sterile powders for the preparation of sterile injectable solutions, the preferred methods of preparation are vacuum drying and freeze-drying which yields a powder of the active ingredient plus any additional desired ingredient from a previously sterile-filtered solution thereof.

Oral compositions generally include an inert diluent or an edible carrier. They can be enclosed in gelatin capsules or compressed into tablets. For the purpose of oral therapeutic administration, the active compound can be incorporated with excipients and used in the form of tablets, troches, or capsules. Oral compositions can also be prepared using a fluid carrier for use as a mouthwash, wherein the compound in the fluid carrier is applied orally and swished and expectorated or swallowed. Pharmaceutically compatible binding compounds, and/or adjuvant materials can be included as part of the composition. The tablets, pills, capsules, troches and the like can contain any of the following ingredients, or compounds of a similar nature: a binder such as microcrystalline cellulose, gum tragacanth or gelatin; an excipient such as starch or lactose, a disintegrating compound such as alginic acid, Primogel, or corn starch; a lubricant such as magnesium stearate or Sterotes; a glidant such as colloidal silicon dioxide; a sweetening compound such as sucrose or saccharin; or a flavoring compound such as peppermint, methyl salicylate, or orange flavoring.

In one embodiment, the test compounds are prepared with carriers that will protect the compound against rapid elimination from the body, such as a controlled release formulation, including implants and microencapsulated delivery systems. Biodegradable, biocompatible polymers can be used, such as ethylene vinyl acetate, polyanhydrides, polyglycolic acid, collagen, polyorthoesters, and polylactic acid. Methods for preparation of such formulations will be apparent to those skilled in the art. The materials can also be obtained commercially from, e.g., Alza Corporation and Nova Pharmaceuticals, Inc. Liposomal suspensions (including liposomes targeted to infected cells with monoclonal antibodies to viral antigens) can also be used as pharmaceutically acceptable carriers. These can be prepared according to methods known to those skilled in the art, for example, as described in U.S. Pat. No. 4,522,811, incorporated herein by reference.

IV. Methods for Modulating Metabolic Disorders by Modulating XBP-1

The invention also provides for the modulation of at least one symptom of a metabolic disorder by modulating XBP-1 (e.g., by directly or indirectly modulating XBP-1 or a molecule in a signal transduction pathway involving XBP-1) in cells, e.g., either in vitro or in vivo. In particular, the ability of a compound to modulate XBP-1 can be detected by measuring the ability of the compound to modulate a biological activity of XBP-1, e.g., by measuring modulation of metabolism, modulation of insulin resistance, modulation of insulin receptor mediated signaling, modulation of the UPR in a cell, modulation of the proteasome pathway, modulation of protein folding, secretion, expression and/or transport, modulation of terminal B cell differentiation, and modulation of apoptosis. Accordingly, the invention features methods for modulating a metabolic disorder regulated by XBP-1 by contacting the cells with a modulator of XBP-1 expression, processing, post-translational modification, and/or activity such that the biological response is modulated. In another embodiment, a biological response regulated by XBP-1 can be modulated by modulating the expression, processing, post-translational modification, and/or activity of a non-XBP-1 molecule that acts upstream or downstream of XBP-1 in a signal transduction pathway involving XBP-1 (e.g., ATF6α or IRE-1). The claimed methods of modulation are not meant to include naturally occurring events. For example, the term “agent” or “modulator” is not meant to embrace endogenous mediators produced by the cells of a subject.

The subject methods employ agents that modulate XBP-1 expression, processing, post-translational modification, or activity (or the expression, processing, post-translational modification, or activity of another molecule in an XBP-1 signaling pathway (e.g., IRE-1)) such that an XBP-1 biological activity is modulated. The subject methods are useful in both clinical and non-clinical settings.

In one embodiment, the instant methods can be performed in vitro. For example, the production of a commercially valuable protein, e.g., a recombinantly expressed protein, can be increased by stimulating the expression, processing, post-translational modification, and/or activity of spliced XBP-1 or by inhibiting the expression, processing, post-translational modification, and/or activity of a negative regulator of spliced XBP-1. In a preferred embodiment, the production of immunoglobulin can be increased in a cell either in vitro or in vivo. In another embodiment, XBP-1 expression, processing, post-translational modification, and/or activity can be modulated in a cell in vitro and then the treated cells can be administered to a subject.

In one embodiment, the methods and compositions of the invention can be used to modulate XBP-1 expression, processing, post-translational modification, and/or activity (or the expression, processing, post-translational modification, and/or activity of a molecule in a signal transduction pathway involving XBP-1) in a cell. In one embodiment, the cell is a mammalian cell. In another embodiment, the cell is a human cell. Such modulation can occur in vitro or in vivo. The subject invention can also be used to treat various conditions or disorders that would benefit from modulation of one or more XBP-1 biological activity. In one embodiment, cells in which, e.g., XBP-1, is modulated in vitro can be introduced or reintroduced into a subject. In one embodiment, the invention also allows for modulation of XBP-1 in vivo, by administering to the subject a therapeutically effective amount of a modulator of XBP-1 such that a biological effect of XBP-1 in a subject is modulated. For example, XBP-1 can be modulated to treat a specific metabolic disorder.

In another embodiment, a modulatory agent of the invention directly affects the expression, post-translational modification, and/or activity of XBP-1 protein. In one embodiment, the expression of XBP-1 is modulated. In another embodiment, the post-translational modification of XBP-1 is modulated. In another embodiment, the activity of XBP-1 is modulated.

The term “subject” is intended to include living organisms but preferred subjects are mammals. Examples of subjects include mammals such as, e.g., humans, monkeys, dogs, cats, mice, rats, cows, horses, goats, and sheep.

Identification of compounds that modulate the biological effects of XBP-1 by directly or indirectly modulating XBP-1 activity allows for selective manipulation of these biological effects in a variety of clinical situations using the modulatory methods of the invention. For example, the stimulatory methods of the invention (i.e., methods that use a stimulatory agent) can result in increased expression, processing, post-translational modification, and/or activity of spliced XBP-1, such that at least one symptom of a metabolic disorder is alleviated.

In another embodiment, the inhibitory methods of the invention inhibit the activity of a negative regulator of XBP-1, e.g., unspliced XBP-1 or a dominant negative form of XBP-1. The XBP-1 unspliced protein is an example of a ubiquitinated and hence extremely unstable protein. XBP-1 spliced protein is not ubiquitinated, and has a much longer half life than unspliced XBP-1 protein. Proteasome inhibitors, for example, block ubiquitination, and hence stabilize XBP-1 unspliced but not spliced protein. Thus, the ratio of unspliced to spliced XBP-1 protein increases upon treatment with proteasome inhibitors. Since unspliced XBP-1 protein actually inhibits the function of the spliced protein, treatment with proteasome inhibitors blocks the activity of spliced XBP-1.

Modulation of XBP-1 activity, therefore, provides a means to regulate disorders arising from aberrant XBP-1 activity in metabolic disorders. Thus, to treat a disorder wherein stimulation of a biological effect of spliced XBP-1 is desirable, a stimulatory method of the invention is selected such that spliced XBP-1 activity is stimulated and/or a inhibitory method is selected such that the expression and/or activity of a negative regulator of XBP-1 is inhitibed.

In one embodiment, the modulatory methods of the invention are practiced on a subject in a patient population suffering from a metabolic disorder. For example, in one embodiment, the modulatory methods of the invention are practiced on a subject that would benefit from modulation of a metabolic disorder. In another embodiment, a biological specimen can be obtained from the patient and assayed for, e.g., expression or activity of XBP-1 or a molecule in a signal transduction pathway involving XBP-1 to identify a patient that would benefit from modulation of XBP-1.

In another embodiment, a biological sample from a subject can be examined for the presence of mutations in a gene encoding XBP-1 (or a molecule in a signal transduction pathway encoding XBP-1) or in the promoter region for XBP-1 (or a gene in a signal transduction pathway encoding XBP-1).

In another embodiment, the level of expression of genes whose expression is regulated by XBP-1 (e.g., ERdj4, p58^{IPK}, EDEM, PDI-P5, RAMP4, BiP, XBP-1, or ATF6α) can be measured using standard techniques. The sequences of such genes are known in the art. See, e.g., ERdj4 (e.g., NM_{—}012328 [gi:9558754] (SEQ ID NO.:10-nucleic acid; SEQ ID NO.:11-amino acid)), p58^{ipk} (e.g., XM_{—}209778 [gi:2749842] or NM_{—}006260 [gi:24234721] (SEQ ID NO.:12-nucleic acid; SEQ ID NO.:13-amino acid)), EDEM (e.g., NM_{—}014674 [gi:7662001] (SEQ ID NO.:14-nucleic acid; SEQ ID NO.:15-amino acid)), PDI-P5 (e.g., D49489 [gi:1136742] (SEQ ID NO.:16-nucleic acid; SEQ ID NO.:17-amino acid)), RAMP4 (e.g., AF136975 [gi: 12239332] (SEQ ID NO.:18-nucleic acid; SEQ ID NO.:19-amino acid)), HEDJ (e.g., AF228505 [gi: 7385134] (SEQ ID NO.:20-nucleic acid; SEQ ID NO.:21-amino acid)), BiP (e.g., X87949 [gi: 1143491] (SEQ ID NO.:22-nucleic acid; SEQ ID NO.:23-amino acid)), ATF6ac (e.g., NM_{—}007348 [gi:6671584 (SEQ ID NO.:24-nucleic acid; SEQ ID NO.:25-amino acid)], XBP-1 (e.g., NM_{—}005080 [gi:14110394]), Armet (e.g., NM_{—}006010 [gi:51743920] (SEQ ID NO.:26-nucleic acid; SEQ ID NO.:27-amino acid)) and/or DNAJB9 (which encodes mDj7) e.g., (NM_{—}012328 [gi:9558754] (SEQ ID NO.:28-nucleic acid; SEQ ID NO.:29-amino acid)), the MHC class II genes (various MHC class II gene sequences are known in the art) and the IL-6 gene (e.g., MN_{—}000600 [gi 10834983] (SEQ ID NO.:30-nucleic acid; SEQ ID NO.:31-amino acid)).

Application of the modulatory methods of the invention to the treatment of a disorder can result in curing the disorder, a decrease in at least one symptom associated with the disorder, either in the long term or short term (i.e., amelioration of the condition) or simply a transient beneficial effect to the subject.

Compounds that can be used in the methods of the invention is described in further detail below.

Stimulatory Compounds

The methods of the invention using spliced XBP-1 stimulatory compounds can be used in the treatment of disorders in which spliced XBP activity and/or expression is undesirably reduced, inhibited, downregulated or the like. For example, in the case of metabolic disorders. In one embodiment, the stimulatory methods of the invention, a subject is treated with a stimulatory compound that stimulates expression and/or activity of spliced XBP-1 or a molecule in a signal transduction pathway involving XBP-1.

In another embodiment, a stimulatory method of the invention can be used to stimulate the expression and/or activity of a negative regulator of spliced XBP-1 activity.

Examples of stimulatory compounds include proteins, expression vectors comprising nucleic acid molecules and chemical agents that stimulate expression and/or activity of the protein of interest.

A preferred stimulatory compound is a nucleic acid molecule encoding unspliced XBP-1 that is capable of being spliced or spliced XBP wherein the nucleic acid molecule is introduced into the subject in a form suitable for expression of the protein in the cells of the subject. For example, an XBP-1 cDNA (full length or partial cDNA sequence) is cloned into a recombinant expression vector and the vector is transfected into cells using standard molecular biology techniques. The XBP-1 cDNA can be obtained, for example, by amplification using the polymerase chain reaction (PCR) or by screening an appropriate cDNA library. The nucleotide sequences of XBP-1 cDNA are known in the art and can be used for the design of PCR primers that allow for amplification of a cDNA by standard PCR methods or for the design of a hybridization probe that can be used to screen a cDNA library using standard hybridization methods. Another preferred stimulatory compound is a nucleic acid molecule encoding the spliced form of XBP-1.

Following isolation or amplification of XBP-1 cDNA or cDNA encoding a molecule in a signal transduction pathway involving XBP-1, the DNA fragment is introduced into a suitable expression vector, as described above. For example, nucleic acid molecules encoding XBP-1 in the form suitable for expression of the XBP-1 in a host cell, can be prepared as described above using nucleotide sequences known in the art. The nucleotide sequences can be used for the design of PCR primers that allow for amplification of a cDNA by standard PCR methods or for the design of a hybridization probe that can be used to screen a cDNA library using standard hybridization methods.

In one embodiment, a stimulatory agent can be present in an inducible construct. In another embodiment, a stimulatory agent can be present in a construct which leads to constitutive expression.

Another form of a stimulatory compound for stimulating expression of XBP-1 or a molecule in a signal transduction pathway involving XBP-1 in a cell is a chemical compound that specifically stimulates the expression, processing, post-translational modification, or activity of endogenous spliced XBP-1. Such compounds can be identified using screening assays that select for compounds that stimulate the expression of XBP-1 that can be spliced or activity of spliced XBP-1 as described herein.

Inhibitory Compounds

The methods of the invention using inhibitory compounds which inhibit the expression, processing, post-translational modification, or activity of spliced XBP-1 or a molecule in a signal transduction pathway involving XBP-1 can be used in the treatment of disorders in which spliced XBP-1 activity is undesirably enhanced, stimulated, upregulated or the like.

In a preferred embodiment, inhibitory compounds can be used to inhibit the expression, processing, post-translational modification, or activity of a negative regulator of XBP-1, e.g., unspliced XBP-l. Such compounds can be used in the treatment of disorders in which unspliced XBP-1 is undesirably elevated or when spliced XBP-1 expression and/or activity is undesirably reduced.

In one embodiment of the invention, an inhibitory compound can be used to inhibit (e.g., specifically inhibit) the expression, processing, post-translational modification, or activity of spliced XBP-1. Preferably, an inhibitory compound can be used to inhibit (e.g., specifically inhibit) the expression, processing, post-translational modification, or activity of unspliced XBP-1.

Inhibitory compounds of the invention can be, for example, intracellular binding molecules that act to specifically inhibit the expression, processing, post-translational modification, or activity e.g., of XBP-1 or a molecule in a signal transduction pathway involving XBP-1( e.g., IRE-1 or ATF6α). As used herein, the term “intracellular binding molecule” is intended to include molecules that act intracellularly to inhibit the processing expression or activity of a protein by binding to the protein or to a nucleic acid (e.g., an mRNA molecule) that encodes the protein. Examples of intracellular binding molecules, described in further detail below, include antisense nucleic acids, intracellular antibodies, peptidic compounds that inhibit the interaction of XBP-1 or a molecule in a signal transduction pathway involving XBP-1 with a target molecule and chemical agents that specifically inhibit XBP-1 activity or the activity of a molecule in a signal transduction pathway involving XBP-1.

Antisense or siRNA Nucleic Acid Molecules

In one embodiment, an inhibitory compound of the invention is an antisense nucleic acid molecule that is complementary to a gene encoding XBP-1 or a molecule in a signal transduction pathway involving XBP-1, e.g., a molecule with which XBP-1 interacts), or to a portion of said gene, or a recombinant expression vector encoding said antisense nucleic acid molecule. The use of antisense nucleic acids to downregulate the expression of a particular protein in a cell is well known in the art (see e.g., Weintraub, H. et al., Antisense RNA as a molecular tool for genetic analysis, Reviews—Trends in Genetics, Vol. 1(1) 1986; Askari, F. K. and McDonnell, W. M. (1996) N. Eng. J. Med. 334:316-318; Bennett, M. R. and Schwartz, S. M. (1995) Circulation 92:1981-1993; Mercola, D. and Cohen, J. S. (1995) Cancer Gene Ther. 2:47-59; Rossi, J. J. (1995) Br. Med. Bull. 51:217-225; Wagner, R. W. (1994) Nature 372:333-335; eahc of which is incorporated herein by reference). An antisense nucleic acid molecule comprises a nucleotide sequence that is complementary to the coding strand of another nucleic acid molecule (e.g., an mRNA sequence) and accordingly is capable of hydrogen bonding to the coding strand of the other nucleic acid molecule. Antisense sequences complementary to a sequence of an mRNA can be complementary to a sequence found in the coding region of the mRNA, the 5′ or 3′ untranslated region of the mRNA or a region bridging the coding region and an untranslated region (e.g., at the junction of the 5′ untranslated region and the coding region). Furthermore, an antisense nucleic acid can be complementary in sequence to a regulatory region of the gene encoding the mRNA, for instance a transcription initiation sequence or regulatory element. Preferably, an antisense nucleic acid is designed so as to be complementary to a region preceding or spanning the initiation codon on the coding strand or in the 3′ untranslated region of an mRNA.

Given the known nucleotide sequence for the coding strand of the XBP-1 gene (or e.g., the IRE-1 or ATF6α gene) and thus the known sequence of the XBP-1, IRE-1, or ATF6α mRNA, antisense nucleic acids of the invention can be designed according to the rules of Watson and Crick base pairing. The antisense nucleic acid molecule can be complementary to the entire coding region of an mRNA, but more preferably is antisense to only a portion of the coding or noncoding region of an mRNA. For example, the antisense oligonucleotide can be complementary to the region surrounding the translation start site of an XBP-1 (or e.g., the IRE-1 or ATF6α) mRNA. An antisense oligonucleotide can be, for example, about 5, 10, 15, 20, 25, 30, 35, 40, 45 or 50 nucleotides in length. An antisense nucleic acid of the invention can be constructed using chemical synthesis and enzymatic ligation reactions using procedures known in the art. For example, an antisense nucleic acid (e.g., an antisense oligonucleotide) can be chemically synthesized using naturally occurring nucleotides or variously modified nucleotides designed to increase the biological stability of the molecules or to increase the physical stability of the duplex formed between the antisense and sense nucleic acids, e.g., phosphorothioate derivatives and acridine substituted nucleotides can be used. Examples of modified nucleotides which can be used to generate the antisense nucleic acid include 5-fluorouracil, 5-bromouracil, 5-chlorouracil, 5-iodouracil, hypoxanthine, xanthine, 4-acetylcytosine, 5-(carboxyhydroxylmethyl) uracil, 5-carboxymethylaminomethyl-2-thiouridine, 5-carboxymethylaminomethyluracil, dihydrouracil, beta-D-galactosylqueosine, inosine, N6-isopentenyladenine, 1-methylguanine, 1-methylinosine, 2,2-dimethylguanine, 2-methyladenine, 2-methylguanine, 3-methylcytosine, 5-methylcytosine, N6-adenine, 7-methylguanine, 5-methylaminomethyluracil, 5-methoxyaminomethyl-2-thiouracil, beta-D-mannosylqueosine, 5′-methoxycarboxymethyluracil, 5-methoxyuracil, 2-methylthio-N6-isopentenyladenine, uracil-5-oxyacetic acid (v), wybutoxosine, pseudouracil, queosine, 2-thiocytosine, 5-methyl-2-thiouracil, 2-thiouracil, 4-thiouracil, 5-methyluracil, uracil-5-oxyacetic acid methylester, uracil-5-oxyacetic acid (v), 5 -methyl-2-thiouraci 1,3 -(3-amino-3-N-2-carboxypropyl) uracil, (acp3)w, and 2,6-diaminopurine. To inhibit expression in cells, one or more antisense oligonucleotides can be used.

Alternatively, an antisense nucleic acid can be produced biologically using an expression vector into which all or a portion of a cDNA has been subcloned in an antisense orientation (i.e., nucleic acid transcribed from the inserted nucleic acid will be of an antisense orientation to a target nucleic acid of interest). Regulatory sequences operatively linked to a nucleic acid cloned in the antisense orientation can be chosen which direct the expression of the antisense RNA molecule in a cell of interest, for instance promoters and/or enhancers or other regulatory sequences can be chosen which direct constitutive, tissue specific or inducible expression of antisense RNA. The antisense expression vector is prepared according to standard recombinant DNA methods for constructing recombinant expression vectors, except that the cDNA (or portion thereof) is cloned into the vector in the antisense orientation. The antisense expression vector can be in the form of, for example, a recombinant plasmid, phagemid or attenuated virus. The antisense expression vector can be introduced into cells using a standard transfection technique.

The antisense nucleic acid molecules of the invention are typically administered to a subject or generated in situ such that they hybridize with or bind to cellular mRNA and/or genomic DNA encoding a protein to thereby inhibit expression of the protein, e.g., by inhibiting transcription and/or translation. The hybridization can be by conventional nucleotide complementarity to form a stable duplex, or, for example, in the case of an antisense nucleic acid molecule which binds to DNA duplexes, through specific interactions in the major groove of the double helix. An example of a route of administration of an antisense nucleic acid molecule of the invention includes direct injection at a tissue site. Alternatively, an antisense nucleic acid molecule can be modified to target selected cells and then administered systemically. For example, for systemic administration, an antisense molecule can be modified such that it specifically binds to a receptor or an antigen expressed on a selected cell surface, e.g., by linking the antisense nucleic acid molecule to a peptide or an antibody which binds to a cell surface receptor or antigen. The antisense nucleic acid molecule can also be delivered to cells using the vectors described herein. To achieve sufficient intracellular concentrations of antisense molecules, vector constructs in which the antisense nucleic acid molecule is placed under the control of a strong pol II or po III promoter are preferred.

In yet another embodiment, an antisense nucleic acid molecule of the invention is an α-anomeric nucleic acid molecule. An α-anomeric nucleic acid molecule forms specific double-stranded hybrids with complementary RNA in which, contrary to the usual β-units, the strands run parallel to each other (Gaultieret al. (1987) Nucleic Acids. Res. 15:6625-6641; incorporated herein by reference). The antisense nucleic acid molecule can also comprise a 2′-o-methylribonucleotide (Inoue et al. (1987) Nucleic Acids Res. 15:6131-6148; incorporated herein by reference) or a chimeric RNA-DNA analogue (Inoue et al. (1987) FEBS Lett. 215:327-330; incorporated herein by reference).

In still another embodiment, an antisense nucleic acid molecule of the invention is a ribozyme. Ribozymes are catalytic RNA molecules with ribonuclease activity which are capable of cleaving a single-stranded nucleic acid, such as an mRNA, to which they have a complementary region. Thus, ribozymes (e.g., hammerhead ribozymes (described in Haselhoff and Gerlach (1988) Nature 334:585-591; incorporated herein by reference)) can be used to catalytically cleave mRNA transcripts to thereby inhibit translation mRNAs. A ribozyme having specificity e.g., for an XBP-1, IRE-1, or ATF6α-encoding nucleic acid can be designed based upon the nucleotide sequence of the cDNA. For example, a derivative of a Tetrahymena L-19 IVS RNA can be constructed in which the nucleotide sequence of the active site is complementary to the nucleotide sequence to be cleaved in, e.g., an XBP-1, IRE-1, or ATF6α-encoding mRNA. See, e.g., Cech et al. U.S. Pat. No.4,987,071; Cech et al. U.S. Pat. No. 5,116,742; each of which is incorporated herein by reference. Alternatively, XBP-1 (or, e.g., IRE-1, ATF6α) mRNA can be used to select a catalytic RNA having a specific ribonuclease activity from a pool of RNA molecules. See, e.g., Bartel, D. and Szostak, J. W. (1993) Science 261:1411-1418; incorporated herein by reference.

Alternatively, gene expression can be inhibited by targeting nucleotide sequences complementary to the regulatory region of a gene (e.g., an XBP-1, IRE-1, or ATF6α promoter and/or enhancer) to form triple helical structures that prevent transcription of a gene in target cells. See generally, Helene, C. (1991) Anticancer Drug Des. 6(6):569-84; Helene, C. et al. (1992) Ann. N.Y Acad. Sci. 660:27-36; Maher (1992) Bioassays 14(12):807-15; each of which is incorporated herein by reference.

In another embodiment, a compound that promotes RNAi can be used to inhibit expression of XBP-1 or a molecule in a signal transduction pathway involving XBP-1. RNA interference (RNAi is a post-transcriptional, targeted gene-silencing technique that uses double-stranded RNA (dsRNA) to degrade messenger RNA (mRNA) containing the same sequence as the dsRNA (Sharp, P. A. and Zamore, P. D. 287, 2431-2432 (2000); Zamore et al. Cell 101, 25-33 (2000). Tuschl et al. Genes Dev. 13, 3191-3197 (1999); Cottrell T R, and Doering T L. 2003. Trends Microbiol. 11:37-43; Bushman F.2003. Mol Therapy. 7:9-10; McManus M T and Sharp P A. 2002. Nat. Rev. Genet. 3:737-47; each of which is incorporated herein by reference). The process occurs when an endogenous ribonuclease cleaves the longer dsRNA into shorter, e.g., 21- or 22-nucleotide-long RNAs, termed small interfering RNAs or siRNAs. The smaller RNA segments then mediate the degradation of the target mRNA. Kits for synthesis of RNAi are commercially available from, e.g. New England Biolabsor Ambion. In one embodiment one or more of the chemistries described above for use in antisense RNA can be employed in molecules that mediate RNAi. A working example of XBP-1 specific RNAi in which an XBP-1-specific RNAi vector was constructed by inserting two complementary oligonucleotides for 5′-GGGATTCATGAATGGCCCTTA-3′ (SEQ ID NO: 9) into the pBS/U6 vector.

Exemplary siRNA molecules specific for the unspliced form of murine XBP-1 are shown below:

Beginning at position 711:

| | | |
|---|---|---|
| Sense strand | GUUGGACCCUGUCAUGUUUtt | (SEQ ID NO.:32) |
| siRNA: | | |
| Antisense | AAACAUGACAGGGUCCAACtt | (SEQ ID NO.:33) |
| strand siRNA: | | |

Beginning at position 853:

| | | |
|---|---|---|
| Sense strand | GCCAUUAAUGAACUCAUUCtt | (SEQ ID NO.:34) |
| sIRNA: | | |
| Antisense | GAAUGAGUUCAUUAAUGGCtt | (SEQ ID NO.:35) |
| strand siRNA: | | |

Exemplary siRNA molecules specific for the spliced form of murine XBP-1 are shown below:

Beginning at position 746:

| | | |
|---|---|---|
| Sense strand | GAAGAGAACCACAAACUCCUU | (SEQ ID NO.:36) |
| siRNA: | | |
| Antisense | GGAGUUUGUGGUUCUCUUCUU | (SEQ ID NO.:37) |
| strand siRNA: | | |

Beginning at position 1307:

| | | |
|---|---|---|
| Sense strand | GAGGAUCACCCUGAAUUCAUU | (SEQ ID NO.:38) |
| siRNA: | | |
| Antisense | UGAAUUCAGGGUGAUCCUCUU | (SEQ ID NO.:39) |
| strand siRNA: | | |

Exemplary siRNA molecules specific for the unspliced form of human XBP-1 are shown below:

Beginning at position 729:

| | | |
|---|---|---|
| Sense strand | CUUGGACCCAGUCAUGUUCUU | (SEQ ID NO.:44) |
| siRNA: | | |
| Antisense | GAACAUGACUGGGUCCAAGUU | (SEQ ID NO.:45) |
| strand siRNA: | | |

Beginning at position 1079:

| | | |
|---|---|---|
| Sense strand | AUCUGCUUUCAUCCAGCCAUU | (SEQ ID NO.:46) |
| siRNA: | | |
| Antisense | UGGCUGGAUGAAAGCAGAUUU | (SEQ ID NO.:47) |
| strand siRNA: | | |

Exemplary siRNA molecules specific for the spliced form of human XBP-1 are shown below:

Beginning at position 884:

| | | |
|---|---|---|
| Sense strand | GCCCCUAGUCUUAGAGAUAUU | (SEQ ID NO.:48) |
| siRNA: | | |
| Antisense | UAUCUCUAAGACUAGGGGCUU | (SEQ ID NO.:49) |
| strand siRNA: | | |

Beginning at position 1108:

| | | |
|---|---|---|
| Sense strand | GAACCUGUAGAAGAUGAGCUU | (SEQ ID NO.:50) |
| siRNA: | | |
| Antisense | GGUCAUCUUCUACAGGUUCUU | (SEQ ID NO.:51) |
| strand siRNA: | | |

ii. Intracellular Antibodies

Another type of inhibitory compound that can be used to inhibit the expression and/or activity of XBP-1 or a molecule in a signal transduction pathway involving XBP-1 is an intracellular antibody specific for, e.g., XBP-1 (e.g., specific for unspliced XBP-1), IRE-1, or ATF6α or another molecule in the pathway as discussed herein. In one embodiment, an antibody binds to both spliced and unspliced XBP-1. In another embodiment, an antibody is specific for spliced XBP-1, i.e., recognizes an epitope present in ORF2. The use of intracellular antibodies to inhibit protein function in a cell is known in the art (see e.g., Carlson, J. R. (1988) Mol. Cell. Biol. 8:2638-2646; Biocca, S. etal. (1990) EMBO J. 9:101-108; Werge, T. M. et al. (1990) FEBS Letters 274:193-198; Carlson, J. R. (1993) Proc. Natl. Acad. Sci. USA 90:7427-7428; Marasco, W. A. et al. (1993) Proc. Natl. Acad. Sci. USA 90:7889-7893; Biocca, S. et al. (1994) Bio/Technology 12:396-399; Chen, S-Y. et al. (1994) Human Gene Therapy 5:595-601; Duan, Let al. (1994) Proc. Natl. Acad. Sci. USA 91:5075-5079; Chen, S-Y. etal. (1994) Proc. Natl. Acad. Sci. USA 91:5932-5936; Beerli, R. R. et al. (1994) J. Biol. Chem. 269:23931-23936; Beerli, R. R. et al. (1994) Biochem. Biophys. Res. Commun. 204:666-672; Mhashilkar, A. M. et al. (1995) EMBO J. 14:1542-1551; Richardson, J. H. et al. (1995) Proc. Natl. Acad. Sci. USA 92:3137-3141; PCT Publication No. WO 94/02610 by Marasco et al.; PCT Publication No. WO 95/03832 by Duan et al.; each of which is incorporated herein by reference).

To inhibit protein activity using an intracellular antibody, a recombinant expression vector is prepared which encodes the antibody chains in a form such that, upon introduction of the vector into a cell, the antibody chains are expressed as a functional antibody in an intracellular compartment of the cell. For inhibition of transcription factor activity according to the inhibitory methods of the invention, preferably an intracellular antibody that specifically binds the protein is expressed within the nucleus of the cell. Nuclear expression of an intracellular antibody can be accomplished by removing from the antibody light and heavy chain genes those nucleotide sequences that encode the N-terminal hydrophobic leader sequences and adding nucleotide sequences encoding a nuclear localization signal at either the N- or C-terminus of the light and heavy chain genes (see e.g., Biocca et al. (1990) EMBO J. 9:101-108; Mhashilkar et al. (1995) EMBO J. 14:1542-1551; each of which is incorporated herein by reference). A preferred nuclear localization signal to be used for nuclear targeting of the intracellular antibody chains is the nuclear localization signal of SV40 Large T antigen (see Biocca et al. (1990) EMBO J. 9:101-108; Mhashilkar et al. (1995) EMBO J. 14:1542-1551; each of which is incorporated herein by reference).

To prepare an intracellular antibody expression vector, antibody light and heavy chain cDNAs encoding antibody chains specific for the target protein of interest, e.g., XBP-1, IRE-1, or ATF6α protein, is isolated, typically from a hybridoma that secretes a monoclonal antibody specific for the protein. Antibodies can be prepared by immunizing a suitable subject, (e.g., rabbit, goat, mouse or other mammal), e.g., with an XBP-1, IRE-1, or ATF6α protein immunogen. An appropriate immunogenic preparation can contain, for example, recombinantly expressed protein or a chemically synthesized peptide. The preparation can further include an adjuvant, such as Freund's complete or incomplete adjuvant, or similar immunostimulatory compound. Antibody-producing cells can be obtained from the subject and used to prepare monoclonal antibodies by standard techniques, such as the hybridoma technique originally described by Kohler and Milstein (1975, Nature 256:495-497; incorporated herein by reference) (see also, Brown et al. (1981) J. Immunol 127:539-46; Brown et al. (1980) J Biol Chem 255:4980-83; Yeh et al. (1976) PNAS 76:2927-31; Yeh et al. (1982) Int. J. Cancer 29:269-75; each of which is incorporated herein by reference). The technology for producing monoclonal antibody hybridomas is well known (see generally R. H. Kenneth, in Monoclonal Antibodies: A New Dimension In Biological Analyses, Plenum Publishing Corp., New York, N.Y. (1980); E. A. Lerner (1981) Yale J. Biol. Med., 54:387-402; M. L. Gefter et al. (1977) Somatic Cell Genet., 3:231-36; each of which is incorporated herein by reference). Briefly, an immortal cell line (typically a myeloma) is fused to lymphocytes (typically splenocytes) from a mammal immunized with a protein immunogen as described above, and the culture supernatants of the resulting hybridoma cells are screened to identify a hybridoma producing a monoclonal antibody that binds specifically, e.g., to the XBP-1, IRE-1, or ATF6α protein. Any of the many well known protocols used for fusing lymphocytes and immortalized cell lines can be applied for the purpose of generating a monoclonal antibody (see, e.g., G. Galfre et al. (1977) Nature 266:550-52; Gefter et al. Somatic Cell Genet., cited supra; Lerner, Yale J. Biol. Med., cited supra; Kenneth, Monoclonal Antibodies, cited supra; each of which is incorporated herein by reference). Moreover, the ordinary skilled artisan will appreciate that there are many variations of such methods which also would be useful. Typically, the immortal cell line (e.g., a myeloma cell line) is derived from the same mammalian species as the lymphocytes. For example, murine hybridomas can be made by fusing lymphocytes from a mouse immunized with an immunogenic preparation of the present invention with an immortalized mouse cell line. Preferred immortal cell lines are mouse myeloma cell lines that are sensitive to culture medium containing hypoxanthine, aminopterin and thymidine (“HAT medium”). Any of a number of myeloma cell lines can be used as a fusion partner according to standard techniques, e.g., the P3-NS1/1-Ag4-1, P3-x63-Ag8.653 or Sp2/O-Ag14 myeloma lines. These myeloma lines are available from the American Type Culture Collection (ATCC), Rockville, Md. Typically, HAT-sensitive mouse myeloma cells are fused to mouse splenocytes using polyethylene glycol (“PEG”). Hybridoma cells resulting from the fusion are then selected using HAT medium, which kills unfused and unproductively fused myeloma cells (unfused splenocytes die after several days because they are not transformed). Hybridoma cells producing a monoclonal antibody that specifically binds the protein are identified by screening the hybridoma culture supernatants for such antibodies, e.g., using a standard ELISA assay.

Alternative to preparing monoclonal antibody-secreting hybridomas, a monoclonal antibody that binds to a protein can be identified and isolated by screening a recombinant combinatorial immunoglobulin library (e.g., an antibody phage display library) with the protein, or a peptide thereof, to thereby isolate immunoglobulin library members that bind specifically to the protein. Kits for generating and screening phage display libraries are commercially available (e.g., the Pharmacia Recombinant Phage Antibody System, Catalog No. 27-9400-01; and the Stratagene SurfZAP™ Phage Display Kit, Catalog No. 240612; each of which is incorporated herein by reference). Additionally, examples of methods and compounds particularly amenable for use in generating and screening antibody display library can be found in, for example, Ladner et al. U.S. Pat. No. 5,223,409; Kang et al. International Publication No. WO 92/18619; Dower et al. International Publication No. WO 91/17271; Winter et al. International Publication WO 92/20791; Markland et al. International Publication No. WO 92/15679; Breitling et al. International Publication WO 93/01288; McCafferty et al. International Publication No. WO 92/01047; Garrard et al. International Publication No. WO 92/09690; Fuchs et al. (1991) Bio/Technology 9:1370-1372; Hay et al. (1992) Hum Antibod Hybridomas 3:81-85; Huse et al. (1989) Science 246:1275-1281; Griffiths et al. (1993) EMBO J 12:725-734; Hawkins et al. (1992) J Mol Biol 226:889-896; Clarkson et al. (1991) Nature 352:624-628; Gram et al. (1992) PNAS 89:3576-3580; Garrad et al. (1991) Bio/Technology 9:1373-1377; Hoogenboom et al. (1991) Nuc Acid Res 19:4133-4137; Barbas et al. (1991) PNAS 88:7978-7982; McCafferty et al. Nature (1990) 348:552-554; each of which is incorporated herein by reference.

In another embodiment, ribosomal display can be used to replace bacteriophage as the display platform (see, e.g., Hanes et al. 2000. Nat. Biotechnol. 18:1287; Wilson et al. 2001. Proc. Natl. Acad. Sci. USA 98:3750; Irving et al. 2001 J. Immunol. Methods 248:31; each of which is incorporated herein by reference). In yet another embodiment, cell surface libraries can be screened for antibodies (Boder et al. 2000. Proc. Natl. Acad Sci. USA 97:10701; Daugherty etal. 2000 J. Immunol. Methods 243:211; each of which is incorporated herein by reference). Such procedures provide alternatives to traditional hybridoma techniques for the isolation and subsequent cloning of monoclonal antibodies.

Yet other embodiments of the present invention comprise the generation of substantially human antibodies in transgenic animals (e.g., mice) that are incapable of endogenous immunoglobulin production (see e.g., U.S. Pat. Nos. 6,075,181, 5,939,598, 5,591,669 and 5,589,369 each of which is incorporated herein by reference). For example, it has been described that the homozygous deletion of the antibody heavy-chain joining region in chimeric and germ-line mutant mice results in complete inhibition of endogenous antibody production. Transfer of a human immunoglobulin gene array to such germ line mutant mice will result in the production of human antibodies upon antigen challenge. Another preferred means of generating human antibodies using SCID mice is disclosed in U.S. Pat. No. 5,811,524 which is incorporated herein by reference. It will be appreciated that the genetic material associated with these human antibodies can also be isolated and manipulated as described herein.

Yet another highly efficient means for generating recombinant antibodies is disclosed by Newman, Biotechnology, 10: 1455-1460 (1992); incorporated herein by reference. Specifically, this technique results in the generation of primatized antibodies that contain monkey variable domains and human constant sequences. This reference is incorporated by reference in its entirety herein. Moreover, this technique is also described in U.S. Pat. Nos. 5,658,570, 5,693,780 and 5,756,096; each of which is incorporated herein by reference.

Once a monoclonal antibody of has been identified (e.g., either a hybridoma-derived monoclonal antibody or a recombinant antibody from a combinatorial library, including monoclonal antibodies that are already known in the art), DNAs encoding the light and heavy chains of the monoclonal antibody are isolated by standard molecular biology techniques. For hybridoma derived antibodies, light and heavy chain cDNAs can be obtained, for example, by PCR amplification or cDNA library screening. For recombinant antibodies, such as from a phage display library, cDNA encoding the light and heavy chains can be recovered from the display package (e.g., phage) isolated during the library screening process. Nucleotide sequences of antibody light and heavy chain genes from which PCR primers or cDNA library probes can be prepared are known in the art. For example, many such sequences are disclosed in Kabat, E. A., et al. (1991) Sequences of Proteins of Immunological Interest, Fifth Edition, U.S. Department of Health and Human Services, NIH Publication No. 91-3242 and in the “Vbase” human germline sequence database.

Once obtained, the antibody light and heavy chain sequences are cloned into a recombinant expression vector using standard methods. As discussed above, the sequences encoding the hydrophobic leaders of the light and heavy chains are removed and sequences encoding a nuclear localization signal (e.g., from SV40 Large T antigen) are linked in-frame to sequences encoding either the amino- or carboxy terminus of both the light and heavy chains. The expression vector can encode an intracellular antibody in one of several different forms. For example, in one embodiment, the vector encodes full-length antibody light and heavy chains such that a full-length antibody is expressed intracellularly. In another embodiment, the vector encodes a full-length light chain but only the VH/CH I region of the heavy chain such that a Fab fragment is expressed intracellularly. In the most preferred embodiment, the vector encodes a single chain antibody (scFv) wherein the variable regions of the light and heavy chains are linked by a flexible peptide linker (e.g., (Gly₄Ser)₃) and expressed as a single chain molecule. To inhibit transcription factor activity in a cell, the expression vector encoding, e.g., the XBP-1, IRE-1, or ATF6α-specific intracellular antibody is introduced into the cell by standard transfection methods as described hereinbefore.

iii. Peptidic Compounds

In another embodiment, an inhibitory compound of the invention is a peptidic compound derived from the XBP-1 amino acid sequence or the amino acid sequence of a molecule in a signal transduction pathway involving XBP-1 ( e.g., IRE-], or ATF6α). For example, in one embodiment, the inhibitory compound comprises a portion of, e.g., XBP-I, IRE-1, or ATF6α (or a mimetic thereof) that mediates interaction of XBP-1, IRE-1, or ATF6α with a target molecule such that contact of XBP-1, IRE-1, or ATF6α with this peptidic compound competitively inhibits the interaction of XBP-1, IRE-1, or ATF6α with the target molecule.

The peptidic compounds of the invention can be made intracellularly in cells by introducing into the cells an expression vector encoding the peptide. Such expression vectors can be made by standard techniques using oligonucleotides that encode the amino acid sequence of the peptidic compound. The peptide can be expressed in intracellularly as a fusion with another protein or peptide (e.g., a GST fusion). Alternative to recombinant synthesis of the peptides in the cells, the peptides can be made by chemical synthesis using standard peptide synthesis techniques. Synthesized peptides can then be introduced into cells by a variety of means known in the art for introducing peptides into cells (e.g., liposome and the like).

In addition, dominant negative proteins (e.g., of XBP-1, IRE-1, or ATF6α) can be made which include XBP-1, IRE-1, or ATF6α molecules (e.g., portions or variants thereof) that compete with native (i.e., wild-type) molecules, but which do not have the same biological activity. Such molecules effectively decrease, e.g., XBP-1, IRE-1, or ATF6α activity in a cell. For example, the peptide compound can be lacking part of an XBP-1 transcriptional activation domain, e.g., can consist of the portion of the N-terminal 136 or 188 amino acids of the spliced form of XBP-1.

Other Agents that Act Upstream of XBP-1

In one embodiment, the expression of spliced XBP-1 can be inhibited using an agent that inhibits a signal that increases XBP-1 expression, processing, post-translational modification or activity in a cell. Both IL4 and IL-6 have been shown to increase transcription of XBP-1 (Wen et al. 1999. Int. Journal of Oncology 15:173, incorporated herein by reference). Accordingly, in one embodiment, an agent that inhibits a signal transduced by IL-4 or IL-6 can be used to downmodulate XBP-1 expression and, thereby, decrease the activity of spliced XBP-1 in a cell. For example, in one embodiment, an agent that inhibits a STAT-6 dependent signal can be used to decrease the expression of XBP-1 in a cell.

Other inhibitory agents that can be used to specifically inhibit the activity of an XBP-1 or a molecule in a signal transduction pathway involving XBP-1 are chemical compounds that directly inhibit expression, processing, post-translational modification, and/or activity of, e.g., an XBP-1, IRE-1, or ATF6α target protein activity or inhibit the interaction between, e.g., XBP-1, IRE-1, or ATF6α and target molecules. Such compounds can be identified using screening assays that select for such compounds, as described in detail above as well as using other art recognized techniques.

The methods of modulating XBP-1 signaling (e.g., by modulating the expression and/or activity of XBP-1 or the expression and/or activity of another molecule in a signal transduction pathway involving XBP-1 can be practiced either in vitro or in vivo. For practicing the method in vitro, cells can be obtained from a subject by standard methods and incubated (i.e., cultured) in vitro with a stimulatory or inhibitory compound of the invention to stimulate or inhibit, respectively, the activity of XBP-1. Methods for isolating cells are known in the art.

Cells treated in vitro with either a stimulatory or inhibitory compound can be administered to a subject to influence the biological effects of XBP-1 signaling. For example, cells can be isolated from a subject, expanded in number in vitro and the activity of, e.g., spliced XBP-1, IRE-1, or ATF6α activity in the cells using a stimulatory agent, and then the cells can be readministered to the same subject, or another subject tissue compatible with the donor of the cells. Accordingly, in another embodiment, the modulatory method of the invention comprises culturing cells in vitro with e.g., an XBP-1 modulator or a modulator of a molecule in a signal transduction pathway involving XBP-1 and further comprises administering the cells to a subject. For administration of cells to a subject, it may be preferable to first remove residual compounds in the culture from the cells before administering them to the subject. This can be done for example by gradient centrifugation of the cells or by washing of the tissue. For further discussion of ex vivo genetic modification of cells followed by readministration to a subject, see also U.S. Pat. No. 5,399,346 by W. F. Anderson et al.; incorporated herein by reference.

In other embodiments, a stimulatory or inhibitory compound is administered to a subject in vivo. Such methods can be used to treat disorders, e.g., as detailed below and/or to increase production of a protein in vivo. For stimulatory or inhibitory agents that comprise nucleic acids (e.g., recombinant expression vectors encoding, e.g., XBP-1, IRE-1, or ATF6α; antisense RNA; intracellular antibodies; or e.g., XBP-1, IRE-1, or ATF6α-derived peptides), the compounds can be introduced into cells of a subject using methods known in the art for introducing nucleic acid (e.g., DNA) into cells in vivo. Examples of such methods include:

Direct Injection: Naked DNA can be introduced into cells in vivo by directly injecting the DNA into the cells (see e.g., Acsadi et al. (1991) Nature 332:815-818; Wolff et al. (1990) Science 247:1465-1468; each of which is incorporated herein by reference). For example, a delivery apparatus (e.g., a “gene gun”) for injecting DNA into cells in vivo can be used. Such an apparatus is commercially available (e.g., from BioRad).

Receptor-Mediated DNA Uptake: Naked DNA can also be introduced into cells in vivo by complexing the DNA to a cation, such as polylysine, which is coupled to a ligand for a cell-surface receptor (see for example Wu, G. and Wu, C. H. (1988) J. Biol. Chem. 263:14621; Wilson etal. (1992) J. Biol. Chem. 267:963-967; U.S. Pat. No. 5,166,320; each of which is incorporated herein by reference). Binding of the DNA-ligand complex to the receptor facilitates uptake of the DNA by receptor-mediated endocytosis. A DNA-ligand complex linked to adenovirus capsids which naturally disrupt endosomes, thereby releasing material into the cytoplasm can be used to avoid degradation of the complex by intracellular lysosomes (see for example Curiel et al. (1991) Proc. Natl. Acad. Sci. USA 88:8850; Cristiano et al. (1993) Proc. Natl. Acad. Sci. USA 90:2122-2126; each of which is incorporated herein by reference).

Retroviruses: Defective retroviruses are well characterized for use in gene transfer for gene therapy purposes (for a review see Miller, (1990) Blood 76:271; incorporated herein by reference). A recombinant retrovirus can be constructed having a nucleotide sequences of interest incorporated into the retroviral genome. Additionally, portions of the retroviral genome can be removed to render the retrovirus replication defective. The replication defective retrovirus is then packaged into virions which can be used to infect a target cell through the use of a helper virus by standard techniques. Protocols for producing recombinant retroviruses and for infecting cells in vitro or in vivo with such viruses can be found in Current Protocols in Molecular Biology, Ausubel, F. M. et al. (eds.) Greene Publishing Associates, (1989), Sections 9.10-9.14 and other standard laboratory manuals. Examples of suitable retroviruses include pLJ, pZIP, pWE and pEM which are well known to those skilled in the art. Examples of suitable packaging virus lines include ψCrip, ψCre, ψ2 and ψAm. Retroviruses have been used to introduce a variety of genes into many different cell types, including epithelial cells, endothelial cells, lymphocytes, myoblasts, hepatocytes, bone marrow cells, in vitro and/or in vivo (see for example Eglitis, et al. (1985) Science 230:1395-1398; Danos and Mulligan (1988) Proc. Nall. Acad. Sci. USA 85:6460-6464; Wilson et al. (1988) Proc. Natl. Acad. Sci. USA 85:3014-3018; Armentano et al. (1990) Proc. Natl. Acad. Sci. USA 87:6141-6145; Huber et al. (1991) Proc. Natl. Acad. Sci. USA 88:8039-8043; Ferry et al. (1991) Proc. Natl. Acad. Sci. USA 88:8377-8381; Chowdhury et al. (1991) Science 254:1802-1805; van Beusechem et al. (1992) Proc. Natl. Acad. Sci. USA 89:7640-7644; Kay et al. (1992) Human Gene Therapy 3:641-647; Dai el al. (1992) Proc. Natl. Acad. Sci. USA 89:10892-10895; Hwu et al. (1993) J. Immunol. 150:4104-4115; U.S. Pat. Nos. 4,868,116; 4,980,286; PCT Application WO 89/07136; PCT Application WO 89/02468; PCT Application WO 89/05345; PCT Application WO 92/07573; each of which is incorporated herein by reference). Retroviral vectors require target cell division in order for the retroviral genome (and foreign nucleic acid inserted into it) to be integrated into the host genome to stably introduce nucleic acid into the cell. Thus, it may be necessary to stimulate replication of the target cell.

Adenoviruses: The genome of an adenovirus can be manipulated such that it encodes and expresses a gene product of interest but is inactivated in terms of its ability to replicate in a normal lytic viral life cycle. See for example Berkner et al. (1988) BioTechniques 6:616; Rosenfeld et al. (1991) Science 252:431-434; Rosenfeld et al. (1992) Cell 68:143-155; each of which is incorporated herein by reference. Suitable adenoviral vectors derived from the adenovirus strain Ad type 5 dl324 or other strains of adenovirus (e.g., Ad2, Ad3, Ad7, etc.) are well known to those skilled in the art. Recombinant adenoviruses are advantageous in that they do not require dividing cells to be effective gene delivery vehicles and can be used to infect a wide variety of cell types, including airway epithelium (Rosenfeld et al. (1992) cited supra), endothelial cells (Lemarchand et al. (1992) Proc. Natl. Acad. Sci. USA 89:6482-6486; incorporated herein by reference), hepatocytes (Herz and Gerard (1993) Proc. Natl. Acad Sci. USA 90:2812-2816; incorporated herein by reference) and muscle cells (Quantin et al. (1992) Proc. Natl. Acad. Sci. USA 89:2581-2584; incorporated herein by reference). Additionally, introduced adenoviral DNA (and foreign DNA contained therein) is not integrated into the genome of a host cell but remains episomal, thereby avoiding potential problems that can occur as a result of insertional mutagenesis in situations where introduced DNA becomes integrated into the host genome (e.g., retroviral DNA). Moreover, the carrying capacity of the adenoviral genome for foreign DNA is large (up to 8 kilobases) relative to other gene delivery vectors (Berlner et al. cited supra; Haj-Ahmand and Graham (1986) J. Virol. 57:267; each of which is incorporated herein by reference). Most replication-defective adenoviral vectors currently in use are deleted for all or parts of the viral E1 and E3 genes but retain as much as 80% of the adenoviral genetic material.

Adeno-Associated Viruses: Adeno-associated virus (AAV) is a naturally occurring defective virus that requires another virus, such as an adenovirus or a herpes virus, as a helper virus for efficient replication and a productive life cycle. (For a review see Muzyczka et al. Curr. Topics in Micro. and Immunol. (1992) 158:97-129; incorporated herein by reference). It is also one of the few viruses that may integrate its DNA into non-dividing cells, and exhibits a high frequency of stable integration (see for example Flotte et al. (1992) Am. J. Respir. Cell. Mol. Biol. 7:349-356; Samulski et al. (1989) J. Virol. 63:3822-3828; McLaughlin et al. (1989) J. Virol. 62:1963-1973; each of which is incorporated herein by reference). Vectors containing as little as 300 base pairs of AAV can be packaged and can integrate. Space for exogenous DNA is limited to about 4.5 kb. An AAV vector such as that described in Tratschin et al. (1985) Mol. Cell. Biol. 5:3251-3260, incorporated herein by reference, can be used to introduce DNA into cells. A variety of nucleic acids have been introduced into different cell types using AAV vectors (see for example Hermonat et al. (1984) Proc. Natl. Acad. Sci. USA 81:6466-6470; Tratschin et al. (1985) Mol. Cell. Biol. 4:2072-2081; Wondisford et al. (1988) Mol. Endocrinol. 2:32-39; Tratschin et al. (1984) J. Virol. 51:611-619; Flotte et al. (1993) J. Biol. Chem. 268:3781-3790; each of which is incorporated herein by reference).

The efficacy of a particular expression vector system and method of introducing nucleic acid into a cell can be assessed by standard approaches routinely used in the art. For example, DNA introduced into a cell can be detected by a filter hybridization technique (e.g., Southern blotting) and RNA produced by transcription of introduced DNA can be detected, for example, by Northern blotting, RNase protection or reverse transcriptase-polymerase chain reaction (RT-PCR). The gene product can be detected by an appropriate assay, for example by immunological detection of a produced protein, such as with a specific antibody, or by a functional assay to detect a functional activity of the gene product, such as an enzymatic assay.

In one embodiment, if the stimulatory or inhibitory compounds can be administered to a subject as a pharmaceutical composition. In one embodiment, the invention is directed to an active compound (e.g., a modulator of XBP-1 or a molecule in a signal transduction pathway involving XBP-1) and a carrier. Such compositions typically comprise the stimulatory or inhibitory compounds, e.g., as described herein or as identified in a screening assay, e.g., as described herein, and a pharmaceutically acceptable carrier. Pharmaceutically acceptable carriers and methods of administration to a subject are described herein.

In one embodiment, the active compounds of the invention are administered in combination with other agents. For example, in one embodiment, an active compound of the invention, e.g., a compound that modulates an XBP-1 signal transduction pathway (e.g., by directly modulating XBP-1 activity) is administered with another compound known in the art to be useful in treatment of a particular condition or disease. For example, in one embodiment, for the treatment of a metabolic disorder, an active compound of the invention can be administered in combination with a known modulator of the metabolic disorder.

V. Diagnostic Assays

In another aspect, the invention features a method of diagnosing a subject for a disorder associated with aberrant biological activity or XBP-1 (e.g., that would benefit from modulation of a metabolic condition).

In one embodiment, the invention comprises identifying the subject as one that would benefit from modulation of an XBP-1 activity, e.g., modulation of the UPR. For example, in one embodiment, expression of XBP-1 or a molecule in a signal transduction pathway involving XBP-1 can be detected in cells of a subject suspected of having a disorder associated with aberrant biological activity of XBP-1. The expression of XBP-1 or a molecule in a signal transduction pathway involving XBP-1 in cells of said subject could then be compared to a control and a difference in expression of XBP-1 or a molecule in a signal transduction pathway involving XBP-1 in cells of the subject as compared to the control could be used to diagnose the subject as one that would benefit from modulation of an XBP-1 activity.

The “change in expression” or “difference in expression” of XBP-1 or a molecule in a signal transduction pathway involving XBP-1 in cells of the subject can be, for example, a change in the level of expression of XBP-1 or a molecule in a signal transduction pathway involving XBP-1 in cells of the subject as compared to a previous sample taken from the subject or as compared to a control, which can be detected by assaying levels of, e.g., XBP-1 mRNA, for example, by isolating cells from the subject and determining the level of XBP-1 mRNA expression in the cells by standard methods known in the art, including Northern blot analysis, microarray analysis, reverse-transcriptase PCR analysis and in situ hybridizations. For example, a biological specimen can be obtained from the patient and assayed for, e.g., expression or activity of XBP-1 or a molecule in a signal transduction pathway involving XBP-1. For instance, a PCR assay could be used to measure the level of spliced XBP-1 in a cell of the subject. For instance, PCR primers (5′-ACACGCTFGGGAATGGACAC-3′ (SEQ ID NO.:40) and 5′-CCATGGGAAGATGTTCTGGG-3′ (SEQ ID NO.:41)) that encompass the missing sequences in XBP-1s can be used to identify spliced XBP-1. A level of spliced XBP-1 higher or lower than that seen in a control or higher or lower than that previously observed in the patient indicates that the patient would benefit from modulation of a signal transduction pathway involving XPB-1. Alternatively, the level of expression of XBP-1 or a molecule in a signal transduction pathway involving XBP-1 in cells of the subject can be detected by assaying levels of, e.g., XBP-1, for example, by isolating cells from the subject and determining the level of XBP-1 or a molecule in a signal transduction pathway involving XBP-1 protein expression by standard methods known in the art, including Western blot analysis, immunoprecipitations, enzyme linked immunosorbent assays (ELISAs) and immunofluorescence. Antibodies for use in such assays can be made using techniques known in the art and/or as described herein for making intracellular antibodies.

In another embodiment, a change in expression of XBP-1 or a molecule in a signal transduction pathway involving XBP-1 in cells of the subject results from one or more mutations (i.e., alterations from wildtype), e.g., the XBP-1 gene and mRNA leading to one or more mutations (i.e., alterations from wildtype) in the amino acid sequence of the protein. In one embodiment, the mutation(s) leads to a form of the molecule with increased activity (e.g., partial or complete constitutive activity). In another embodiment, the mutation(s) leads to a form of the molecule with decreased activity (e.g., partial or complete inactivity). The mutation(s) may change the level of expression of the molecule for example, increasing or decreasing the level of expression of the molecule in a subject with a disorder. Alternatively, the mutation(s) may change the regulation of the protein, for example, by modulating the interaction of the mutant protein with one or more targets e.g., resulting in a form of XBP-1 that cannot be spliced. Mutations in the nucleotide sequence or amino acid sequences of proteins can be determined using standard techniques for analysis of DNA or protein sequences, for example for DNA or protein sequencing, RFLP analysis, and analysis of single nucleotide or amino acid polymorphisms. For example, in one embodiment, mutations can be detected using highly sensitive PCR approaches using specific primers flanking the nucleic acid sequence of interest. In one embodiment, detection of the alteration involves the use of a probe/primer in a polymerase chain reaction (PCR) (see, e.g., U.S. Pat. Nos. 4,683,195 and 4,683,202; each of which is incorporated herein by reference), such as anchor PCR or RACE PCR, or, alternatively, in a ligation chain reaction (LCR) (see, e.g., Landegran et al. (1988) Science 241:1077-1080; Nakazawa et al. (1994) PNAS 91:360-364; each of which is incorporated herein by reference). This method can include the steps of collecting a sample of cells from a patient, isolating nucleic acid (e.g., genomic, DNA) from the cells of the sample, contacting the nucleic acid sample with one or more primers which specifically amplify a sequence under conditions such that hybridization and amplification of the sequence (if present) occurs, and detecting the presence or absence of an amplification product, or detecting the size of the amplification product and comparing the length to a control sample.

In one embodiment, the complete nucleotide sequence for XBP-1 or a molecule in a signal transduction pathway involving XBP-1 can be determined. Particular techniques have been developed for determining actual sequences in order to study polymorphism in human genes. See, for example, Proc. Natl. Acad. Sci. U.S.A. 85, 544-548 (1988) and Nature 330, 384-386 (1987); Maxim and Gilbert. 1977. PNAS 74:560; Sanger 1977. PNAS 74:5463; each of which is incorporated herein by reference. In addition, any of a variety of automated sequencing procedures can be utilized when performing diagnostic assays ((1995) Biotechniques 19:448), including sequencing by mass spectrometry (see, e.g., PCT International Publication No. WO 94/16101; Cohen et al. (1996) Adv. Chromatogr. 36:127-162; Griffin etal. (1993) Appl. Biochem. Biotechnol. 38:147-159; each of which is incorporated herein by reference).

Restriction fragment length polymorphism mappings (RFLPS) are based on changes at a restriction enzyme site. In one embodiment, polymorphisms from a sample cell can be identified by alterations in restriction enzyme cleavage patterns. For example, sample and control DNA is isolated, amplified (optionally), digested with one or more restriction endonucleases, and fragment length sizes are determined by gel electrophoresis and compared. Moreover, the use of sequence specific ribozymes (see, for example, U.S. Pat. No. 5,498,531) can be used to score for the presence of a specific ribozyme cleavage site.

Another technique for detecting specific polymorphisms in particular DNA segment involves hybridizing DNA segments which are being analyzed (target DNA) with a complimentary, labeled oligonucleotide probe. See Nucl. Acids Res. 9, 879-894 (1981); incorporated herein by reference. Since DNA duplexes containing even a single base pair mismatch exhibit high thermal instability, the differential melting temperature can be used to distinguish target DNAs that are perfectly complimentary to the probe from target DNAs that only differ by a single nucleotide. This method has been adapted to detect the presence or absence of a specific restriction site, U.S. Pat. No. 4,683,194; incorporated herein by reference. The method involves using an end-labeled oligonucleotide probe spanning a restriction site which is hybridized to a target DNA. The hybridized duplex of DNA is then incubated with the restriction enzyme appropriate for that site. Reformed restriction sites will be cleaved by digestion in the pair of duplexes between the probe and target by using the restriction endonuclease. The specific restriction site is present in the target DNA if shortened probe molecules are detected.

Other methods for detecting polymorphisms in nucleic acid sequences include methods in which protection from cleavage agents is used to detect mismatched bases in RNA/RNA or RNA/DNA heteroduplexes (Myers et al. (1985) Science 230:1242). In general, the art technique of “mismatch cleavage” starts by providing heteroduplexes of formed by hybridizing (labeled) RNA or DNA containing the polymorphic sequence with potentially polymorphic RNA or DNA obtained from a tissue sample. The double-stranded duplexes are treated with an agent which cleaves single-stranded regions of the duplex such as which will exist due to basepair mismatches between the control and sample strands. For instance, RNA/DNA duplexes can be treated with RNase and DNA/DNA hybrids treated with S1 nuclease to enzymatically digesting the mismatched regions. In other embodiments, either DNA/DNA or RNA/DNA duplexes can be treated with hydroxylamine or osmium tetroxide and with piperidine in order to digest mismatched regions. After digestion of the mismatched regions, the resulting material is then separated by size on denaturing polyacrylamide gels. See, for example, Cotton et al. (1988) Proc. Natl Acad Sci USA 85:4397; Saleeba et al. (1992) Methods Enzymol. 217:286-295; each of which is incorporated herein by reference. In a preferred embodiment, the control DNA or RNA can be labeled for detection.

In another embodiment, alterations in electrophoretic mobility can be used to identify polymorphisms. For example, single strand conformation polymorphism (SSCP) may be used to detect differences in electrophoretic mobility between mutant and wild type nucleic acids (Orita et al. (1989) Proc Natl. Acad. Sci USA: 86:2766, see also Cotton (1993) Mutat Res 285:125-144; Hayashi (1992) Genet Anal Tech Appl 9:73-79; each of which is incorporated herein by reference). Single-stranded DNA fragments of sample and control nucleic acids can be denatured and allowed to renature. The secondary structure of single-stranded nucleic acids varies according to sequence, the resulting alteration in electrophoretic mobility enables the detection of even a single base change. The DNA fragments may be labeled or detected with labeled probes. The sensitivity of the assay may be enhanced by using RNA (rather than DNA), in which the secondary structure is more sensitive.to a change in sequence. In a preferred embodiment, the subject method utilizes heteroduplex analysis to separate double stranded heteroduplex molecules on the basis of changes in electrophoretic mobility (Keen et al. (1991) Trends Genet. 7:5).

In yet another embodiment, the movement of nucleic acid molecule comprising polymorphic sequences in polyacrylamide gels containing a gradient of denaturant is assayed using denaturing gradient gel electrophoresis (DGGE) (Myers et al. (1985) Nature 313:495; incorporated herein by reference). When DGGE is used as the method of analysis, DNA can be modified to insure that it does not completely denature, for example by adding a GC clamp of approximately 40 bp of high-melting GC-rich DNA by PCR. In a further embodiment, a temperature gradient is used in place of a denaturing gradient to identify differences in the mobility of control and sample DNA (Rosenbaum and Reissner (1987) Biophys Chem 265:12753; incorporated herein by reference).

Examples of other techniques for detecting polymorphisms include, but are not limited to, selective oligonucleotide hybridization, selective amplification, or selective primer extension. For example, oligonucleotide primers may be prepared in which the polymorphic region is placed centrally and then hybridized to target DNA under conditions which permit hybridization only if a perfect match is found (Saiki et al. (1986) Nature 324:163); Saiki et al. (1989) Proc. Natl Acad. Sci USA 86:6230; each of which is incorporated herein by reference). Such allele specific oligonucleotides are hybridized to PCR amplified target DNA or a number of different polymorphisms when the oligonucleotides are attached to the hybridizing membrane and hybridized with labeled target DNA.

Another process for studying differences in DNA structure is the primer extension process which consists of hybridizing a labeled oligonucleotide primer to a template RNA or DNA and then using a DNA polymerase and deoxynucleoside triphosphates to extend the primer to the 5′ end of the template. Resolution of the labeled primer extension product is then done by fractionating on the basis of size, e.g., by electrophoresis via a denaturing polyacrylamide gel. This process is often used to compare homologous DNA segments and to detect differences due to nucleotide insertion or deletion. Differences due to nucleotide substitution are not detected since size is the sole criterion used to characterize the primer extension product.

Another process exploits the fact that the incorporation of some nucleotide analogs into DNA causes an incremental shift of mobility when the DNA is subjected to a size fractionation process, such as electrophoresis. Nucleotide analogs can be used to identify changes since they can cause an electrophoretic mobility shift. See, U.S. Pat. No. 4,879,214.

Many other techniques for identifying and detecting polymorphisms are known to those skilled in the art, including those described in “DNA Markers: Protocols, Applications and Overview,” G. Caetano-Anolles and P. Gresshoff ed., (Wiley-VCH, New York) 1997, which is incorporated herein by reference as if fully set forth.

In addition, many approaches have also been used to specifically detect SNPs. Such techniques are known in the art and many are described e.g., in DNA Markers: Protocols, Applications, and Overviews. 1997. Caetano-Anolles and Gresshoff, Eds. Wiley-VCH, New York, pp 199-211 and the references contained therein). For example, in one embodiment, a solid phase approach to detecting polymorphisms such as SNPs can be used. For example an oligonucleotide ligation assay (OLA) can be used. This assay is based on the ability of DNA ligase to distinguish single nucleotide differences at positions complementary to the termini of co-terminal probing oligonucleotides (see, e.g., Nickerson et al. 1990. Proc. Natl. Acad. Sci. USA 87:8923; incorporated herein by reference). A modification of this approach, termed coupled amplification and oligonucleotide ligation (CAL) analysis, has been used for multiplexed genetic typing (see, e.g., Eggerding 1995 PCR Methods Appl. 4:337); Eggerding et al. 1995 Hum. Mutat. 5:153; incorporated herein by reference).

In another embodiment, genetic bit analysis (GBA) can be used to detect a SNP (see, e.g., Nikiforov et al. 1994. Nucleic Acids Res. 22:4167; Nikiforov et al. 1994. PCR Methods Appl. 3:285; Nikiforov et al. 1995. Anal Biochem. 227:201; each of which is incorporated herein by reference). In another embodiment, microchip electrophoresis can be used for high-speed SNP detection (see e.g., Schmalzing et al. 2000. Nucleic Acids Research, 28). In another embodiment, matrix-assisted laser desorption/ionization time-of-flight mass (MALDI TOF) mass spectrometry can be used to detect SNPs (see, e.g., Stoerker et al. Nature Biotechnology 18:1213).

In another embodiment, a difference in a biological activity of XBP-1 between a subject and a control can be detected. For example, an activity of XBP-1 or a molecule in a signal transduction pathway involving XBP-1 can be detected in cells of a subject suspected of having a disorder associated with aberrant biological activity of XBP-1. The activity of XBP-1 or a molecule in a signal transduction pathway involving XBP-1 α in cells of the subject could then be compared to a control and a difference in activity of XBP-1 or a molecule in a signal transduction pathway involving XBP-1 in cells of the subject as compared to the control could be used to diagnose the subject as one that would benefit from modulation of an XBP-1 activity. Activities of XBP-1 or molecules in a signal transduction pathway involving XBP-1 can be detected using methods described herein or known in the art.

In preferred embodiments, the diagnostic assay is conducted on a biological sample from the subject, such as a cell sample or a tissue section (for example, a freeze-dried or fresh frozen section of tissue removed from a subject). In another embodiment, the level of expression of XBP-1 or a molecule in a signal transduction pathway involving XBP-1 in cells of the subject can be detected in vivo, using an appropriate imaging method, such as using a radiolabeled antibody.

In one embodiment, the level of expression of XBP-1 or a molecule in a signal transduction pathway involving XBP-1 in cells of the test subject may be elevated (i.e., increased) relative to the control not associated with the disorder or the subject may express a constitutively active (partially or completely) form of the molecule. This elevated expression level of, e.g., XBP-lor expression of a constitutively active form of spliced XBP-1, can be used to diagnose a subject for a disorder associated with increased XBP-1 activity.

In another embodiment, the level of expression of XBP-1 or a molecule in a signal transduction pathway involving XBP-1 in cells of the subject may be reduced (i.e., decreased) relative to the control not associated with the disorder or the subject may express an inactive (partially or completely) mutant form of, e.g., spliced XBP-1. This reduced expression level of spliced XBP-1 or expression of an inactive mutant form of spliced XBP-1 can be used to diagnose a subject for a disorder, such as immunodeficiency disorders characterized by insufficient antibody production.

In one embodiment, the level of expression of gene whose expression is regulated by XBP-1 can be measured (e.g., ERdj4, p58^{IPK}, EDEM, PDI-P5, RAMP4, BiP, XBP-1, or ATF6α).

In another embodiment, an assay diagnosing a subject as one that would benefit from modulation of XBP-1 expression, processing, post-translational modification, and/or activity (or a molecule in a signal transduction pathway involving XBP-1 is performed prior to treatment of the subject.

The methods described herein may be performed, for example, by utilizing pre-packaged diagnostic kits comprising at least one probe/primer nucleic acid or other reagent (e.g., antibody), which may be conveniently used, e.g., in clinical settings to diagnose patients exhibiting symptoms or family history of a disease or illness involving XBP-1 or a molecule in a signal transduction pathway involving XBP-1.

Kits of the Invention

Another aspect of the invention pertains to kits for carrying out the screening assays, modulatory methods or diagnostic assays of the invention. For example, a kit for carrying out a screening assay of the invention can include an indicator composition comprising XBP-1 or a molecule in a signal transduction pathway involving XBP-1, means for measuring a readout (e.g., protein secretion) and instructions for using the kit to identify modulators of biological effects of XBP-1. In another embodiment, a kit for carrying out a screening assay of the invention can include cells deficient in XBP-1 or a molecule in a signal transduction pathway involving XBP-1, means for measuring the readout and instructions for using the kit to identify modulators of a biological effect of XBP-1.

In another embodiment, the invention provides a kit for carrying out a modulatory method of the invention. The kit can include, for example, a modulatory agent of the invention (e.g., XBP-1 inhibitory or stimulatory agent) in a suitable carrier and packaged in a suitable container with instructions for use of the modulator to modulate a biological effect of XBP-1.

Another aspect of the invention pertains to a kit for diagnosing a disorder associated with a biological activity of XBP-1 in a subject. The kit can include a reagent for determining expression of XBP-1 (e.g., a nucleic acid probe for detecting XBP-1 mRNA or an antibody for detection of XBP-1 protein), a control to which the results of the subject are compared, and instructions for using the kit for diagnostic purposes.

Another aspect of the invention pertains to methods of detecting splicing of XBP-1 and kits for performing such methods. Such methods are useful in identifying agents that modulate splicing. The invention also pertains to constructs comprising XBP-1 or a portion thereof (e.g., the splice region of XBP-1 and a transcriptional activating domain of XBP-1). In one embodiment, such a construct comprises a transactivation domain of XBP-1 (Clauss et al. 1996. Nucleic Acids Research 24:1855; incorporated herein by reference). Cells can be engineered to express such constructs and a reporter gene operably linked to a regulatory region responsive to spliced XBP-1. In one embodiment, a cell is engineered to express a screening vector comprising XBP-1 linked to a reporter gene (e.g., luciferase) such that when the spliced form of XBP-1 is made, the reporter gene is transcribed and when the unspliced form of XBP-1 is made, the reporter gene is not transcribed. In one embodiment, such an assay can be performed in the presence and absence of a compound that promotes the unfolded protein response, e.g., tunicamycin, so that the role of a test compound on that response can be measured (e.g., the ability of the compound to up or downmodulate this response can be tested). In one embodiment, the cell can further express an exogenous or an endogenous IRE-1 molecule. Test compounds can be identified as stimulators or inhibitors of XBP-1 splicing by comparing the amount of XBP-1 splicing in the presence and the absence of the test compound. In one embodiment, the invention also pertains to a kit for detecting splicing of XBP-1. The kit can include a recombinant cell comprising an exogenous XBP-1 molecule or a portion thereof, and a reporter gene operably linked to a regulatory region responsive to XBP-1 such that upon splicing of the XBP-1 protein, transcription of the reporter gene occurs.

This invention is further illustrated by the following examples which should not be construed as limiting. The contents of all references, patents and published patent applications cited throughout this application are hereby incorporated by reference.

### EXAMPLES

The following materials and methods were used in the Examples.

Biochemical Reagents: Anti-IRS-1, anti-phospho-IRS-1 (Ser307) and anti-IRS-2 antibodies were from Upstate Biotechnology (Charlottesville, Va.). Antibodies against phosphotyrosine, eIF2α, insulin receptor β subunit, and XBP-1 were from Santa Cruz Biotechnology (Santa Cruz, Calif.). Anti-phospho-PERK, anti-Akt, and anti-phospho-Akt antibodies and c-Jun protein were from Cell Signaling Technology (Beverly, Mass.). Anti-phospho-eIF2a antibody was purchased from Stressgen (Victoria, British Columbia, Canada). Anti-insulin antibody and C-peptide RIA kit were purchased from Linco Research (St. Charles, Mo.). Anti-glucagon antibody was from Zymed (San Francisco, Calif.). PERK antiserum was kindly provided by Dr. David Ron (New York University School of Medicine). Texas red conjugated donkey anti-guinea pig IgG and fluorescein-conjugated (FITC-conjugated) goat anti-rabbit IgG were from Jackson Immuno Research Laboratories (West Grove, Pa.). Thapsigargin, tunicamycin, and JNK inhibitors were from Calbiochem (San Diego, Calif.). Insulin, glucose, and sulindac sulfide were from Sigma (St. Louis, Mo.). The Ultra Sensitive Rat Insulin ELISA kit was from Crystal Chem Inc. (Downers Grove, Ill.).

Cells: FaO cells were cultured with RPMI 1640 (Gibco) containing 10% fetal bovine serum (FBS). At 70-80% confluency, cells were serum depleted for 12 hours before starting the experiments. Reagents including tunicamycin, thapsigargin, and JNK inhibitors were gently added to the culture dishes in the incubator to prevent any environmental stress. JNK inhibitors were added 1 hour before tunicamycine/thapsigargin treatment. The XBP-1^{-/-} MEF cells, IRE-1α^{-/-} MEF cells (provided by Dr. David Ron (New York University School of Medicine) and their wild type (WT) controls were cultured in Dulbecco's Modified Eagle Medium (DMEM) (Gibco) containing 10% FBS. Experiments in MEF cells were carried out similar to those in FaO cells except after 6 hours of serum depletion.

Overexpression of XBPIs in MEFs: MEF-tet-off cells (Clontech) were cultured in DMEM with 100 μg/ml G418 and 1 μg/ml doxycycline. The MEF-tet-off cells express exogenous tTA (tetracycline-controlled transactivator) protein, which binds to TRE (tetracycline response element) and activates transcription only in the absence of tetracycline or doxycycline. The cDNA of the spliced form of XBP-1 was ligated into pTRE2hyg2 plasmid (Clontech). The MEF-tet-off cells were transfected with the TRE2hyg2-XBP-1s plasmid, followed by selection in the presence of 400 pg/mI hygromycine B. Individual clones of stable transfectants were isolated and doxycycline-dependent XBP-1s expression was confirmed by immunoblotting.

Northern Blot Analysis: Total RNA was isolated from mouse liver using Trizol reagent (Invitrogen), separated by 1% agarose gel, and then transferred onto BrightStar Plus nylon membrane (Ambion). GRP78 cDNA probe was prepared from mouse liver total cDNAs by RT-PCR using the following primers: 5′-TGGAGTTCCCCAGATTGAAG-3′ (SEQ ID NO.:42) and 5′-CCTGACCCACCTllCTCA-3′ (SEQ ID NO.:43). The DNA probes were labeled with ³²P-dCTP using random primed DNA labeling kit (Roche). Hybridization was performed according to the manufacturer's protocol (Ambion) and visualized by Versa Doc Imaging System 3000 (BioRad).

Protein Extracts From Cells: At the end of each treatment, cells were immediately frozen in liquid nitrogen and kept at −80° C. Protein extracts were prepared with a lysis buffer, containing 25 mM Tris-HCl (pH7.4), 2 mM Na₃VO₄, 10 mM NaF, 10 mM Na₄P₂O₇, 1 mM EGTA, 1 mM EDTA, 1% NP40, 5 μg/ml leupeptin, 5 μg/ml aprotinin, 10 nM okadaic acid, and 1 mM PMSF. Immunoprecipitations and immunoblotting experiments were performed with 750 pg and 75 ug total protein, respectively.

Animal Studies and Obesity Models: Adult (10-12 weeks of age) male ob/ob mice and their wild type (WT) littermates were purchased from Jackson Labs. Mice used in the diet-induced obesity model were male C57BL/6. All mice were placed on high fat diet (HFD: 35.5% fat, 20% protein, 32.7% carbohydrates, Bio-Serve) immediately after weaning (at ˜3 weeks of age). The XBP-1^{±} and XBP-1^{+/+} mice were on Balb/C genetic background. Insulin and glucose tolerance tests were performed as previously described (Hirosumi, J., et al. (2002) Nature 420:333-6). Insulin and C-peptide ELISA were performed according to manufacturer's instructions using mouse standards (Crystal Chem Inc., Downers Grove, Ill.). Pancreas isolated from 16-week-old mice was fixed in Bouin's fluid and forinalin, and paraffin sections were double-stained with guinea pig anti-insulin and rabbit anti-glucagon antibodies. Texas red dye conjugated donkey anti-guinea pig IgG and FITC conjugated Goat anti-rabbit IgG were used as secondary antibodies.

Insulin Infusion and Tissue Protein Extraction: Insulin was injected through portal vein as previously described (Hirosumi, J., et al. (2002) Nature 420:333-6; Uysal, K. T., et al. (1997), Nature 389:610-4). Three minutes after insulin infusion, liver was frozen in liquid nitrogen and kept at −80 C until processing. For protein extraction, liver tissue (˜0.3 g) was placed in 10 ml of lysis buffer containing 25 mM Tris-HCl (pH 7.4), 10 mM Na₃VO₄, 100 mM NaF, 50mM Na₄P₂O₇, 10 mM EGTA, 10 mM EDTA, 1% NP-40, 5 μg/ml leupeptin, 5 μg/ml aprotinin, 10 nM okadaic acid, 2 mM PMSF. After homogenization on ice, the tissue lysate was centrifuged at 4,000 rpm for 15 minutes at 4° C. following 55,000 rpm for 1 hour at 4° C. One mg of total tissue protein was used for immunoprecipitation followed by immunoblotting or 100-150 Hg total tissue protein was used to perform direct immunoblotting (Hirosumi, J., et al. (2002) Nature 420:333-6; incorporated herein by reference).

### Example 1

### Induction of ER Stress in Obesity

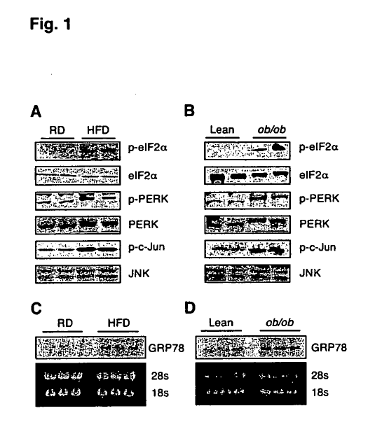

To examine whether ER stress is increased in obesity, the expression patterns of several molecular indicators of ER stress in dietary (high fat diet-induced) and genetic (ob/ob) models of murine obesity were investigated. The pancreatic ER kinase or PKR like kinase (PERK) is an ER transmembrane protein kinase that phosphorylates the α subunit of translation initiation factor 2 (eIF2α) in response to ER stress (Shi, Y., et al. (1998) Mol. Cell Biol. 18:7499; Harding, H. P., et al. (1999) Nature 391:271; each of which incorporated herein by reference). The phosphorylation status of PERK and eIF2α is therefore a key indicator of the presence of ER stress. The phosphorylation status of PERK (Thr980) and eIF2α (Ser51) was determined using phospho-specific antibodies. These experiments demonstrated increased PERK and eIF2α phosphorylation in liver extracts of obese mice compared with lean controls (FIGS. 1A and 1B). ER stress also leads to JNK activation. Consistent with earlier observations (Hirosumi, J., et al. (2002) Nature 420:333; incorporated herein by reference), total JNK activity, indicated by c-Jun phosphorylation, was also dramatically elevated in the obese mice (FIGS. 1A and B).

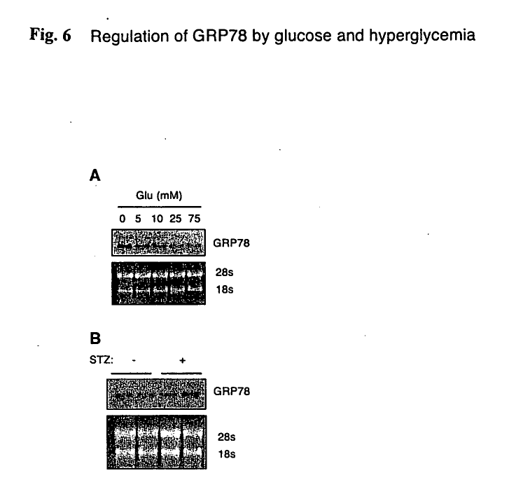

The 78 kDa glucose regulated/binding Ig protein (GRP78/BIP) is an ER chaperone whose expression is increased upon ER stress. The GRP78/BIP mRNA levels were elevated in the liver tissue of obese mice compared with matched lean controls (FIGS. 1C and 1D). Since GRP78 expression is responsive to glucose, we tested whether this upregulation might simply be due to increasing glucose levels. Treatment of cultured rat Fao liver cells with high levels of glucose resulted in reduced GRP78 expression (FIG. 6). Similarly GRP78 levels were not increased in a mouse model of hyperglycemia (FIG. 6), indicating that regulation in obesity is unlikely to be related to glycemia alone.

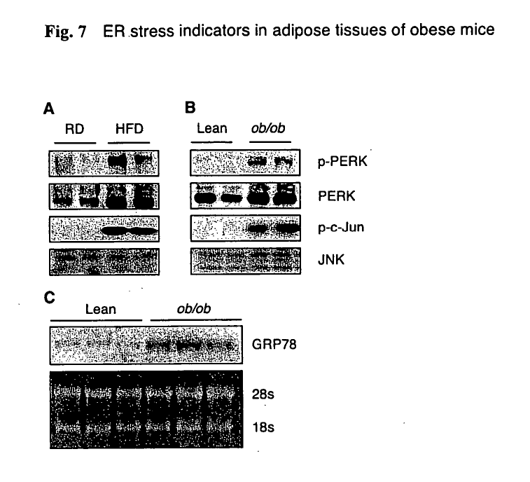

Adipose and muscle tissues were also tested for indications of ER stress in obesity, since they are important sites for metabolic homeostasis. Similar to liver, PERK phosphorylation, JNK activity, and GRP78 expression were all significantly increased in adipose tissue of obese animals compared with lean controls (FIG. 7A-C). However, no indication for ER stress was evident in the muscle tissue of obese animals. Taken together, these results indicate that obesity is associated with induction of ER stress predominantly in liver and adipose tissues.

### Example 2

### ER Stress Inhibits Insulin Action in Liver Cells

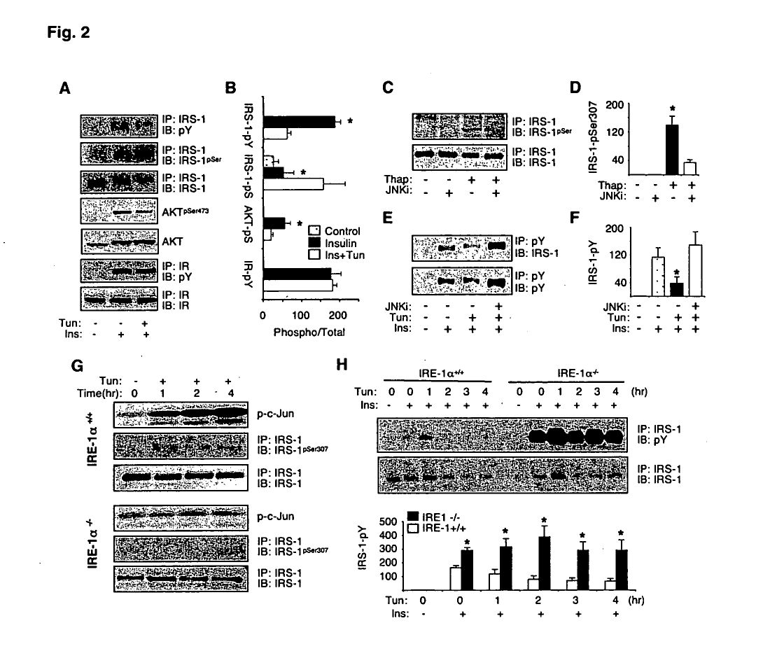

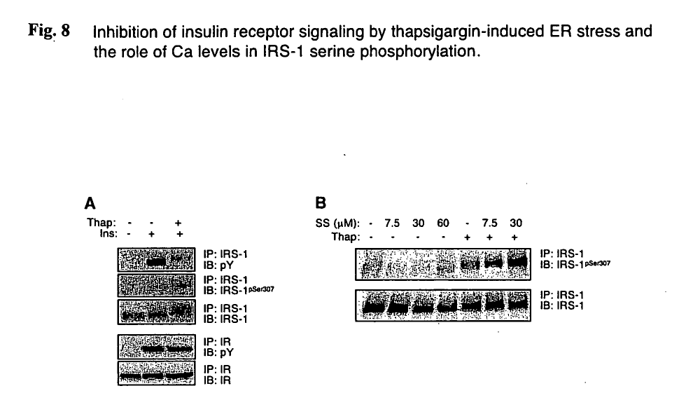

To investigate whether ER stress interferes with insulin action, Fao liver cells were pretreated with tunicamycin and thapsigargin, agents commonly used to induce ER stress. Tunicamycin significantly decreased insulin-stimulated tyrosine phosphorylation of IRS-1 (FIGS. 2A and 2B) and it also produced an increase in the molecular weight of IRS-1 (FIG. 2A). IRS-1 is a substrate for insulin receptor tyrosine kinase and serine phosphorylation of IRS-1, particularly mediated by JNK, reduces insulin receptor signaling (Hirosumi, J., et al. (2002) Nature 420:333; incorporated herein by reference). Pretreatment of Fao cells with tunicamycin produced a significant increase in serine phosphorylation of IRS-1 (FIGS. 2A and B). Tunicamycin pretreatment also suppressed insulin-induced Akt phosphorylation, a more distal event in insulin receptor signaling pathway (FIGS. 2A and B). Similar results were also obtained following treatment with thapsigargin (FIG. 8A), which was independent of alterations in cellular calcium levels (FIG. 8B).

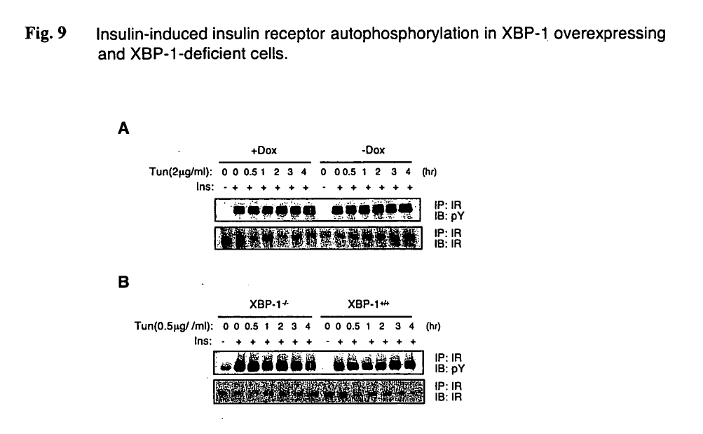

These results demonstrate that treatment of cells with thapsigargin, an agent that induces ER stress by inhibiting calcium ATPase, also increased IRS-1 serine phosphorylation and suppressed insulin receptor signaling. The use of sulindac sulfide to block calcium influx to the cytosol from the extracellular compartment addresses whether these effects were simply due to alterations in cellular calcium levels. Treatment with sulindac sulfide alone had no effect on Ser307 phosphorylation of IRS-1. Furthermore, in the presence of thapsigargin, it did not interfere with IRS-1 serine phosphorylation indicating that the effect of thapsigargin on Ser307 phosphorylation of IRS-1 is mediated through ER stress. In contrast, insulin-stimulated insulin receptor (IR) tyrosine phosphorylation under these conditions was normal (FIG. 9) indicating that signaling between ER stress and insulin receptor signaling occurred at a post-receptor level.

The role of JNK in IRS-1 serine phosphorylation and inhibition of insulin-stimulated IRS-1 tyrosine phosphorylation by ER stress was next examined (FIGS. 2C and D). Inhibition of JNK activity with the synthetic inhibitor, SP600125, reversed the ER stress-induced serine phosphorylation of IRS-1 (FIGS. 2C and D). Pretreatment of Fao cells with a highly specific inhibitory peptide derived from the JNK binding protein, JIP (12), also completely preserved insulin receptor signaling in cells exposed to tunicamycin (FIGS. 2E and F). Similar results were obtained with the synthetic JNK inhibitor, SP600125. These results indicate that ER stress promotes a JNK-dependent serine phosphorylation of IRS-1, which in turn inhibits insulin receptor signaling.

### Example 3

### IRE-1 Plays a Crucial Role in Insulin Receptor Signaling

In the presence of ER stress, increased phosphorylation of inositol requiring kinase-1α (IRE-1α leads to recruitment of TNF-α receptor-associated factor 2 (TRAF2) protein and activates fNK (Urano, F., et al. (2000) Science 287:664; incorporated herein by reference). To address whether ER stress-induced insulin resistance is dependent on intact IRE-1α, JNK activation, IRS-1 serine phosphorylation, and insulin receptor signaling were measured upon exposure of IRE-1α^{-/-} and wild type (WT) fibroblasts to tunicamycin. In the WT but not IRE-1α^{-/-} cells, induction of ER stress by tunicamycin resulted in strong activation of JNK (FIG. 2G). Tunicamycin also stimulated phosphorylation of IRS-1 at Ser307 residue in WT (FIG. 2G) but not IRE-1α^{-/-} fibroblasts (FIG. 2E). Importantly, tunicamycin inhibited insulin-stimulated tyrosine phosphorylation of IRS-1 in the WT cells, whereas no such effect was detected in the IRE-1α^{-/-} cells (FIG. 2H). The level of insulin-induced tyrosine phosphorylation of IRS-1 was dramatically higher in IRE-1α^{-/-} cells despite lower total IRS-1 protein levels (FIG. 2H). These results demonstrate that ER stress-induced inhibition of insulin action is mediated by an IRE-1α-JNK-dependent protein kinase cascade.

### Example 4

### Manipulation of XBP-1 Levels Alters Insulin Receptor Signaling

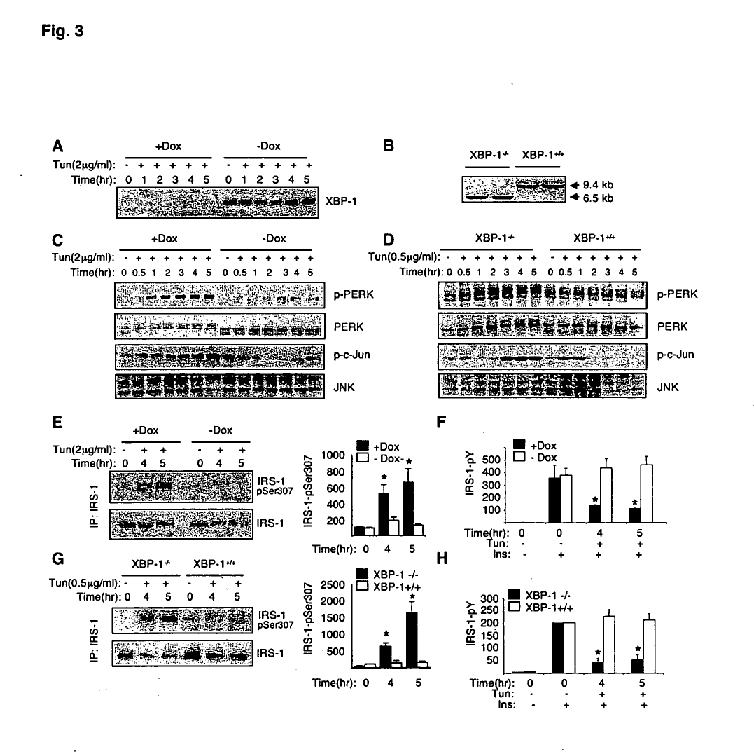

The transcription factor XBP-1 is a bZIP protein. The spliced or processed form of XBP-1 (XBP-1s) is a key factor in the transcriptional regulation of molecular chaperones and enhances the compensatory UPR (Calfon, M., et al. (2002) Nature 415:92; Shen, X., et al. (2001) Cell 107:893; Yoshida, H, et al. (2001) Cell 107:881; Lee, A. H., et al. (2003) Mol. Cell Biol. 23:7448; each of which is incorporated herein by reference). Therefore, modulation of XBP-1s levels in cells should alter insulin action via its potential impact on the magnitude of the ER stress responses. To test this possibility, XBP-1 gain- and loss-of-function cellular models were established. First, an inducible gene expression system was established where exogenous XBP-1s is expressed only in the absence of tetracycline/doxycycline (FIG. 3A). In parallel, MEFs derived from XBP-1^{-/-} mouse embryos (Lee, A. H., et al. (2003) Mol. Cell Biol. 23:7448; Reimold, A. M., et al. (2000) Genes Dev. 14:152; Reimold et al. (2001) Nature 412:300; each of which is incorporated herein by reference) were also studied (FIG. 3B). In fibroblasts without exogenous XBP-1s expression, tunicamycin treatment (2 μg/ml) resulted in strong PERK phosphorylation starting at 30 minutes and peaking at 3-4 hours associated with a mobility shift characteristic of PERK phosphorylation (FIG. 3C). In these cells, there was also a rapid and robust activation of JNK in response to ER stress (FIG. 3C). Upon induction of XBP-1s expression, there was a dramatic reduction in both PERK phosphorylation and JNK activation following tunicamycin treatment (FIG. 3C). Hence, overexpression of XBP-1s rendered WT cells refractory to ER stress. Similar experiments performed in XBP-1^{-/-} MEFs revealed an opposite pattern (FIG. 3D). XBP-1^{-/-} MEFs mounted a strong ER stress response even when treated with a low dose of tunicamycin (0.5 μg/ml), that failed to stimulate significant ER stress in WT cells (FIG. 3D). Under these conditions, PERK phosphorylation and JNK activation levels in XBP-1^{-/-} MEFs were significantly higher than those seen in WT controls (FIG. 3D), indicating that XBP-1^{-/-} cells are prone to ER stress. Thus alterations in the levels of cellular XBP-1s protein result in alterations in the ER stress response.

Next, it was determined whether these differences in the ER stress responses produced alterations in insulin action as assessed by IRS-1 serine phosphorylation and insulin-stimulated IRS-1 tyrosine phosphorylation. Tunicamycin-induced IRS-1 serine phosphorylation was significantly reduced in fibroblasts exogenously expressing XBP-1s, compared with that of control cells (FIG. 3E). Upon insulin stimulation, the extent of IRS-1 tyrosine phosphorylation was significantly higher in cells overexpressing XBP-1s, compared with controls (FIG. 3F). In contrast, IRS-1 serine phosphorylation was strongly induced in XBP-1^{-/-} MEFs compared with XBP-1^{+/+} controls even at low doses of tunicamycin treatment (0.5 μg/ml) (FIG. 3G). Following insulin stimulation, the level of IRS-1 tyrosine phosphorylation was significantly decreased in tunicamycin-treated XBP-1^{-/-} cells compared with tunicamycin-treated WT controls (FIG. 3H). Insulin-stimulated tyrosine phosphorylation of the insulin receptor was normal in these cells (FIG. 9).

### Example 5

### XBP-1^{±} Mice Show Impaired Glucose Homeostasis

Complete XBP-1 deficiency results in embryonic lethality (Reimold, A. M., et al., (2000) Genes Dev. 14, 152). To investigate the role of XBP-1 in ER stress, insulin sensitivity and systemic glucose metabolism in vivo, Balb/C-XBP-1^{±} mice with a null mutation in one XBP-1 allele were studied. Mice on the Balb/C genetic background were studied since this strain exhibits strong resistance to obesity-induced alterations in systemic glucose metabolism. Based on the results with cellular systems, it was hypothesized that XBP-1 deficiency would predispose mice to the development of insulin resistance and type 2 diabetes.

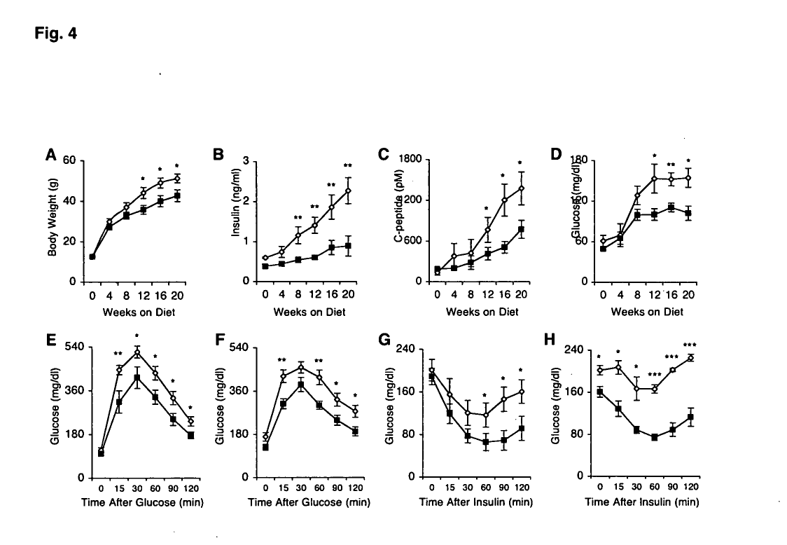

XBP-1^{±} mice and their WT littermates were placed on a high fat diet (HFD) at 3 weeks of age. In parallel, control mice of both genotypes were placed on a chow diet. The total body weights of both genotypes were similar on chow diet and until 12 weeks of age on HFD. After this period, the XBP-1^{±} animals on HFD exhibited a small but significant increase in body weight (FIG. 4A). Serum levels of leptin, adiponectin and triglycerides did not exhibit any statistically significant differences between the genotypes measured after 16 weeks of HFD.

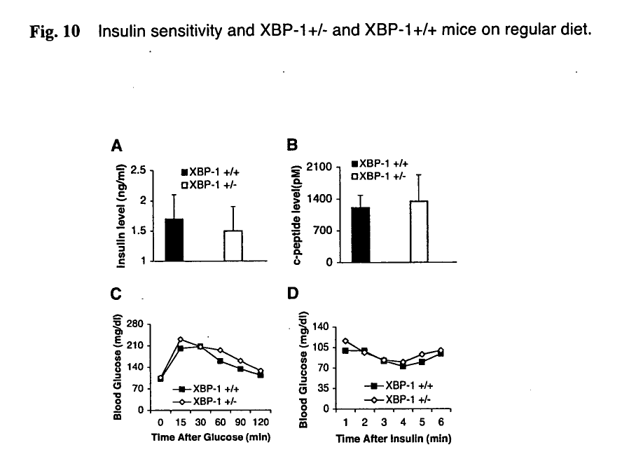

At the onset of the HFD experiment, there was also no difference in glucose metabolism between XBP-1^{±} and XBP-1^{+/+} mice as determined by fasting and fed blood glucose, insulin and C-peptide levels, and by intraperitoneal glucose and insulin tolerance tests. Serum levels of leptin (26.2±2.5 and 25.2±1.8 ng/ml in XBP-1^{+/+} and XBP-1^{±}, respectively), adiponectin (15.5±1.8 and 16.6±1.6 ng/dl in XBP-1^{+/+} and XBP-1^{±}, respectively) and triglycerides (67.7±5.5 and 62.8±3.4 mg/dl in XBP-1^{+/+} and XBP-1^{±}, respectively) did not exhibit any statistically significant differences between the genotypes measured after 16 weeks of HFD. Blood insulin levels in XBP-1^{+/+} mice were significantly lower than those in XBP-1^{±} littermates (0.89±0.25 and 2.27±0.32 ng/ml in XBP-1^{+/+} and XBP-1^{±} after 20 weeks on HFD, respectively, p<0.05). C-peptide levels were also significantly higher in XBP-1^{±} animals than in WT controls (772.91±132.24 and 1374.11±241.8 ng/ml in XBP-1^{+/+} and XBP-^{±} after 20 weeks on HFD, respectively, p<0.05) (FIG. 10).

On HFD, XBP-1^{±} mice developed continuous and progressive hyperinsulinemia evident as early as 4 weeks (FIG. 4B). Insulin levels continued to increase in XBP-1^{±} mice for the duration of the experiment. Blood insulin levels in XBP-1^{+/+} mice were significantly lower than those in XBP-1^{±} littermates (FIG. 4B). As shown in FIG. 4C, C-peptide levels were also significantly higher in XBP-1^{±} animals than in WT controls. Blood glucose levels also began to rise in the XBP-1^{±} mice on HFD starting at 8 weeks and remained high until the conclusion of the experiment at 20 weeks (FIG. 4D). This pattern was the same in both fasted (FIG. 4D) and fed states. The rise in blood glucose in the face of hyperinsulinemia in the mice on HFD is a strong indicator of the development of peripheral insulin resistance.

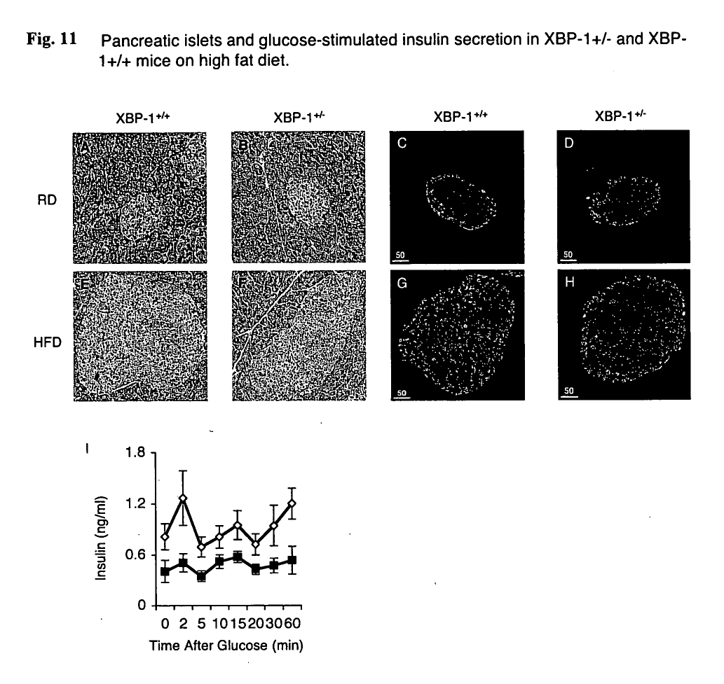

To investigate systemic insulin sensitivity, glucose (GTT) and insulin (ITT) tolerance tests were performed in XBP-1^{±} mice and XBP-1^{+/+} controls. Exposure to HFD resulted in significant glucose intolerance in XBP-1^{±} mice. Upon glucose challenge after 7 weeks of HFD, XBP-1± mice showed significantly higher glucose levels than XBP-1^{+/+} mice (FIG. 4E). This glucose intolerance continued to be evident in XBP-1^{±} mice compared with WT mice after 16 weeks on HFD (FIG. 4F). During ITT, the hypoglycemic response to insulin was also significantly lower in XBP-1^{±} mice compared with XBP-1^{+/+} littermates at 8 weeks of HFD (FIG. 4G) and this reduced responsiveness continued to be evident after 17 weeks of HFD (FIG. 4H). Examination of islets morphology and function did not reveal significant differences between genotypes (FIG. 11). Hence, loss of an XBP-1 allele predisposes mice to diet-induced insulin resistance and diabetes.

In these experiments, there was no detectable abnormality in the XBP^{±} islets and no difference was evident between genotypes under standard conditions. On HFD, both the XBP-1^{±} and XBP-1^{+/+} mice exhibited islet hyperplasia. This anticipated response to HFD was similar between genotypes and the hyperplastic component (islet size>150 μM) comprised 40% of all islets in XBP-1^{±} and 43% of all islets in WT mice on HFD. In experiments examining glucose-stimulated insulin secretion in XBP-1^{±} and WT mice on HFD, the XBP-1³⁵ mice responded to glucose with even a stronger insulin secretory response, which effectively eliminates the possibility of an isolated islet defect underlying their phenotype. Hence, these data indicate that the phenotype of the XBP-1^{±} mice cannot be explained by defective islets and even after 16 weeks on HFD, the islets appear indistinguishable between genotypes.

### Example 6

### Increased ER Stress and Impaired Insulin Signaling in XBP-1± Mice

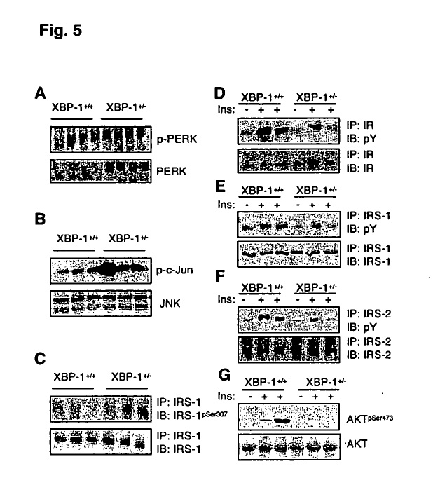

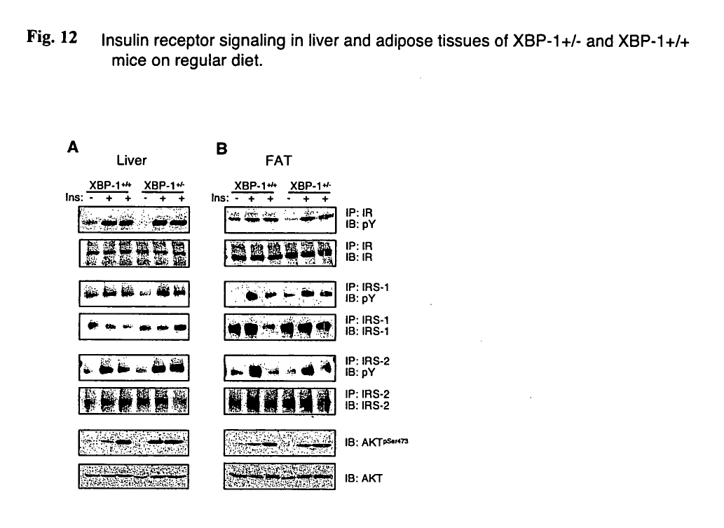

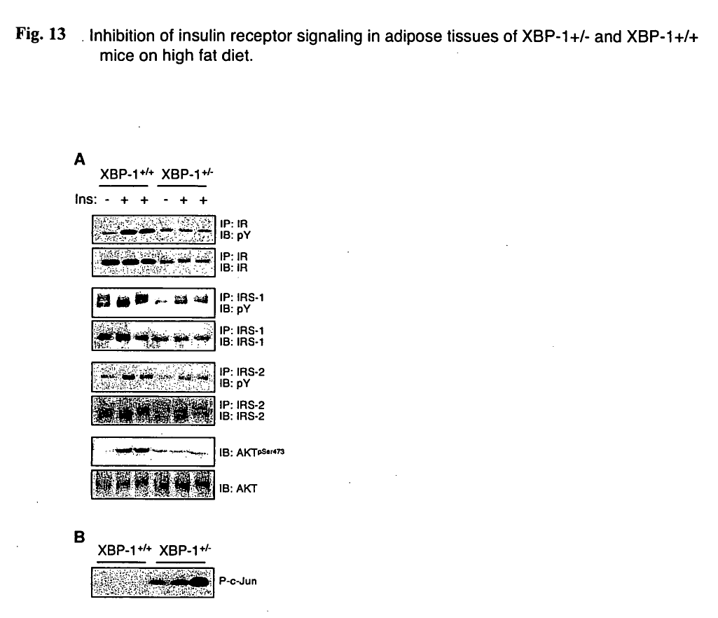

Experiments with cultured cells demonstrated an increase in ER stress and a decrease in insulin signaling capacity in XBP-1-deficient cells and reversal of these phenotypes upon expression of high levels of XBP-1s. If this mechanism is the basis of the insulin resistance seen in XBP-1^{±} mice, these animals should exhibit high levels of ER stress coupled with impaired insulin receptor signaling. To test this, ER stress was first evaluated by examining PERK phosphorylation and JNK activity in the livers of obese XBP-1^{±} and WT mice. These experiments revealed an increase in PERK levels and seemingly an increase in liver PERK phosphorylation in obese XBP-1^{±} mice compared with WT controls on HFD (FIG. 5A). There was also a significant increase in JNK activity in XBP-1^{±} mice compared with WT controls (FIG. 5B). Consistent with these results, serine 307 phosphorylation of IRS-1 was also increased in XBP-1^{±} mice compared with WT controls on HFD (FIG. 5C). Finally, in vivo insulin-stimulated insulin receptor-signaling capacity was studied in these mice. There was no detectable difference in any of the insulin receptor signaling components in liver and adipose tissues between genotypes on regular diet (FIG. 12). However, following exposure to HFD, major components of insulin receptor signaling in the liver, including insulin-stimulated IR, IRS-1 and IRS-2 tyrosine- and Akt serine-phosphorylation were all decreased in XBP-1^{±} mice compared with WT controls (FIG. 5D-G). A similar suppression of insulin receptor signaling was also evident in the adipose tissues of XBP-1^{±} mice compared with XBP-1^{+/+} mice on HFD (FIG. 13). The suppression of IR tyrosine phosphorylation in XBP-1^{±} mice differs from the observations made in

XBP-1^{-/-} cells where ER stress inhibited insulin action at a post-receptor level. It is likely that this reflects the effects of chronic hyperinsulinemia in vivo on insulin receptors. Hence, the data demonstrate the link between ER stress and insulin action in vivo but are not conclusive in determining the exact locus in insulin receptor signaling pathway that is targeted through this mechanism.

In this study, ER stress is identified as a molecular link between obesity, the deterioration of insulin action and the development of type 2 diabetes. Induction of ER stress or reduction in the compensatory UPR capacity through down-regulation of XBP-1 leads to suppression of insulin receptor signaling in intact cells via IRE-la-dependent activation of JNK. Experiments with mouse models also yielded data consistent with the link between ER stress and systemic insulin action. Deletion of an XBP-1 allele in mice leads to enhanced ER stress, hyperactivation of JNK, reduced insulin receptor signaling, systemic insulin resistance, and type 2 diabetes.

### Example 7

### Anti-Diabetic Effects of XBP-1

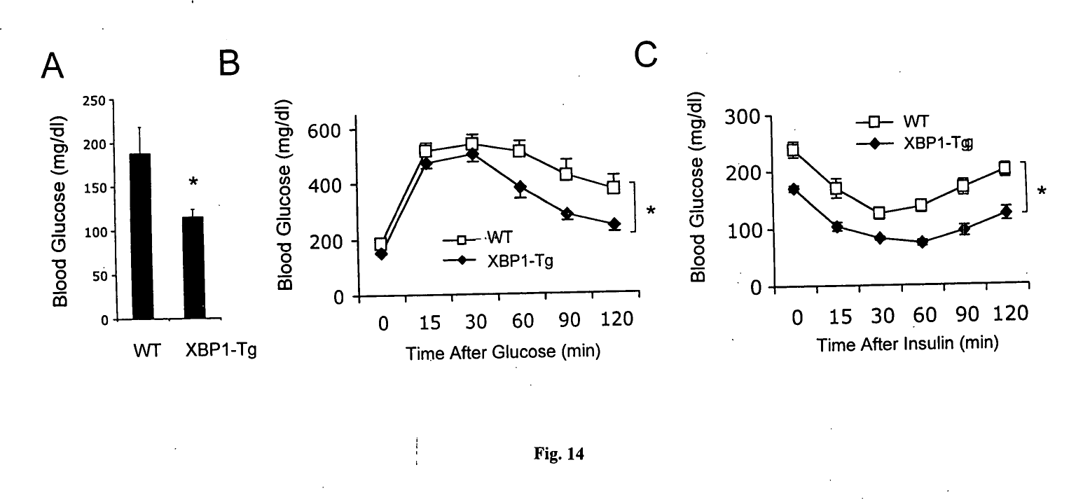

The active, spliced form of XBP-1 (XBP-1s) protein is transgenically expressed in the livers of mice. These XBP-1s transgenic (XBP1-Tg) animals along with their wild type (WT) non-transgenic controls were placed on a high fat diet for 16 weeks which results in increased blood glucose levels and decreased systemic insulin action (insulin resistance). At 16 weeks, blood glucose levels were determined (FIG. 14A). Blood glucose levels in the transgenic, XBP-1s producing animals were significantly lower (*) than wild type controls. Insulin action was further evaluated by performing glucose tolerance tests (FIG. 14B) and insulin tolerance tests (FIG. 14C). In both of these tests, transgenic XBP-1s producing animals performed superior to wild type controls. The glucose disposal curves in transgenic animals demonstrated better glucose homeostasis and insulin sensitivity in both tests. These results demonstrate that increasing XBP-1 activity by producing XBP-1s in whole animals acts to protect the animals from the development of insulin resistance and type 2 diabetes and could be utilized as an anti-diabetic treatment.

Methods: Blood glucose measurements in FIG. 14A were after overnight fasting and determined by the use of an automated glucometer. Glucose tolerance tests shown in FIG. 14B were performed after intraperitoneal administration of 2 g/kg glucose followed by blood glucose measurements at the indicated times. Insulin tolerance tests shown in the FIG. 14B were performed after intraperitoneal administration of 1 IU/kg insulin followed by blood glucose measurements at the indicted times. Asterix indicates statistically siginificant differences.

### Equivalents

Those skilled in the art will recognize, or be able to ascertain using no more than routine experimentation, many equivalents to the specific embodiments and methods described herein. Such equivalents are intended to be encompassed by the scope of the following claims.

What is claimed is:

1. A method of identifying a compound useful in treating at least one symptom of a metabolic disorder comprising:
a) providing an indicator composition comprising mammalian XBP-1;
b) contacting the indicator composition with each member of a library of test compounds;
c) selecting from the library of test compounds a compound of interest that increases the expression, activity, and/or stability of spliced XBP-1
to thereby identify a compound useful in treating at least one symptom of a metabolic disorder.

2. The method of claim 1, wherein the activity of XBP-1 is measured by measuring the phosphorylation of PERK or eIF2α.

3. The method of claim 1, wherein the indicator composition comprises an indicator gene whose expression is regulated by XBP-1 and the activity of XBP-1 is measured by measuring the expression or activity of the indicator gene.

4. The method of claim 3, wherein the indicator gene is a chaperone gene.

5. The method of claim 4, wherein the chaperone gene is selected from the group consisting of: ERdj4, p58^{ipk}, EDEM, PDI-P5, RAMP4, HEDJ, BiP, ATF6α, XBP-1, Armet and DNAJB9.

6. The method of claim 3, wherein the indicator gene comprises the regulatory region of XBP-1 operably linked to nucleotide sequence encoding a measurable polypeptide and expression or activity of the polypeptide is measured.

7. The method of claim 6, wherein the measurable polypeptide is a reporter polypeptide.

8. The method of claim 1, wherein the metabolic disorder is obesity

9. The method of claim 1, wherein the metabolic disorder is insulin resistance

10. The method of claim 1, wherein the metabolic disorder is type 2 diabetes

11. A method of increasing insulin sensitivity in a cell comprising contacting a cell with an agent that increases the expression or activity of spliced XBP-1 in the cell such that insulin sensitivity is increased.

12. A method of upmodulating glucose metabolism in a mammalian cell comprising contacting a cell with an agent that increases the expression, processing, post-translational modification, and/or activity of spliced XBP-1 in the cell such that glucose metabolism is decreased.

13. The method of claim 11 or 12, wherein the agent is selected from the group consisting of: nucleic acid molecules encoding a biologically active portion of XBP-1, biologically active portions of XBP-1, and expression vectors encoding XBP-i that allow for increased expression of XBP-1 activity in a cell, and chemical compounds that act to specifically increase the activity of XBP-1.

14. A method for treating at least one symptom of a metabolic disorder in a subject comprising upmodulating the expression, processing, post-translational modification, and/or activity of spliced XBP-1 to thereby treat at least one symptom of a metabolic disorder.

15. The method of claim 14, wherein the metabolic disorder is obesity

16. The method of claim 14, wherein the metabolic disorder is insulin resistance

17. The method of claim 14, wherein the metabolic disorder is type 2 diabetes

18. The method of claim 14, wherein the agent is selected from the group consisting of: nucleic acid molecules encoding a biologically active portion of XBP-1, biologically active portions of XBP-1, and expression vectors encoding XBP-1 that allow for increased expression of XBP-1 activity in a cell, and chemical compounds that act to specifically increase the activity of XBP-1.

19. A method for diagnosing a subject at risk for developing a metabolic disorder comprising measuring the level expression of spliced XBP-1, wherein a decrease in the level of expression of spliced form of XBP-1 relative to a control indicates that the subject is at risk of developing a metabolic disorder.

20. A method for diagnosing a subject at risk for developing a metabolic disorder comprising measuring the level expression of a gene whose expression is upregulated by spliced XBP-1, wherein a decrease in the level of expression of the gene relative to a control indicates that the subject is at risk of developing a metabolic disorder.

21. The method of claim 19 or 20, wherein the metabolic disorder is obesity

22. The method of claim 19 or 20, wherein the metabolic disorder is insulin resistance

23. The method of claim 19 or 20, wherein the metabolic disorder is type 2 diabetes

24. The method of claim 20, wherein the gene is selected from the group consisting of: ERdj4, p58^{ipk}, EDEM, PDI-P5, RAMP4, HEDJ, BiP, ATF6cc, XBP-1, Armet and DNAJB9.
